(19) United States
(12) Patent Application Publication
(10) Pub. No.: US 2007/0161031 A1
(43) Pub. Date: Jul. 12, 2007

(54) Functional arrays for high throughput characterization of gene expression regulatory elements

(75) Inventors: Nathan D. Trinklein, Redwood City, CA (US); Shelley F. Aldred, Hayward, CA (US); Sara J. Cooper, Seattle, WA (US); Richard M. Myers, Stanford, CA (US)

Correspondence Address: WILSON SONSINI GOODRICH & ROSATI, 650 PAGE MILL ROAD, PALO ALTO, CA, 94304-1050, US

(73) Assignee: The Board of Trustees of the Leland Stanford Junior University, Palo Alto, CA (US)

(21) Appl. No.: 11/636,385

(22) Filed: Dec. 7, 2006

Related U.S. Application Data
(60) Provisional application No. 60/750,929, filed on Dec. 16, 2005.

(51) Int. Cl. C40B 30/06; C40B 40/02; C40B 50/06

(52) U.S. Cl. 435/6; 435/325

(57) ABSTRACT

The present invention provides compositions, kits, assemblies, libraries, arrays, and high throughput methods for large scale structural and functional characterization of gene expression regulatory elements in a genome of an organism, especially in a human genome. In one aspect of the invention, an array of expression constructs is provided, each of the expression constructs comprising: a nucleic acid segment operably linked with a reporter sequence in an expression vector such that expression of the reporter sequence is under the transcriptional control of the nucleic acid segment, the nucleic acid segment varying in the library and having a diversity of at least 50. The nucleic acid segments can be a large library of gene expression regulatory elements such as transcriptional promoters. The present invention can have a wide variety of applications such as in personalized medicine, pharmacogenomics, and correlation of polymorphisms with phenotypic traits.

### CROSS-REFERENCE

This application claims the benefit of U.S. Provisional Application No. 60/750,929, filed Dec. 16, 2005 and U.S. Provisional Application No. 60/762,056, filed Jan. 24, 2006 which are incorporated herein by reference in their entirety.

### STATEMENT AS TO FEDERALLY SPONSORED RESEARCH

This invention was made with the support of the United States government under the National Institutes of Health (NIH) Grant 1 U01 HG03162-01 from the National Human Genome Research Institute.

### BACKGROUND OF THE INVENTION

The regulation of human gene expression is a critical, highly coordinated, and complex process. Gene regulation plays a crucial role in virtually every biological process from coordinating cell division to responding to extracellular stimuli and directing transcription during development (Ahituv et al. 2004; Blais and Dynlacht 2004; Pirkkala et al. 2001). While knowledge of regulation at the level of individual genes is progressing, global characterization of gene regulation currently represents one of the major challenges and fundamental goals for biomedical research. An initial step in achieving this goal is the comprehensive identification of transcriptional regulatory elements in the human genome. Towards this end, the ENCODE (Encyclopedia of DNA Elements) project began in 2004 as a collective effort of many labs to identify the functional elements in 1% of the human genome (The ENCODE Project Consortium 2004).

Promoters are the best-characterized transcriptional regulatory sequences in complex genomes because of their predictable location immediately upstream of transcription start sites (TSS). They are often described as having two separate segments: core and extended promoter regions. The core promoter is generally within 50 bp of the TSS, where the pre-initiation complex forms and the general transcription machinery assembles. The extended promoter can contain specific regulatory sequences that control spatial and temporal expression of the downstream gene (reviewed in (Butler and Kadonaga 2002)). Despite a substantial body of literature describing transcriptional promoters, due to the 3′ bias in isolation and synthesis of cDNAs (Kimmel and Berger 1987) and the existence of alternative promoters regulating alternative RNA isoforms (Landry et al. 2003), the identification of the true start sites for all human transcripts is far from complete. Several groups have recently developed large resources of full-length enriched cDNA sequences including the Database of Transcriptional Start Sites (DBTSS) which contains 11,234 human genes (Suzuki et al. 2002; Suzuki et al. 2004) as well as the Mammalian Gene Collection (MGC) which contains 12,228 genes (Gerhard et al. 2004). These databases provide sequences enriched for the 5′ ends of genes, but they still contain a significant number of incomplete and artifactual sequences, emphasizing the need for further experimental validation to identify the true transcription start sites and corresponding promoters of all the genes in the human genome. The Eukaryotic Promoter Database is one such resource, but it currently contains only 1,871 human promoters (Cavin Perier et al. 1998; Praz et al. 2002), a small fraction of the estimated total.

Several technologies currently exist to study the functional regions of the human genome. Expression microarrays enable researchers to measure the steady state level of all the genes in the genome under different conditions. Another technique that combines chromatin immunoprecipitation and genomic microarrays (CHIP-chip) can determine the binding sites of a transcription factor across the genome. Sequencing the genomes of many different individuals and even different species can also show which sequences in the genome are under selective constraint. Additionally, assays of epigenetic modifications such as DNA-methylation status add more information to regulatory element studies. All of these experimental approaches produce valuable observations, but they do not directly measure the function of DNA regulatory elements. The present invention provides innovative solutions to problems in functional characterization of regulatory elements and uses of the information generated in the functional studies for research, diagnosis, prevention and treatment of diseases or conditions.

### SUMMARY OF THE INVENTION

The present invention relates to high throughput methods for structural and functional characterization of gene expression regulatory elements in a genome of an organism, preferably a mammalian genome, and more preferably a human genome. The gene expression regulatory elements include, but are not limited to transcriptional promoters, enhancers, insulators, suppressors, and inducers. In preferred embodiments, the regulator element is a transcriptional promoter. Each of the regulatory elements can be characterized in terms of its genomic location, sequence, variation, mutation, polymorphism, transcriptional regulatory activity in different cell or tissue type, and binding affinity with other regulatory factors, such as transcription factors. Information on the structure and function of the gene expression regulatory elements can have a wide variety of applications, including but not limited to diagnosis and treatment of diseases in a personalized manner (also known as “personalized medicine”) by association with phenotype such as disease resistance, disease susceptibility or drug response. Identification and characterization of the regulatory elements in terms of cell- or tissue-specificity can also aid in the design of gene therapy with enhanced therapeutic efficacy and reduced side effects. “Disease” includes but is not limited to any condition, trait or characteristic of an organism that it is desirable to change. For example, the condition may be physical, physiological or psychological and may be symptomatic or asymptomatic.

In one aspect of the invention, a method is provided for determining transcriptional regulatory activity of a plurality of different nucleic acid segments. The method comprises: operably linking each of the plurality of different nucleic acid segments with a reporter sequence in an expression vector such that expression of the reporter sequence is under transcriptional control of each of the different nucleic acid segments; expressing the reporter sequence; and determining the expression level of the reporter controlled by each of the different nucleic acid segments.

The plurality of different nucleic acid segments are preferably DNA segments derived from the region 5′ of the transcription start site of different genes, expanding a region from about +100 to about −3000 bp, optionally about +50 to about −2000, about +20 to about −1800, about +20 to about −1500, about +10 to about −1500, about +10 to about −1200, about +20 to about −1000, about +20 to about −900, about +20 to about −800, about +20 to about −700, about +20 to about −600, about +20 to about −500, about +20 to about −400, or about +20 to about −300, relative to a transcription start site (TSS). The diversity of the plurality of different nucleic acid segments can be at least 50, optionally at least about 80, 120, 160, 200, 400, 500, 600, 800, 1000, 1500, 2000, 3000, 5000, 8000, or 10,000. Examples of the plurality of different nucleic acid segments include, but are not limited to at least 2, optionally at least 5, 10, 20, 50, 100, 200, 500, 1000, 5000, 10000, or 25000 nucleotides selected from the group consisting of SEQ ID NOs: 1-45096 or fragments thereof.

The plurality of different DNA segments can be derived from the 5′ untranscribed region of different genes by using a computer-aided method for predicting putative transcriptional regulatory elements, such as promoters. The computer-aided method comprises: aligning a library of cDNA for different genes with a genome of an organism; defining a transcription start site for each of the different genes; and selecting a segment in the genome that comprises a sequence 5′ from the transcription start site, the selected segment constituting a member of the plurality of different DNA segments.

The methods of the present invention for selecting putative gene expression regulatory elements can be implemented in various configurations in a plurality of computing systems, including but not limited to supercomputers, personal computers, personal digital assistants (PDAs), networked computers, distributed computers on the internet or other microprocessor systems. The methods and systems described herein above are amenable to execution on various types of executable mediums other than a memory device such as a random access memory (RAM). Other types of executable mediums can be used, including but not limited to, a computer readable storage medium which can be any memory device, compact disc, zip disk or floppy disk.

The present invention also provides compositions, assemblies of articles, and kits, preferably for carrying out the methods of the present invention. For example, an array of different gene expression regulatory elements is provided, preferably an array of different transcriptional promoters. The diversity of the array is preferably at least 50, optionally at least 80, 120, 160, 200, 400, 500, 600, 800, 1000, 1500, 2000, 3000, 5000, 8000, 10,000, or 25,000. Also provided are a library of expression vectors each of which comprises a different gene expression regulatory element, preferably operably linked with a reporter sequence such that expression of the reporter sequence is under transcriptional control of each of the gene expression regulatory element. Examples of the different gene expression regulatory elements include, but are not limited to at least 2, optionally at least 5, 10, 20, 50, 100, 200, 500, 1000, 5000, 10000, or 25000 nucleotides selected from the group consisting of SEQ ID NOs: 1-45096 or fragments thereof, or nucleic acids having sequences with at least 70% homology thereto. Examples of the reporter sequence include but are not limited to genes encoding luciferase, fluorescent protein (such as green fluorescent protein), and β-galactosidase. In addition, kits are provided which comprise reagents and instructions for performing methods of the present invention, or for performing tests or assays utilizing any of the compositions, libraries, arrays, or assemblies of articles of the present invention. The kits may further comprise buffers, restriction enzymes, adaptors, primers, a ligase, a polymerase, dNTPS and instructions necessary for use of the kits.

The present invention also provides a method for determining the base present at a polymorphism of a transcriptional regulator element in the genome of an individual. The method comprises: providing a nucleic acid sample from the individual; amplifying a predetermined region of the transcriptional regulator element in the genome to produce a nucleic acid fragment; hybridizing a nucleic acid fragment to an array of different transcriptional regulator elements immobilized to a solid support; and generating a hybridization pattern resulting from the hybridization; and determining the base present at the polymorphism in the individual based upon an analysis of the hybridization pattern. The transcriptional regulator element is preferably a core promoter or an expanded promoter. The array of different transcriptional regulator elements are preferably the arrays provided in the present invention, and are capable of interrogating one or more polymorphic sites. The identity of the polymorphic base is determined from the hybridization information. The method can also be used to determine the base present at a polymorphism of a transcriptional regulator element in the genomes of a population of individuals.

In addition, the present invention provides a method for determining transcriptional activity of a plurality of transcriptional regulator elements in the genome of an individual. The method comprises: providing a nucleic acid sample from the individual; amplifying a predetermined region of a plurality of transcriptional regulator elements in the genome to produce a plurality of nucleic acid fragments; inserting each of the nucleic acid fragments into a reporter construct to generate a library of reporter constructs; expressing the library of reporter constructs in cells; and determining the transcriptional activity of the transcriptional regulator elements in the cells by correlating with the levels of reporter expressed in the cells. The method may further comprise: comparing the transcriptional activity of the transcriptional regulator elements with a profile of the same transcriptional regulator elements obtained from a reference sample. Examples of the plurality of transcriptional regulator elements include, but are not limited to at least 2, optionally at least 5, 10, 20, 50, 100, 200, 500, 1000, 5000, 10000, or 25000 nucleotides selected from the group consisting of SEQ ID NOs: 1-45096 or fragments thereof.

The method can be used for diagnosing a disease or condition associated with aberrant transcriptional activity of a regulatory element, such as beta-thalassemia, cardiovascular disease, Alzheimer disease, schizophrenia, bi-polar disorder, glaucoma, epilepsy, multiple sclerosis and lupus. The transcriptional activity of a particular regulatory element, such as a promoter, or a panel of promoters in the individual being tested can be compared with those of a panel of promoters in a reference sample derived from the same individual or another individual. A difference in the transcriptional activity may indicate that the individual being tested has a disease associated with aberrant transcriptional activity.

The method can also be used for treating a disease or condition associated with aberrant transcriptional activity of a regulatory element, such as beta-thalassemia, cardiovascular disease, Alzheimer disease, schizophrenia, bi-polar disorder, glaucoma, epilepsy, multiple sclerosis and lupus. The transcriptional activity of a particular regulatory element, such as a promoter, or a panel of promoters in the patient being treated can be compared with those of a panel of promoters in a reference sample derived from the same patient or another individual, and treating the patient with a therapeutic agent that regulates the transcriptional activity of the regulatory element.

In another aspect this invention provides a library of isolated nucleic acid molecules, each member of the library comprising a different, pre-determined nucleic acid segment from a genome, wherein the segment comprises transcription regulatory sequences, wherein: (a) the library has a diversity of at least 50 different nucleic acid segments; (b) each nucleic acid segment is naturally linked in the genome with a sequence expressed as a cDNA; and (c) the average length of the nucleic acid segments in the library is at least 600 nucleotides. In one embodiment a plurality of the isolated nucleic acid molecules in the library are selected from the group consisting of SEQ ID NOs: 1-45096.

In another aspect this invention provides a library of expression constructs, each member of the library comprising a different nucleic acid segment from a genome, wherein the segment comprises transcription regulatory sequences, operably linked with a heterologous reporter sequence in an expression vector such that expression of the reporter sequence is under transcriptional control of the transcription regulatory sequences, wherein: (a) the library has a diversity of at least 50 different nucleic acid segments; (b) each nucleic acid segment and is naturally linked in the genome with a sequence expressed as a cDNA; and (c) the average length of the nucleic acid segments in the library is at least 600 nucleotides.

In another aspect this invention provides a library of recombinant nucleic acid molecules, each member of the library comprising a different, determined nucleic acid segment from a genome linked with a heterologous nucleic acid molecule, wherein the segment comprises transcription regulatory sequences, wherein: (a) the library has a diversity of at least 50 different nucleic acid segments; (b) each nucleic acid segment is naturally linked in the genome with a sequence expressed as a cDNA; and (c) the average length of the nucleic acid segments in the library is at least 600 nucleotides.

In another aspect this invention provides a library of cells, wherein each cell in the library of cells comprises a different member of a library of expression constructs, wherein each member of the library of expression constructs comprises a different nucleic acid segment from a genome, wherein the segment comprises transcription regulatory sequences, operably linked with a heterologous reporter sequence in an expression vector such that expression of the reporter sequence is under transcriptional control of the transcription regulatory sequences, wherein: (a) the library has a diversity of at least 50 different nucleic acid segments; (b) each nucleic acid segment is naturally linked in the genome with a sequence expressed as a cDNA; and (c) the average length of the nucleic acid segments in the library is at least 600 nucleotides. In one embodiment the cells are human cells. In another embodiment the cells are non-human cells.

In another aspect this invention provides a collection of cells comprising within the cells a library of expression constructs, each member of the library of expression constructs comprising: a different nucleic acid segment from a genome, wherein the segment comprises transcription regulatory sequences, operably linked with a different heterologous reporter sequence in an expression vector such that expression of the reporter sequence is under transcriptional control of the transcription regulatory sequences.

In another aspect this invention provides a device comprising at least one plate comprising a plurality of wells, each well containing a different member of the library of cells, wherein each cell in the library of cells comprises a different member of the library of expression constructs, each expression construct comprising a different nucleic acid segment from a genome, wherein the segment comprises transcription regulatory sequences, operably linked with a heterologous reporter sequence in an expression vector such that expression of the reporter sequence is under transcriptional control of the transcription regulatory sequences and wherein each member of the library of cells has a known location among the wells.

In another aspect this invention provides a kit for characterizing a biological function of a target gene expression regulatory element, comprising: (a) a device comprising at least one plate comprising a plurality of wells, each well containing a different member of the library of expression constructs, each expression construct comprising a different nucleic acid segment from a genome, wherein the segment comprises transcription regulatory sequences operably linked with a heterologous reporter sequence in an expression vector such that expression of the reporter sequence is under transcriptional control of the transcription regulatory sequences, and wherein each member has a known location among the wells; and (b) reporter assay substrates. In one embodiment the kit further comprises instructions for characterizing the biological function of the target gene expression regulatory element.

In another aspect this invention provides a device comprising a solid substrate comprising a surface and nucleic acid molecules immobilized to the surface, each at a different known location, wherein each molecule comprises a nucleotide sequence of at least 10 nucleotides from a genomic segment comprising transcription regulatory sequences and the device comprises transcription regulatory sequences from at least 50 different genomic segments.

In another aspect this invention provides a system comprising: (a) a device of this invention; and (b) a reader adapted to detect a signal from an expressed reporter sequenced in each well of the device.

In one embodiment the device further comprises (c) software comprising: (i) code that executes an algorithm that normalizes signal from all wells of plates based on the signal from the control constructs. In another aspect this invention provides software comprising code that executes the aforementioned algorithm.

In another aspect this invention provides a method comprising: (a) providing a device comprising at least one plate comprising a plurality of wells, each well containing a different member of a library of cells, wherein each cell in the library of cells comprises a different member of the library of expression constructs, each expression construct comprising a different nucleic acid segment from a genome, wherein the segment comprises transcription regulatory sequences, operably linked with a heterologous reporter sequence in an expression vector such that expression of the reporter sequence is under transcriptional control of the transcription regulatory sequences and wherein each member of the library of cells has a known location among the wells; (b) culturing the cells; and (c) measuring the level of expression of the reporter sequence in each well.

In one embodiment the step of providing the device comprises: (i) providing a device comprising at least one plate comprising a plurality of wells, each well containing a different member of the library of expression constructs, wherein each member of the library of expression constructs has a known location among the wells; (ii) delivering cells to each of the wells; and (iii) transfecting the cells with the expression constructs. In another embodiment the method further comprises: (d) perturbing the cells in each well; (e) measuring the level of expression of the reporter sequence in each well; and (f) determining whether the level of expression in any well changed after contacting the cells with the test compound. In another embodiment of the method perturbing comprises contacting the cells in each well with a test compound, exposing the cells to different environmental conditions, or genetically modifying the cells either permanently or transiently such as by inducing mutation, overexpressing a transcript for example by transfecting with a cDNA or decreasing expression of a transcript by siRNA.

In another aspect this invention provides a method comprising: (a) providing a first device and second device, each device comprising at least one plate comprising a plurality of wells, each well containing a different member of a library of cells, wherein each cell in the library of cells comprises a different member of the library of expression constructs, each expression construct comprising a different nucleic acid segment from a genome, wherein the segment comprises transcription regulatory sequences, operably linked with a heterologous reporter sequence in an expression vector such that expression of the reporter sequence is under transcriptional control of the transcription regulatory sequences, wherein each member of the library of cells has a known location among the wells and wherein the first and second devices comprise cells of the same type and the library of expression constructs is the same in the first and second devices; (b) culturing the cells of the first and second devices under different culture conditions; (c) measuring the level of expression of the reporter sequence in each well; and (d) comparing the level of expression of the reporter sequence to each transcription regulatory sequence between the first cell type and the second cell type.

In another aspect this invention provides a method comprising: (a) providing a first device and second device, each device comprising at least one plate comprising a plurality of wells, each well containing a different member of a library of cells, wherein each cell in the library of cells comprises a different member of the library of expression constructs, each expression construct comprising a different nucleic acid segment from a genome, wherein the segment comprises transcription regulatory sequences, operably linked with a heterologous reporter sequence in an expression vector such that expression of the reporter sequence is under transcriptional control of the transcription regulatory sequences, wherein each member of the library of cells has a known location among the wells and wherein the first device comprises cells of a first type and second device comprises cells of a second type and the library of expression constructs is the same in the first and second devices; (b) culturing the cells of the first and second devices; (c) measuring the level of expression of the reporter sequence in each well; and (d) comparing the level of expression of the reporter sequence to each transcription regulatory sequence between the first cell type and the second cell type.

In another aspect this invention provides a method for evaluating the level of expression from constructs measured by the method of claim 46 comprising: (a) providing a set of cells comprising a set of control reporter constructs, each control reporter construct comprising a random genomic fragment operatively linked with the heterologous reporter sequence; (b) measuring the level of expression of the reporter sequence in each of cells; (c) determining a mean or average of the expression level among the control constructs; (d) determining, for the level of expression of each of the test constructs, a statistical distance from the mean or average; and (e) determining whether the deviation is statistically significant. In one embodiment the deviation is a standard deviation. In another embodiment random genomic fragments are random fragments selected from the genome of the same size distribution as the experimental fragments. In another embodiment the random genomic fragments are random fragments from middle exons of protein coding genes where the middle exon codes for protein and is a length of at least the size of the experimental fragments and at least 5,000 or 10,000 bases from a known transcription start site in the genome. In another embodiment activity and significance are calculated as a Z-score by the following equation: Z-score promoter activity=(raw promoter activity−mean of random controls)/standard deviation of the random controls. In another aspect this invention provides software comprising code that executes an algorithm that determines the mean and deviations of the method.

In another aspect this invention provides analysis software that integrates Z-score transformed promoter activity data with Z-score transformed functional data from DNA methylation experiments, transcription factor binding data, histone modification data, DNase hypersensitivity data, nucleosome displacement data or gene expression data.

In another aspect this invention provides a method for determining a methylation pattern in a sequence of nucleic acid comprising: (a) creating a first set of labeled nucleic acid segments by: (i) obtaining a nucleic acid molecule comprising the sequence from a source; and (ii) labeling the isolated nucleic acid molecule with a first label, whereby labeling creates a first set of labeled nucleic acid segments; (b) creating a second set of labeled nucleic acid segments by: (i) obtaining the nucleic acid molecule having the nucleotide sequence from the source; (ii) contacting the nucleic acid molecule with at least three methyl-sensitive restriction enzymes having different recognition sequences, wherein the enzymes cleave the nucleic acid molecule at un-methylated recognition sequences but not at methylated recognition sequences, thereby nucleic acid fragments; (iii) isolating nucleic acid fragments of at least 100 nucleotides from the mixture; and (iv) labeling the fragments with a second, different label, whereby labeling creates a second set of nucleic acid segments; (c) hybridizing the first and second labeled segments to one or more nucleic acid probes comprising the nucleotide sequence; and (d) determining areas of the nucleotide sequence that are differentially labeled by the first and second labeled segments, wherein differentially labeled areas are un-methylated areas of the nucleotide sequence. In one embodiment the nucleic acid molecule comprises transcription regulatory sequences. In another embodiment the method comprises contacting the nucleic acid molecules with at least six different methyl-sensitive enzymes. In another embodiment the first label generates a first color and the second label generates a second, different color. In another embodiment the method comprises hybridizing the segments to a plurality of probes that tile the nucleotide sequence of the nucleic acid molecules that would be predicted to be digested based on the methyl-sensitive restriction enzyme recognition sequences. In another embodiment the method further comprises performing the method a second time with nucleic acid from a second source, wherein the first and second sources are healthy and diseased tissues or two different types of diseased tissues.

In another aspect this invention provides a business method comprising commercializing any of the compositions, devices or methods described herein.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a clustergram of 642 putative promoter fragments. The clustergram illustrates the hierarchical clustering of promoter activity among 16 diverse cell lines. Each row indicates the promoter activity of a fragment in each of the cell lines with red indicating the degree of activity and black, no activity. Promoter activity has been normalized and log transformed to reflect comparable values between cell lines. Area A represents a cluster of promoter fragments with strong, ubiquitous activity in all cell lines and Area B represents a cluster of promoter fragments that exhibit variable function across the 16 cell types.

FIG. 2 illustrates that two promoters differentially regulate testin gene. A) Gene structure of testin (TES) gene. B and C) Promoter activity for promoters of the TES gene in 16 tested cell types represented as a transformed luciferase/renilla ratio. B) Promoter A shows activity in 12 of the 16 tissues, but little activity in two brain cell lines, U87 and T98G. C) Promoter B has significant activity only in U87 and T98G, both brain cell lines.

FIG. 3 illustrates reporter activity of promoter deletion constructs. A) Diagram of promoter deletion constructs. B) Average promoter activity observed for each of the 6 constructs of decreasing upstream sequence (1,000 bp, 500 bp, 350 bp, 200 bp, 90 bp, 40 bp). The average represents normalized activity of constructs in 45 promoters and seven cell lines (HT1080, HeLa, HCT116, G-402, AGS, T98G, and JEG3). The promoter activity, assayed in triplicate and represented as normalized luciferase/renilla ratio, provides a transfection-normalized value to compare activity within and between cell lines. C) Average activities of promoter fragments for the UDP-glycosyltransferase gene (UGT1A10) across seven cell types. D) Average activities of sperm-associated antigen 4 (SPAG4) promoter fragments across seven cell types. The 898 bp fragment of the SPAG4 promoter shows considerably less activity than the 372 bp fragment.

FIG. 4 illustrates reporter activity of a negative regulatory element in SPAG4 promoter. Average promoter activity across two cell types, HT1080 and HCT116, of six constructs: 1, SPAG4-372 bp fragment. 2, SPAG4 372 bp promoter cloned in tandem duplicate to control for size. 3, 500 bp of random sequence cloned upstream of the SPAG4 372 bp promoter. 4, SPAG4 898 bp fragment. 5, SPAG4-898 to −372 fragment cloned upstream of heterologous promoter A. 6, SPAG4-8984372 fragment upstream of heterologous promoter B. Error bars indicate one standard deviation from the mean of four replicates of each construct.

FIG. 5 is a Scatterplot of endogenous RNA transcript levels versus promoter activity. RNA levels, expressed as absolute genomic equivalents, are plotted on the X-axis and the normalized promoter activity is shown on the Y-axis. The correlation coefficient was calculated, r=0.53. (R²=0.28). Quadrants boundaries are set by the median RNA transcript level (0.17 genomic equivalents) and median promoter activity (2.69 luciferase/renilla ratio).

FIG. 6 shows Table 1. Promoter Activity by Class. Multi-exon and single-exon predictions are subdivided and exhibit significantly different validation rates. Further classification by longest cDNA promoter and alternative (internal) promoter show higher success among longest cDNA predictions within both categories. High Confidence predictions (HiConf) indicate support for a transcription start site either by a RefSeq gene or greater than 1 cDNA within the gene model used for the prediction.

FIG. 7 shows Table 2. Locations of promoter-binding factors, TAF1 and RNAP II overlap functional promoters. Column 1: number of binding sites for each factor. Column 2: number of all promoter predictions that overlap the binding sites. Column 3: number of binding sites tested by transient transfection reporter assay. Column 4: number and percentage of overlapping fragments with promoter activity.

FIG. 8A schematically illustrates a method for identifying, isolating and functionally analyzing a large number of regulatory elements, such as human transcriptional promoters.

FIG. 8B schematically illustrates another embodiment of the method for identifying, isolating and functionally analyzing a large number of regulatory elements, such as human transcriptional promoters.

FIG. 9A schematically illustrates an embodiment of the method for predicting transcriptional promoters.

FIG. 9B schematically illustrates another embodiment of the method for predicting transcriptional promoters.

FIG. 10A schematically illustrates an embodiment of the method for isolating promoters and cloning them into a reporter vector.

FIG. 10B schematically illustrates another embodiment of the method for isolating promoters and cloning them into a reporter vector.

FIG. 11A schematically illustrates an embodiment of the method for detecting transcriptional activity of a plurality of promoters in a high throughput manner.

FIG. 11B schematically illustrates another embodiment of the method for detecting transcriptional activity of a plurality of promoters in a large scale, high throughput manner.

FIG. 12A schematically illustrates an embodiment of the method for analyzing data obtained in a functional assay of a plurality of promoters.

FIG. 12B schematically illustrates another embodiment of the method for analyzing data obtained in a functional assay of a large number of promoters.

FIG. 13 schematically illustrates an embodiment of the method for large scale, high throughput determination of methylation status of promoters genome-wide.

FIG. 14 schematically shows a gene model that includes each type of the transcription start sites (TSS) and the cDNAs that define them. The promoter prediction algorithm (PPA) according to the present invention defines a gene model as all the collection of cDNAs with at least one base of exon overlap with at least one other cDNA in the same genomic region on the same strand. After the PPA assembles all the cDNAs into gene models, it predicts the TSS within the gene models. TSSs are classified based on their location in the gene model and from the type of cDNA that establishes that TSS. For each gene model, there is a 5′ boundary and a cDNA that defines that most 5′ TSS. Some gene models have cDNAs that predict alternative TSSs downstream of the most 5′ TSS. The PPA predicts alternative TSSs based on these full-length cDNAs from the MGC, DBTSS, or RefSeq that are at least 500 bases downstream of the next closest cDNA. In addition, an alternative TSS is predicted if a cDNA has a first exon that does not overlap any exons from longer cDNAs in the same gene model. A unique first exon increases the confidence in that particular TSS, because it is less likely to be an artificially truncated form of the gene. Because of the issues raised above concerning single-exon cDNAs, the PPA filters out any alternative TSSs predicted by a single-exon cDNA in that gene model. The gene-model building approach and TSS category classifications are described in detail in the accompanying text.

FIG. 15 shows a table summarizing the output of PPA v1.1 and PPA v1.2. PPA v1.1 predicts 64,526 promoters and PPA v1.2 predicts 45,096 promoters (the sequences of which are designated SEQ ID NOs: 1-45096 listed in the attached CD) in the human genome. The increase in the proportion of predicted promoters representing the 5′ most category, alternative first exons and multi-exon gene models taken with a decrease in the proportion of predicted promoters associated with pseudogenes, putative single-exon genes and random sequence alignments indicate that this 30% reduction in overall promoter number largely represents a reduction of noise that was present in PPA v1.1. Therefore, PPA v1.2 is a significant improvement over PPA v1.1 and is significantly more specific without sacrificing sensitivity. In addition, the ability of the two versions was compared to identify promoters present in the Eukaryotic Promoter Database (EPD), a publicly available database containing ˜1,800 promoter sequences previously identified in the published literature. The overlap with the EPD sequences is very similar with the two versions, again indicating that PPA v1.2 is removing noise from the predictions without losing sensitivity to detect true promoters.

FIG. 16 shows a table listing proportions of predicted promoter sequences clonable using different sets of restriction enzyme pairs. To facilitate ligation-based cloning of promoter fragments into a reporter vector, a restriction enzyme site sequence is added to the forward and reverse primers for each promoter. For directional cloning, one sequence is added to the forward primer and a different sequence to the reverse primer. If such an approach is to be effective, the amplified promoter sequence to be cloned is preferred not to contain the restriction site sequence to be added to the primers. Preferably, the PPA of the present invention screens each promoter sequence, and one of three restriction site pairs is used depending on which sites are absent in the promoter sequence. Based on the genome-wide promoter analysis, employing three restriction enzyme pairs covers 97% of all of the promoters of the genome whereas using a single pair will cover between 55-78% depending on the pair of enzymes used.

FIG. 17 shows a table listing predicted and observed percentage of unique clones recovered at different levels of sequencing coverage using pooled cloning strategy.

### DETAILED DESCRIPTION OF THE INVENTION

1. Definitions

As used herein, the term “nucleic acid” refers to single-stranded and/or double-stranded polynucleotides such as deoxyribonucleic acid (DNA), and ribonucleic acid (RNA) as well as analogs or derivatives of either RNA or DNA. Also included in the term “nucleic acid” are analogs of nucleic acids such as peptide nucleic acid (PNA), phosphorothioate DNA, and other such analogs and derivatives or combinations thereof. Thus, the term also should be understood to include, as equivalents, derivatives, variants and analogs of either RNA or DNA made from nucleotide analogs, single (sense or antisense) and double-stranded polynucleotides, including double-stranded RNA. Deoxyribonucleotides include deoxyadenosine, deoxycytidine, deoxyguanosine and deoxythymidine. For RNA, the uracil base is uridine.

As used herein, the term “polynucleotide” refers to an oligomer or polymer containing at least two linked nucleotides or nucleotide derivatives, including a deoxyribonucleic acid (DNA), a ribonucleic acid (RNA), and a DNA or RNA derivative containing, for example, a nucleotide analog or a “backbone” bond other than a phosphodiester bond, for example, a phosphotriester bond, a phosphoramidate bond, a phophorothioate bond, a thioester bond, or a peptide bond (peptide nucleic acid). The term “oligonucleotide” also is used herein essentially synonymously with “polynucleotide,” although those in the art recognize that oligonucleotides, for example, PCR primers, generally are less than about fifty to one hundred nucleotides in length.

Nucleotide analogs contained in a polynucleotide can be, for example, mass modified nucleotides, which allows for mass differentiation of polynucleotides; nucleotides containing a detectable label such as a fluorescent, radioactive, luminescent or chemiluminescent label, which allows for detection of a polynucleotide; or nucleotides containing a reactive group such as biotin or a thiol group, which facilitates immobilization of a polynucleotide to a solid support. A polynucleotide also can contain one or more backbone bonds that are selectively cleavable, for example, chemically, enzymatically or photolytically. For example, a polynucleotide can include one or more deoxyribonucleotides, followed by one or more ribonucleotides, which can be followed by one or more deoxyribonucleotides, such a sequence being cleavable at the ribonucleotide sequence by base hydrolysis. A polynucleotide also can contain one or more bonds that are relatively resistant to cleavage, for example, a chimeric oligonucleotide primer, which can include nucleotides linked by peptide nucleic acid bonds and at least one nucleotide at the 3′ end, which is linked by a phosphodiester bond or other suitable bond, and is capable of being extended by a polymerase. Peptide nucleic acid sequences can be prepared using well known methods (see, for example, Weiler et al. Nucleic acids Res. 25: 2792-2799 (1997)).

As used herein, to hybridize under conditions of a specified stringency is used to describe the stability of hybrids formed between two single-stranded DNA fragments and refers to the conditions of ionic strength and temperature at which such hybrids are washed, following annealing under conditions of stringency less than or equal to that of the washing step. Typically high, medium and low stringency encompass the following conditions or equivalent conditions thereto:
1) high stringency: 0.1×SSPE or SSC, 0.1% SDS, 65° C.;
2) medium stringency: 0.2×SSPE or SSC, 0.1% SDS, 50° C.;
3) low stringency: 1.0×SSPE or SSC, 0.1% SDS, 50° C.

Equivalent conditions refer to conditions that select for substantially the same percentage of mismatch in the resulting hybrids. Additions of ingredients, such as formamide, Ficoll, and Denhardt's solution affect parameters such as the temperature under which the hybridization should be conducted and the rate of the reaction. Thus, hybridization in 5×SSC, in 20% formamide at 42° C. is substantially the same as the conditions recited above hybridization under conditions of low stringency. The recipes for SSPE, SSC and Denhardt's and the preparation of deionized formamide are described, for example, in Sambrook et al. (1989) Molecular Cloning, A Laboratory Manual, Cold Spring Harbor Laboratory Press, Chapter 8; see, Sambrook et al., vol. 3, p. B. 13, see, also, numerous catalogs that describe commonly used laboratory solutions). It is understood that equivalent stringencies can be achieved using alternative buffers, salts and temperatures.

The term “substantially” identical or homologous or similar varies with the context as understood by those skilled in the relevant art and generally means at least 70%, preferably means at least 80%, more preferably at least 90%, and most preferably at least 95% identity.

The term “fragment,” “segment,” or “DNA segment” refers to a portion of a larger DNA polynucleotide or DNA. A polynucleotide, for example, can be broken up, or fragmented into, a plurality of segments. Various methods of fragmenting nucleic acids are well known in the art. These methods may be, for example, either chemical or physical in nature. Chemical fragmentation may include partial degradation with a DNAse; partial depurination with acid; the use of restriction enzymes; intron-encoded endonucleases; DNA-based cleavage methods, such as triplex and hybrid formation methods, that rely on the specific hybridization of a nucleic acid segment to localize a cleaveage agent to a specific location in the nucleic acid molecule; or other enzymes or compounds which cleave DNA at known or unknown locations. Physical fragmentation methods may involve subjecting the DNA to a high shear rate. High shear rates may be produced, for example, by moving DNA through a chamber or channel with pits or spikes, or forcing the DNA sample through a restricted size flow passage, e.g., an aperture having a cross sectional dimension in the micron or submicron scale. Other physical methods include sonication and nebulization. Combinations of physical and chemical fragmentation methods may likewise be employed such as fragmentation by heat and ion-mediated hydrolysis. See for example, Sambrook et al., “Molecular Cloning: A Laboratory Manual,” 3rd Ed. Cold Spring Harbor Laboratory Press, Cold Spring Harbor, N.Y. (2001) (“Sambrook et al.”) which is incorporated herein by reference in its entirety for all purposes. These methods can be optimized to digest a nucleic acid into fragments of a selected size range. Useful size ranges may be from 100, 200, 400, 700 or 1000 to 500, 800, 1500, 2000, 4000 or 10,000 base pairs. However, larger size ranges such as 4000, 10,000 or 20,000 to 10,000, 20,000 or 500,000 base pairs may also be useful.

Methods of ligation will be known to those of skill in the art and are described, for example in Sambrook et al. and the New England BioLabs catalog, both of which are incorporated herein in their entireties by reference for all purposes. Methods include using T4 DNA ligase, which catalyzes the formation of a phosphodiester bond between juxtaposed 5 phosphate and 3′ hydroxyl termini in duplex DNA or RNA with blunt or and sticky ends; Taq DNA ligase, which catalyzes the formation of a phosphodiester bond between juxtaposed 5′ phosphate and 3′ hydroxyl termini of two adjacent oligonucleotides that are hybridized to a complementary target DNA; E. coli DNA ligase, which catalyzes the formation of a phosphodiester bond between juxtaposed 5′-phosphate and 3′-hydroxyl termini in duplex DNA containing cohesive ends; and T4 RNA ligase which catalyzes ligation of a 5′ phosphoryl-terminated nucleic acid donor to a 3′ hydroxyl-terminated nucleic acid acceptor through the formation of a 3′->5′ phosphodiester bond, substrates include single-stranded RNA and DNA as well as dinucleoside pyrophosphates; or any other methods described in the art.

“Genome” designates or denotes the complete, single-copy set of genetic instructions for an organism as coded into the DNA of the organism. A genome may be multi-chromosomal such that the DNA is distributed among a plurality of individual chromosomes. For example, in human there are 22 pairs of chromosomes plus a gender associated XX or XY pair.

“Polymorphism” refers to the occurrence of two or more genetically determined alternative sequences or alleles in a population. A polymorphic marker or site is the locus at which divergence occurs. Preferred markers have at least two alleles, each occurring at a frequency of preferably greater than 1%, and more preferably greater than 10% or 20% of a selected population. A polymorphism may comprise one or more base changes, an insertion, a repeat, or a deletion. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A diallelic polymorphism has two forms. A triallelic polymorphism has three forms. A polymorphism between two nucleic acids can occur naturally, or be caused by exposure to or contact with chemicals, enzymes, or other agents, or exposure to agents that cause damage to nucleic acids, for example, ultraviolet radiation, mutagens or carcinogens.

Single nucleotide polymorphisms (SNPs) are positions at which two alternative bases occur in the human population, and are the most common type of human genetic variation. The site is usually preceded by and followed by highly conserved sequences of the allele (e.g., sequences that vary in less than 1/100 or 1/1000 members of the populations). It is estimated that there are as many as 3×10⁶ SNPs in the human genome. Variations that occur at a rate of at least 10% are referred to as common SNPs.

A single nucleotide polymorphism usually arises due to substitution of one nucleotide for another at the polymorphic site. A transition is the replacement of one purine by another purine or one pyrimidine by another pyrimidine. A transversion is the replacement of a purine by a pyrimidine or vice versa. Single nucleotide polymorphisms can also arise from a deletion of a nucleotide or an insertion of a nucleotide relative to a reference allele.

The term genotyping refers to the determination of the genetic information an individual carries at one or more positions in the genome. For example, genotyping may comprise the determination of which allele or alleles an individual carries for a single polymorphism or the determination of which allele or alleles an individual carries for a plurality of polymorphisms.

As used herein, “profiling” refers to detection and/or identification of a plurality of components, generally 3 or more, such as 4, 5, 6, 7, 8, 10, 50, 100, 500, 1000, 10⁴, 10⁵, 10⁶, 10⁷, or more, in a sample. A profile can include the identified loci to which components of a sample detectably bind or are otherwise located. The profile can be detected, e.g., in a multi-well plate, or as a pattern on a solid surface, in which case the profile can be presented as an visual image. The profile can be in the form of a list or database or other such compendium.

As used herein, an image refers to a collection of data points representative of a profile. An image can be a visual, graphical, tabular, matrix or other depiction of such data. It can be stored in a database.

As used herein, a database refers to a collection of data items.

As used herein, in an addressable collection of components of interest, such as a library of transcription regulatory elements (with pre-determined sequences), expression vectors encoding transcription regulatory elements, and cells containing expression vectors encoding transcription regulatory elements, each member of the collection is labeled and/or is positionally located to permit identification of each of member of the components. The addressable collection is typically an array or other encoded (such as bio-barcoded with unique nucleic acid tags) collection in which each locus contains a single, unique component and is identifiable. The collection can be in the liquid phase if other discrete identifiers, such as chemical, electronic, colored, fluorescent or other tags are included.

As used herein, an address refers to a unique identifier whereby an addressed entity can be identified. An addressed moiety is one that can be identified by virtue of its address. Addressing can be effected by position on a surface or by other identifier, such as a tag encoded with a bar code or other symbology, a chemical tag, an electronic, such RF tag, a color-coded tag or other such identifier.

As used herein, a nucleotide barcode refers to a specific type of address, more specifically, predesigned, predetermined and unique nucleotide sequence tag which can be used to uniquely identify each member in a collection of transcription regulatory elements, expression vectors encoding transcription regulatory elements, and cells containing expression vectors encoding transcription regulatory elements. Such a nucleic acid barcode may be 3-200, 5-200, 8-100, or 10-50 nucleotides in length, and discrete and tailorable hybridization and melting properties. Barcodes are heterologous to the molecules they tag.

An “array” comprises a support, preferably solid, comprising a plurality of different, known locations at which an item can be placed. Arrays include, for example, microtiter plates with addressable wells and chips comprising bound molecules at addressable locations. Members of the array may be identified by virtue of an identifiable or detectable label, such as by color, fluorescence, electronic signal (i.e., RF, microwave or other frequency that does not substantially alter the interaction of the molecules of interest), bar code (such as bio-barcode with unique nucleic acid tags) or other symbology, chemical or other such label. For example, the members of the array may be positioned in a container such as a well of a multi-well plate (such as a microtiter plate with 96, 384, or 1536 loci) or a vial, or immobilized to discrete identifiable loci on the surface of a solid phase or directly or indirectly linked to or otherwise associated with the identifiable label, such as affixed to a microsphere or other particulate support (herein referred to as beads) and suspended in solution or spread out on a surface. A microarray, which is used by those of skill in the art, generally is a positionally addressable array, such as an array on a solid support, in which the loci of the array are at high density. Examples of hybridization arrays, also described as “microarrays” or colloquially “chips” have been generally described in the art, for example, U.S. Pat. Nos. 5,143,854, 5,445,934, 5,744,305, 5,677,195, 5,800,992, 6,040,193, 5,424,186 and Fodor et al., Science, 251:767-777 (1991).

Arrays may generally be produced using a variety of techniques, such as mechanical synthesis methods or light directed synthesis methods that incorporate a combination of photolithographic methods and solid phase synthesis methods. Techniques for the synthesis of these arrays using mechanical synthesis methods are described in, e.g., U.S. Pat. Nos. 5,384,261, and 6,040,193, which are incorporated herein by reference in their entirety for all purposes. Although a planar array surface is preferred, the array may be fabricated on a surface of virtually any shape or even a multiplicity of surfaces. Arrays may be nucleic acids on beads, gels, polymeric surfaces, fibers such as fiber optics, glass or any other appropriate substrate. (See U.S. Pat. Nos. 5,770,358, 5,789,162, 5,708,153, 6,040,193 and 5,800,992.)

As used herein, a support (also referred to as a matrix support, a matrix, an insoluble support or solid support) refers to any solid or semisolid or insoluble support to which an item, e.g., a molecule of interest, typically a biological molecule, organic molecule or biospecific ligand can be linked or contacted. Such materials include any materials that are used as affinity matrices or supports for chemical and biological molecule syntheses and analyses, such as, but are not limited to: polystyrene, polycarbonate, polypropylene, nylon, glass, dextran, chitin, sand, pumice, agarose, polysaccharides, dendrimers, buckyballs, polyacrylamide, silicon, rubber, and other materials used as supports for solid phase syntheses, affinity separations and purifications, hybridization reactions, immunoassays and other such applications. The matrix herein can be particulate or can be a be in the form of a continuous surface, such as a microtiter dish or well, a glass slide, a silicon chip, a nitrocellulose sheet, nylon mesh, or other such materials.

As used herein, matrix or support particles refer to matrix materials that are in the form of discrete particles. The particles have any shape and dimensions, but typically have at least one dimension that is 100 μm or less, 50 μm or less and typically have a size that is 100 mm³ or less, 50 mm³ or less, 10 mm³ or less, and 1 mm³ or less, 100 μm³ or less and may be order of cubic microns. Such particles are collectively called “beads.” They are often, but not necessarily, spherical. Such reference, however, does not constrain the geometry of the matrix, which can be any shape, including random shapes, needles, fibers, and elongated. Roughly spherical “beads”, particularly microspheres that can be used in the liquid phase, are also contemplated. The “beads” can include additional components, such as magnetic or paramagnetic particles (see, e.g., Dyna beads (Dynal, Oslo, Norway)) for separation using magnets, as long as the additional components do not interfere with the methods and analyses herein.

As used herein, a “library” is a collection of items. In certain embodiments the library is “addressable,” i.e., members of the library comprise an identifying tag or are physically located at a different, discrete, known locations, such as contained within different wells of a multi-well plate or different containers.

As used herein, “array library” refers to the collections of addressable elements or components created by physical separation of the mixed library into a number of discrete collections.

As used herein, biological sample refers to any sample obtained from a living or viral source and includes any cell type or tissue of a subject from which nucleic acid or protein or other macromolecule can be obtained. Biological samples include, but are not limited to, cell lystates, cells, body fluids, such as blood, plasma, serum, cerebrospinal fluid, synovial fluid, urine and sweat, tissue and organ samples from animals and plants, such as humans, non-human mammals such as monkeys, dogs, pigs, horses, cats, rabbits, rats, and mice, and other vertebrates such as birds and fish. Also included are soil and water samples and other environmental samples, viruses, bacteria, fungi algae, protozoa and components thereof. The methods herein can be practiced using biological samples and in some embodiments, such as for profiling, can also be used for testing any sample.

As used herein, “a reporter gene construct” is a nucleic acid molecule that includes a nucleic acid encoding a reporter operatively linked to a transcriptional control sequences. Transcription of the reporter gene is controlled by these sequences. The activity of at least one or more of these control sequences is directly or indirectly regulated by transcription factors and other proteins or biomolecules. The transcriptional control sequences include the promoter and other regulatory regions, such as enhancer sequences, that modulate the activity of the promoter, or control sequences that modulate the activity or efficiency of the RNA polymerase that recognizes the promoter, or control sequences are recognized by effector molecules. Such sequences are herein collectively referred to as transcriptional regulatory elements or sequences.

As used herein, “reporter” or “reporter moiety” refers to any moiety that allows for the detection of a molecule of interest, such as a protein expressed by a cell, or a biological particle. Typical reporter moieties include, include, for example, light emitting proteins such as luciferase, fluorescent proteins, such as red, blue and green fluorescent proteins (see, e.g., U.S. Pat. No. 6,232,107, which provides GFPs from Renilla species and other species), the lacZ gene from E. coli, alkaline phosphatase, secreted embryonic alkaline phosphatase (SEAP), chloramphenicol acetyl transferase (CAT), hormones and cytokines and other such well-known genes. For expression in cells, nucleic acid encoding the reporter moiety can be expressed as a fusion protein with a protein of interest or under to the control of a promoter of interest. The expression of these reporter genes can also be monitored by measuring levels of mRNA transcribed from these genes.

As used herein, the phrase “operatively linked” generally means the sequences or segments have been covalently joined into one piece of DNA, whether in single or double stranded form, whereby control or regulatory sequences on one segment control or permit expression or replication or other such control of other segments. The two segments are not necessarily contiguous. It means a juxtaposition between two or more components so that the components are in a relationship permitting them to function in their intended manner. Thus, in the case of a regulatory region operatively linked to a reporter or any other polynucleotide, or a reporter or any polynucleotide operatively linked to a regulatory region, expression of the polynucleotide/reporter is influenced or controlled (e.g., modulated or altered, such as increased or decreased) by the regulatory region. For gene expression a sequence of nucleotides and a regulatory sequence(s) are connected in such a way to control or permit gene expression when the appropriate molecular signal, such as transcriptional activator proteins, are bound to the regulatory sequence(s). Operative linkage of heterologous nucleic acid, such as DNA, to regulatory and effector sequences of nucleotides, such as promoters, enhancers, transcriptional and translational stop sites, and other signal sequences refers to the relationship between such DNA and such sequences of nucleotides. For example, operative linkage of heterologous DNA to a promoter refers to the physical relationship between the DNA and the promoter such that the transcription of such DNA is initiated from the promoter by an RNA polymerase that specifically recognizes, binds to and transcribes the DNA in reading frame.

As used herein, regulatory molecule refers to a polymer of deoxyribonucleic acid (DNA) or ribonucleic acid (RNA), or an oligonucleotide mimetic, or a polypeptide or other molecule that is capable of enhancing or inhibiting expression of a gene.

As used herein, the term “regulatory region” means a nucleotide sequence that influences expression, positively or negatively, of an operatively linked gene. Regulatory regions include sequences of nucleotides that confer inducible (i.e., require a substance or stimulus for increased transcription) expression of a gene. When an inducer is present, or at increased concentration, gene expression increases. Regulatory regions also include sequences that confer repression of gene expression (i.e., a substance or stimulus decreases transcription). When a repressor is present or at increased concentration, gene expression decreases. Regulatory regions are known to influence, modulate or control many in vivo biological activities including cell proliferation, cell growth and death, cell differentiation and immune-modulation. Regulatory regions typically bind one or more trans-acting proteins which results in either increased or decreased transcription of the gene. In certain embodiments, the regulatory regions are cis-acting.

Particular examples of gene regulatory regions are promoters and enhancers. Promoters are sequences located around the transcription start site, typically positioned 5′ of the transcription start site. Enhancers are known to influence gene expression when positioned 5′ or 3′ of the gene, or when positioned in or a part of an exon or an intron. Enhancers also can function at a significant distance from the gene, for example, at a distance from about 3 Kb, 5 Kb, 7 Kb, 10 Kb, 15 Kb or more.

As used herein, a promoter region refers to the portion of DNA of a gene that controls transcription of the DNA to which it is operatively linked. The promoter region includes specific sequences of DNA that are sufficient for RNA polymerase recognition, binding and transcription initiation. This portion of the promoter region is referred to as the core promoter. In addition, the promoter region includes sequences that modulate this recognition, binding and transcription initiation activity of the RNA polymerase. These sequences can be cis acting or can be responsive to trans acting factors. Promoters, depending upon the nature of the regulation, can be constitutive or regulated.

Regulatory regions also include, in addition to promoter regions, sequences that facilitate translation, splicing signals for introns, maintenance of the correct reading frame of the gene to permit in-frame translation of mRNA and, stop codons, leader sequences and fusion partner sequences, internal ribosome binding sites (IRES) elements for the creation of multigene, or polycistronic, messages, polyadenylation signals to provide proper polyadenylation of the transcript of a gene of interest and stop codons and can be optionally included in an expression vector.

As used herein, a composition refers to any mixture. It can be a solution, a suspension, liquid, powder, a paste, aqueous, non-aqueous or any combination thereof.

As used herein, a combination refers to any association between among two or more items. The combination can be two or more separate items, such as two compositions or two collections, can be a mixture thereof, such as a single mixture of the two or more items, or any variation thereof.

As used herein, a kit refers to a packaged combination, optionally including instructions and/or reagents for their use.

As used herein, two nucleic acid segments are “heterologous” with respect to each other if their sequences are not found in the same genome or are not normally linked to one another within 10000 nucleotides in the same genome.

As used herein, a nucleic acid molecule is “isolated” if it is removed from its natural milieu in a genome and/or cell.

A nucleic acid molecule is “pure” or “purified” if it is the predominant biomolecular species in a mixture.

2. Introduction

The present invention relates to high throughput methods for structural and functional characterization of gene expression regulatory elements in a genome of an organism, preferably a mammalian genome, and more preferably a human genome. The inventive methods can be utilized as a high-throughput and easy-to-use system for characterization of the regulatory elements on a large scale, preferably on a genome-wide scale. Compositions, assemblies, libraries, arrays and kits are also provided to allow one to measure activity of the regulatory element in the genome in multiple experimental conditions in an efficient and economic way. In preferred embodiments, promoter macroarrays are provided for determining transcription factor binding and promoter activity on the same DNA fragment. Such functional libraries or arrays of the regulatory elements can have a wide variety of applications in research, diagnosis, prevention and treatment of diseases or conditions.

In one aspect, by using the invention, activity of a large number of different regulatory elements can be assessed or determined across diverse cell types or through a differentiation time-course to find tissue-specific and ubiquitous promoters. The activity of the regulatory elements can be detected or determined under different conditions, such as before and after the addition of an siRNA, cDNA, or other compound or drug to identify promoters that are up-regulated or down-regulated in response to a specific treatment. Effects of transcription factors binding to the regulatory element can also be assessed efficiently. The collection of these regulatory elements can be further analyzed for a sequence motif that is functionally relevant, for status of DNA methylation or other epigenetic modifications.

In another aspect, the functional arrays provided by the present invention enables researchers to directly measure the functional activity of promoter fragments that the previous approaches do not. In addition, the spotted promoter arrays or oligo-based promoter arrays also enable chromatin immunoprecipitation and methylation studies to be performed on the exact same promoter fragments and with an intergrated computational platform. The integration of multiple types of independent data related to promoter function provides a profoundly new capability in the study of genome-wide transcriptional regulation. This process and methodology allow, for the first time, the simultaneous study of promoter activity, transcription factor binding, and DNA methylation on a large number of promoter fragments throughout the human genome.

While not wishing to be bound by theory, it is believed that functional assays are important because although experimental tools like expression microarrays and chromatin immunoprecipitation produce valuable observations, they do not explain the mechanism or function of the DNA regulatory elements themselves. Functional data from promoters can show that increased promoter activity and thus increased rates of transcription initiation result in high transcript levels detected in a microarray experiment rather than post-transcriptional mechanisms that stabilize the transcript. Furthermore, the promoter functional assay localizes the activity of interest to a specific DNA fragment and enables the discovery of the exact functional motifs contained in that region.

It is also believed that any one experimental platform alone is not sufficient to fully describe a biological system. A gene may be highly expressed as measured by a microarray based on nucleic acid hybridization, but it cannot be determined why. A transcription factor may bind near a particular gene in the genome, but the functional consequences of binding cannot be determined. A stretch of sequence may be highly conserved, but the reason natural selection has acted to preserve this sequence is unknown. A promoter may be methylated in one cell type and unmethylated in another, but the functional consequences of this difference is not immediately clear. In addition, a promoter may show increased activity in a cell-based functional assay upon the addition of a compound, but one can only make guesses as to why its activity changed without other lines of experimental evidence. Each experimental approach also has its own inherent biases and unique issues related to that particular approach. Thus, the inventors believe that it is only when researchers integrate the information gathered from many diverse techniques they are able to gain a full picture of a biological system, independent of the limitations specific to any one experiment.

The present invention provides an innovative methodology and products to facilitate an integrated approach to regulatory element network analysis and use the information generated therefrom for researching the molecular genetic mechanisms of predisposition, onset and/or development of diseases, for development of effective measures for diagnosis, prevention and treatment of diseases.

3. Libraries of Transcription Regulatory Elements

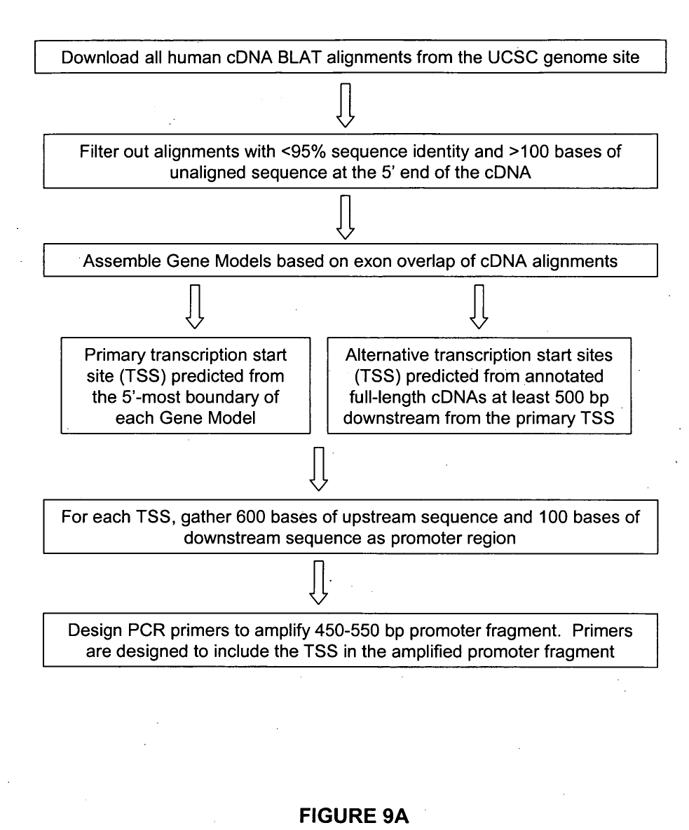

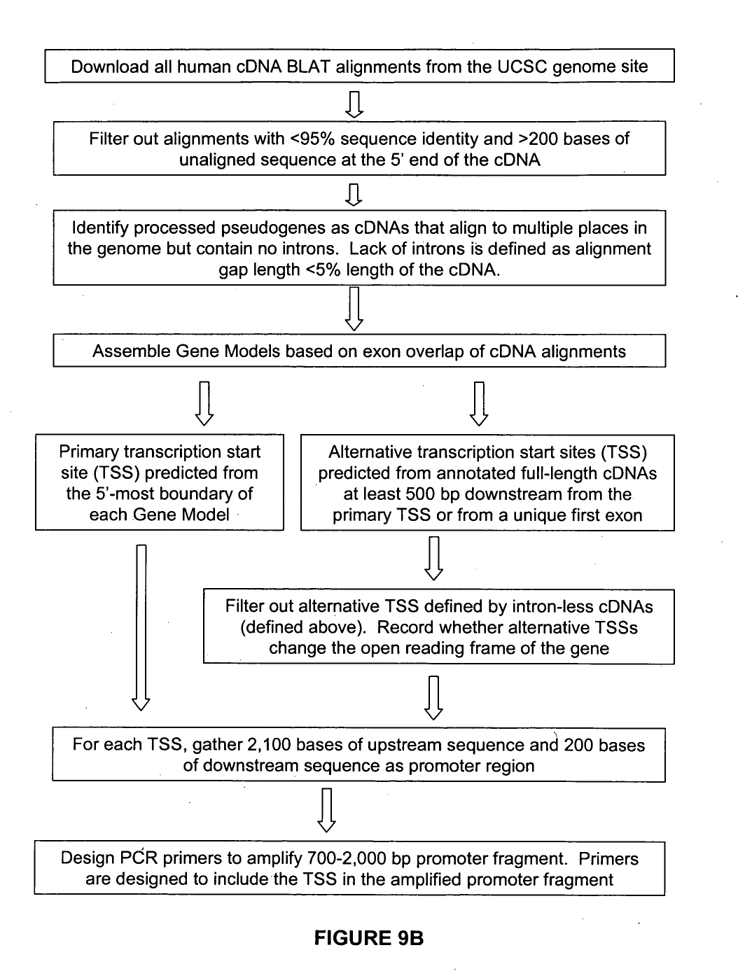

This invention provides a library of genomic nucleic acid segments comprising transcription regulatory elements. The libraries of this invention are characterized by, among other things, the length of the segments that populate the library and the high percentage of segments in which the transcriptional regulatory elements naturally control the transcription of mRNAs with biological function (that is, mRNAs that play a biological role in an organism). In one embodiment, the human genomic segments of this invention can be selected using an algorithm that is described in FIG. 9B, and more fully described in the examples.

Each genomic nucleic acid segment selected for the library is operatively linked in nature with a sequence in the genome that aligns with a known cDNA molecule. The library comprises a low percentage of segments (e.g., less than 30%, 25%, 20%, 15%, 10%, 5%, 2%, or 1%) that are linked to cDNA alignment artifacts. These artifacts result from inaccuracies of the alignment algorithm or from genomic DNA contamination of the original cDNA libraries that were sequenced. These artifacts are identified as intronless (ungapped) alignments represented by a small number of independent cDNAs from existing cDNA libraries, as pseudogenes and as single exon genes. More specifically, a library of genetic sequences, such a GenBank, contains a number of molecules reported as cDNAs. When these sequences are aligned against the sequence of the genome, certain locations of the genome are mapped by many reported cDNAs, so that the alignment cannot be considered random: One can be highly confident that these locations represent biologically relevant cDNAs and that the up-stream sequences are active transcription regulatory sequences. Other locations in the genome are mapped by few reported cDNAs or none. If the cDNA sequences are unspliced (that is they contain no introns) and the number of cDNAs mapping to a location in the genome is no more than what one would expect under a random model, then these alignments are considered artifacts.

The segments of the libraries of this invention also function well in regulating transcription because they contain more sequences involved in regulation of transcription. The libraries of this invention include segments having an average length of at least 600 nucleotides. In certain embodiments, the average length of segments in the library is between 700 nucleotides and 1200 nucleotides. More particularly, the average length can be between 800 nucleotides and 1100 nucleotides or between 950 nucleotides and 1050 nucleotides. Furthermore, the segments in the library can have a range of different lengths. For example, in one embodiment, at least 90% of the segments have lengths ranging from 200 to 1300 nucleotides or between 700 nucleotides and 1300 nucleotides. In another embodiment no more than 5% of the nucleic acid segments are naturally linked to cDNA alignment artifacts. Each segment contains a start site for transcription. Most of the genomic sequence of the segments is up-stream of the transcriptional start site, typically at least 500 base pairs. The segments typically have at least one nucleotide beyond the transcriptional start site and a majority have approximately 100 nucleotides downstream of the transcriptional start site.

The present invention also provides a library of gene expression regulatory elements, preferably a library of transcriptional promoters, preferably with diversity of at least 50, optionally at least 80, 120, 160, 200, 400, 500, 600, 800, 1000, 1500, 2000, 3000, 5000, 8000, or 10,000. Examples of the transcriptional promoters include, but are not limited to, at least 2, optionally at least 5, 10, 20, 50, 100, 200, 500, 1000, 5000, 10000, or 25000 nucleotides selected from the group consisting of SEQ ID NOs: 1-45096, or fragments thereof, such as fragments of SEQ ID NOs: 1-45096 of about 100-1800, about 300-1500, about 500-1400, about 600-1300, about 700-1200, or about 800-1000 nucleotide in length, or nucleic acids having sequences with at least 70%, 75%, 80%, 85%, 90%, 95%, or 98% homology thereto.

The gene expression regulatory elements include, but are not limited to, transcriptional promoters, enhancers, insulators, silencers, suppressors, and inducers. In preferred embodiments, the regulator element is a transcriptional promoter. Each of the regulatory elements can be characterized in terms of its genomic location, sequence, variation, mutation, polymorphism, transcriptional regulatory activity in different cell or tissue type, and binding affinity with other regulatory factors, such as transcription factors. Information on the structure and function of the gene expression regulatory elements can have a wide variety of applications, including but not limited to diagnosis and treatment of diseases in a personalized manner (also known as “personalized medicine”) by association with phenotype such as disease resistance, disease susceptibility or drug response. Identification and characterization of the regulatory elements in terms of cell- or tissue-specificity can also aid in the design of transgenic expression constructs for gene therapy with enhanced therapeutic efficacy and reduced side effects. “Disease” includes but is not limited to any condition, trait or characteristic of an organism that it is desirable to change. For example, the condition may be physical, physiological or psychological and may be symptomatic or asymptomatic.

The promoter library (or the regulatory element library) may exist in an in silico form and a physical form. The in silico form is a database of sequences from the human genome representing transcriptional promoters (with preferred size ranges as described above) and related genomic information such as the gene model and transcript it is associated with. The physical form of the promoter library may be a set of a plurality of individual nucleic acid fragments of the promoters, or plasmids each of which contains a unique promoter fragment from the human genome that is cloned upstream of a reporter gene cassette. The library preferably represents at least 50%, 70%, 80%, 90%, 95%, or 99% of all promoters in the human genome.

The physical form of the promoter library may be represented in several ways. One form may be as an archived library of plasmids that are frozen in small E. coli cultures. These frozen cultures can be stored indefinitely and expanded in liquid culture to produce more of the plasmids. Another form of the library may be purified plasmid DNAs that can be immediately ready for transfection. Based on the library of gene expression regulatory elements, preferably a library of transcriptional promoters, a wide variety of tools or kits can be built, such as plasmid functional macroarrays and spotted promoter microarrays, which are described below.

The promoter library includes a panel of plasmids, each made up of a common vector/plasmid backbone with a unique insert representing a single promoter from the human genome. The promoter fragment may be cloned immediately 5′ to a reporter gene cassette. This library can be a starting point from which two types of arrays: a plasmid functional macroarray and a spotted promoter microarray are built.

The plurality of different nucleic acid segments are preferably DNA segments derived from the region immediately 5′ of the transcription start site of different genes, expanding a region from about +100 to about −3000 bp, optionally about +50 to about −2000, about +20 to about −1800, about +20 to about −1500, about +10 to about −1500, about +10 to about −1200, about +20 to about −1000, about +20 to about −900, about +20 to about −800, about +20 to about −700, about +20 to about −600, about +20 to about −500, about +20 to about −400, or about +20 to about −300, relative to a transcription start site (TSS). The diversity of the plurality of different nucleic acid segments can be at least 50, optionally at least about 80, 120, 160, 200, 400, 500, 600, 800, 1000, 1500, 2000, 3000, 5000, 8000, or 10,000. Examples of the plurality of different nucleic acid segments include, but are not limited to at least 2, optionally at least 5, 10, 20, 50, 100, 200, 500, 1000, 5000, 10000, or 25000 nucleotides selected from the group consisting of SEQ ID NOs: 1-45096, or fragments thereof, such as fragments of SEQ ID NOs: 1-45096 of about 100-1800, about 300-1500, about 500-1400, about 600-1300, about 700-1200, or about 800-1000 nucleotide in length.

The plurality of different DNA segments can be derived from the 5′ untranscribed region of different genes by using a computer-aided method for predicting putative transcriptional regulatory elements, such as promoters. The computer-aided method comprises: aligning a library of cDNA for different genes with a genome of an organism; defining a transcription start site for each of the different genes; and selecting a segment in the genome that comprises a sequence 5′ from the transcription start site, the selected segment constituting a member of the plurality of different DNA segments.

The methods of the present invention for selecting putative gene expression regulatory elements can be implemented in various configurations in any computing systems, including but not limited to supercomputers, personal computers, personal digital assistants (PDAs), networked computers, distributed computers on the internet or other microprocessor systems. The methods and systems described herein above are amenable to execution on various types of executable mediums other than a memory device such as a random access memory (RAM). Other types of executable mediums can used, including but not limited to, a computer readable storage medium which can be any memory device, compact disc, zip disk or floppy disk.

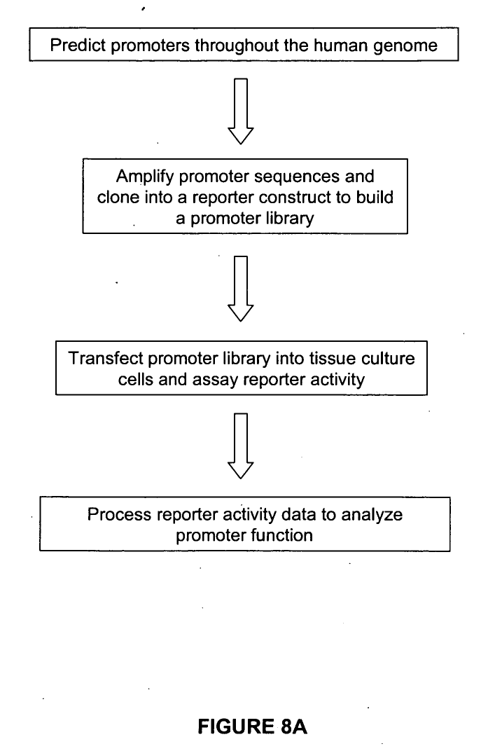

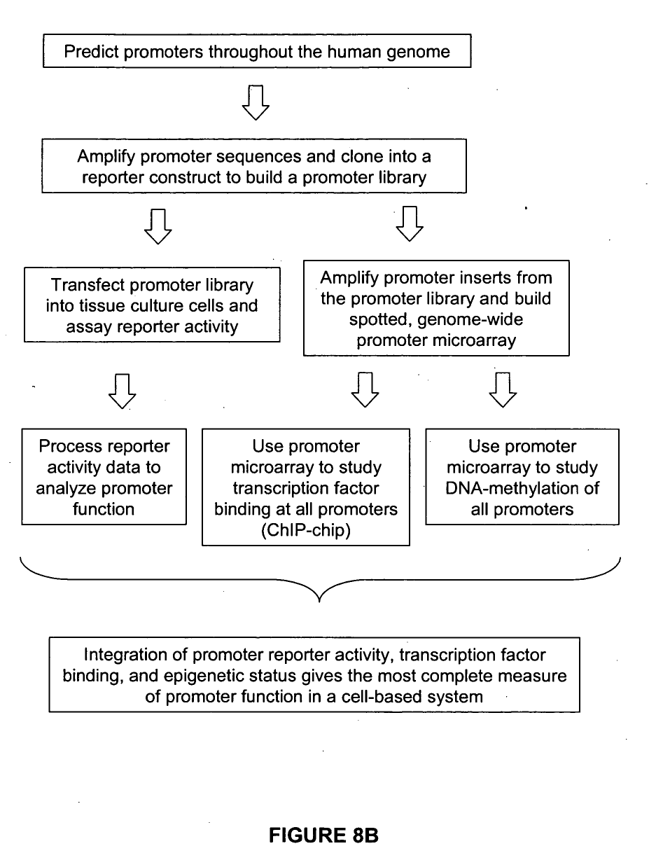

FIG. 8A schematically illustrates an embodiment of the methodology disclosed herein. The flow chart in FIG. 8A illustrates a process for identifying, isolating and functionally analyzing a large number of regulatory elements, such as human transcriptional promoters. It is preferred that transcriptional promoters are predicted throughout the human genome by using a computer-aided method provided in the present invention as detailed below. The predicted putative promoter sequences are amplified and cloned into an expression vector containing a reporter to build a library of expression vectors containing a library of promoters which are transfected or otherwise introduced into tissue culture cells. Transcriptional activation of the promoters results in expression of the reporter. Activity of the reporter is then assayed and correlated with the activity of the promoters.

FIG. 8B schematically illustrates another embodiment of the methodology disclosed herein. The flow chart in FIG. 8B illustrates a process for identifying, isolating and functionally analyzing a large number of regulatory elements, such as human transcriptional promoters. It is preferred that transcriptional promoters, including the expanded promoters, are predicted throughout the human genome by using a computer-aided method provided in the present invention as detailed below. The predicted putative promoter sequences are amplified and cloned into an expression vector containing a reporter to build a library of expression vectors containing a library of promoters which are transfected or otherwise introduced into tissue culture cells. Transcriptional activation of the promoters results in expression of the reporter. Activity of the reporter is then assayed and correlated with the activity of the promoters. In addition, the promoter sequences can be amplified and utilized to build a large scale (preferably genome-wide) promoter array. The promoter array can be used for a wide variety of applications such as to study binding of transcription factors at all of the promoters on the array (e.g. used in conjunction with chromatin immunoprecipitation (CHIP), resulting in a CHIP-chip), and to access the status of DNA methylation of the promoters. This methodology illustrated in FIG. 8B integrates promoter reporter activity, transcription factor binding, and epigenetic status, which should give the most complete measure of promoter function in a cell-based system. Alternately, the sequences in the library may be used to design an oligo-based promoter microarray for the same uses described above.

FIG. 9A schematically illustrates an embodiment of the method for predicting transcriptional promoters. As illustrated in FIG. 9A and further described in a Promoter Prediction Algorithm (PPA v1.1) in Example 1, preferably all of cDNAs available in Genbank (including those from the Mammalian Gene Collection (MGC)) are utilized for the prediction of promoters. This process filters out low quality cDNA sequences and low quality alignments, assembles all the cDNA alignments into a set of gene models based on exon overlap, and makes all promoter predictions relative to this set of gene models. In contrast, previous approaches predicted a promoter for each cDNA and filtered out redundant fragments but made no association with a gene. Therefore, for the previous approaches there was no systematic way to designate a promoter as being the primary promoter or an alternative promoter to the same gene.

FIG. 9B schematically illustrates another embodiment of the method for predicting transcriptional promoters. As illustrated in FIG. 9B and further described in Example 2, this process uses a less stringent quality control for cDNAs. It allows 200 bp of unaligned sequence at the 5′ end of cDNAs. As demonstrated in Example 2, this process utilizes cDNAs that align to multiple places in the genome and filters out likely processed pseudogenes. This process also predicts alternative promoters in a gene model based on cDNAs with unique first exons, and removes alternative TSSs defined by intron-less cDNAs. Further more this process records if the alternative TSSs result in a different open reading frame compared to the longest cDNA in the gene model. Also significantly, this process gathers 2,000 bases of putative promoter sequence from which primers are designed to amplify a promoter fragment between 700 and 2,000 basepairs. The inventors believe that there is a significant amount of transcriptional regulation controlled in the distal promoter region, and subsequent functional assays performed with these fragments will be more informative than experiments done with promoter fragments <700 basepairs.

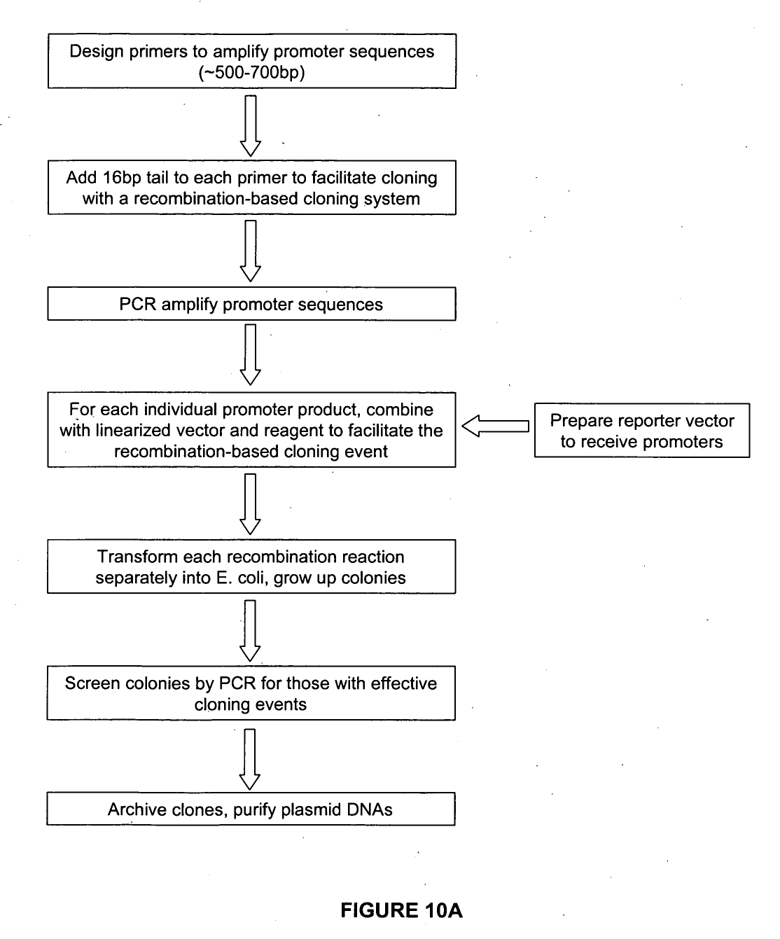

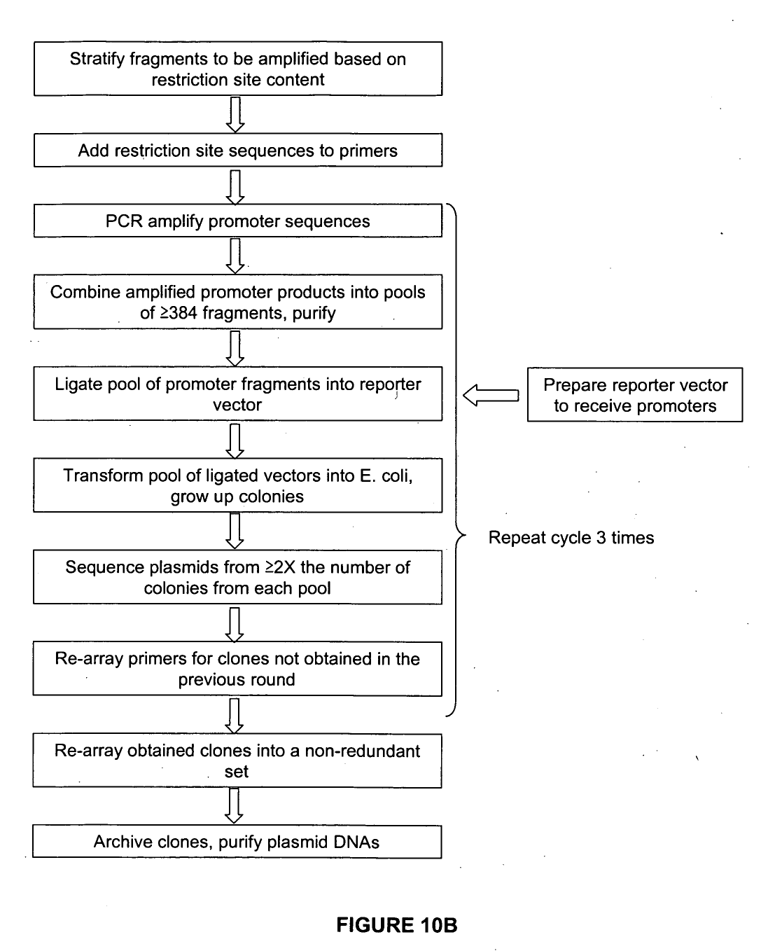

FIG. 10A schematically illustrates an embodiment of the method for isolating promoters and cloning them into a reporter vector. As illustrated in FIG. 10A and further described in Example 1, about 500-700 bp of the predicted promoter sequences are PCR amplified and cloned into a reporter (e.g., luciferase) vector via a recombination-based cloning system. Each of the recombination reaction containing each of the promoter-reporter construct is transformed into bacteria, and the clones are screened by PCR and analyzed for containing the correct constructs.

FIG. 10B schematically illustrates another embodiment of the method for isolating promoters and cloning them into a reporter vector. As illustrated in FIG. 10B and further described in Example 2, promoter fragments are stratified and amplified based on restriction site content to maximize the number of promoters to be cloned. If a single restriction enzyme pair is used for cloning, those fragments that contained internal restriction sites would have to be filtered out, resulting in a loss of a significant number of promoters. According this embodiment, at least 3 restriction enzyme pairs are used that are compatible with the reporter vector. By stratifying the target promoter fragments based on these enzyme pairs, more than 98% of the promoters in the genome can be cloned. The amplified promoter products are pooled and ligated into a reporter vector. By using a pooling and sequencing strategy, a tremendous economy of scale can be achieved. By pooling the PCR products, only a small number of digestions, ligations, and transformations need to be performed, which saves considerable amounts of time and costs associated with these treatments. To capture nearly all of the fragments in the pool, at least 3 cycles of sequencing-arraying with primers of the clones are performed.

4. Libraries of Expression Constructs

In another embodiment, this invention provides libraries of expression constructions comprising the genomic segments of this invention. The library comprises a collection of members, each of which contains a different nucleic acid segment from the genome. The expression constructs are recombinant nucleic acid molecules comprising a nucleic acid segment of this invention operably linked with a heterologous reporter sequence. A nucleotide sequence is operably linked with an expression control sequence when the nucleotide sequence is under the transcriptional regulatory control of the expression control sequence. The reporter sequence is heterologous to the genomic segment in that it is not naturally under the transcriptional regulatory control of the genomic segment sequence in the genome from which the nucleic acid segment comes. This recombinant nucleic acid molecule is further comprised within a vector that can be used to either infect or transiently or stably transfect cells and that may be capable of replicating inside a cell.

It should be noted that other than transcriptional promoters, libraries and arrays can be built for other types of regulatory elements following a similar principle to that for promoters described above. The vectors used in each case may be slightly different, however each preferably still contains a reporter cassette or construct. Different types of regulatory elements may be cloned in different positions relative to the reporter cassette.

4.1. Reporter Sequences

This invention contemplates a number of different reporter sequences that may be under the control of the transcriptional regulatory elements of the genomic segments.

In one embodiment, the reporter sequence encodes a reporter protein, such as a light emitting protein (e.g., luciferase, a flourescent protein (e.g., red, blue and green fluorescent proteins), alkaline phosphatase, secreted embryonic alkaline phosphatase (SEAP), chloramphenicol acetyl transferase (CAT), hormones and cytokines. In libraries using proteins that emit a detectable signal it may be useful, but not essential, for all of the reporter proteins to emit the same signal. This simplifies detection during high-throughput methods.

Alternatively, the expression constructs in the library may contain different reporter sequences which emit different detectable signals. For example, the reporter sequence in each of the constructs can be a unique, pre-determined nucleotide barcode. This allows assaying a large number of the nucleic acid segments in the same batch or well of cells. In an embodiment, in each construct a unique promoter sequence is cloned upstream of a unique barcode reporter sequence yielding a unique promoter/barcode reporter combination. The active promoter can drive the production of a transcript containing the unique barcode sequence. Thus, in a library of expression constructs, each promoter's activity produces a unique transcript whose level can be measured. Since each reporter is unique, the library of expression constructs can be transfected into one large pool of cells (as opposed to separate wells) and all of the RNAs may be harvested as a pool. The levels of each of the barcoded transcripts can be detected using a microarray with the complementary barcode sequences. So the amount of fluorescence on each array spot corresponds to the strength of the promoter that drove the nucleotide barcode's transcription.

Optionally, the expression constructs in the library may contain a first reporter sequence and a second reporter sequence. The first reporter sequence and a second reporter sequence are preferred to be different. For example, the first reporter sequence may encode the same reporter protein (e.g., luciferase or GFP), and the second reporter sequence may be a unique nucleotide barcode. In this way, transcription can yield a hybrid transcript of a reporter protein coding region and a unique barcode sequence. Such a construct could be used either in a well-by-well approach for reading out the signal emitted by the reporter protein (e.g., luminescence) and/or in a pooled approach by reading out the barcodes.

By using the unique, molecular barcode for each member of the library, a large library (e.g. a library with diversity of at least 100, 150, 200, 500, 1000, 2000, or 25,000) can be assayed in a single container (such as a vial or a well in a plate) rather than in thousands of individual wells. This approach is more efficient and economic as it can reduce costs at all levels: reagents, plasticware, and labor.

4.2. Vectors

The expression construct may be any vector that facilitates expression of the reporter sequence in the construct in a host cell. Any suitable vector can be used. There are many known in the art. Examples of vectors that can be used include, for example, plasmids or modified viruses. The vector is typically compatible with a given host cell into which the vector is introduced to facilitate replication of the vector and expression of the encoded reporter. Examples of specific vectors that may be useful in the practice of the present invention include, but are not limited to, E. coli bacteriophages, for example, lambda derivatives, or plasmids, for example, pBR322 derivatives or pUC plasmid derivatives; phage DNAs, e.g., the numerous derivatives of phage 1, e.g., NM989, and other phage DNA, e.g., M13 and filamentous single stranded phage DNA; yeast vectors such as the 2μ plasmid or derivatives thereof; vectors useful in eukaryotic cells, for example, vectors useful in insect cells, such as baculovirus vectors, vectors useful in mammalian cells such as retroviral vectors, adenoviral vectors, adenovirus viral vectors, adeno-associated viral vectors, SV40 viral vectors, herpes simplex viral vectors and vaccinia viral vectors; vectors derived from combinations of plasmids and phage DNAs, plasmids that have been modified to employ phage DNA or other expression control sequences; and the like.

5. Recombinant Cells

In another aspect this invention provides recombinant cells comprising the expression libraries of this invention. Two different embodiments are contemplated in particular.

In a first embodiment each cell or group of cells comprises a different member of the expression library. Such a library of cells is particularly useful with the arrays of this invention. Typically, the library is indexed. For example, each different cell harboring a different expression vector can be maintained in a separate container that indicates the identity of the genomic segment within. The index also can indicate the particular gene or genes that is/are under the transcriptional regulatory control of the sequences naturally in the genome.

In a second embodiment, a culture of cells is transfected with a library of expression constructs so that all of the members of the library exist in at least one cell and each cell has at least one member of the expression library. The second embodiment is particularly useful with libraries in which the reporter sequences are unique sequences that can be detected independently.

Useful cell types include primary and transformed mammalian cell lines to which exogenous DNA may be introduced by lipofection, electroporation, or infection. Libraries in such cells may be maintained in growing cultures in appropriate growth media or as frozen cultures supplemented with Dimethyl Sulfoxide and stored in liquid Nitrogen.

6. Functional Arrays: Multiwell Plates

In another aspect, this invention provides devices comprising multiwell plates, also called macroarrays, each well of which contains a different member of expression library of this invention. While this invention contemplates multiwell plates in a variety of formats and array layouts, there are a number of standard formats well known in the art. In particular, it is contemplated that a library of expression vectors can be contained within the wells of one or more 96-well, 384-well or 1536-well microtiter plates.

In a preferred embodiment, an array of diverse, different gene expression regulatory elements is provided, preferably an array of different transcriptional promoters. The diversity of the array is preferably at least at least 50, optionally at least 80, 120, 160, 200, 400, 500, 600, 800, 1000, 1500, 2000, 3000, 5000, 8000, 10,000, or 25,000. Also provided are a library of expression vectors each of which comprises a different gene expression regulatory element, preferably operably linked with a reporter sequence such that expression of the reporter sequence is under transcriptional control of each of the gene expression regulatory element.

For the plasmid functional macroarray, each member of the promoter library may be transfected separately into E. coli. Each E. coli stock may be grown up to make >100 ug of each plasmid and then the plasmid DNAs are purified from the rest of the parts of the bacterial cells. Small aliquots of each plasmid (with appropriate transfection reagents) may be arrayed in a 96-well, 384-well, or 1536-well format. This macroarray of plasmids can be used for a number of different applications. Its primary use is preferably in the transfection of living cells. Once the plasmids are delivered to living cells, the amount of activity detected from the reporter gene product reflects the transcriptional activity provided by the promoter fragment. Thus, the plasmid macroarray enables the high-throughput study of promoter function in living cells. Promoter functional assays may be conducted in a variety of cell types, in response to a change in the cellular environment, in response to an alteration in a gene sequence or function, or in the presence of a small molecule or protein sequence of interest.

In a more preferred embodiment, a highly diverse array of expression vectors is provided which comprise at least 200 different gene expression regulatory elements in the expression vectors. As described in detail in the EXAMPLE section, surprisingly the inventors discovered that promoter functional assays in a 384-well format could efficiently and accurately measure transcriptional activities of a diverse promoter library comparable to a 96-well format. The variance between replicate experimental wells in either format is almost identical and the correlation of measurements between 96 and 384-well format is very high (R=0.98). In addition, the reporter activity for even weak promoters is still within the linear range of detection for commercially available luminometers. Thus, such highly diverse functional arrays can be used efficiently and effectively to measure transcriptional activities of a large number of regulatory elements under various conditions in a single panel or experiment, e.g., in a 384-well or higher density format.

6.1. Microtiter Arrays with “naked” nucleic acids

In one embodiment, this invention contemplates microtiter arrays in which the wells contain expression vectors outside of a cellular environment. In particular, microtiter arrays are contemplated in which each well contains an expression vector of this invention in dried form. Such devices can be stored and shipped easily and are ready for use. In other embodiments the wells contain a solution comprising the nucleic acids. In another embodiment, the solution can contain all the elements necessary for transfecting cells that are added to the plates.

6.2. Microtiter Arrays with recombinant cells

Microtiter arrays in which each well comprises a recombinant cell containing an expression vector of this invention are useful for carrying out high-throughput screening assays. To generate such arrays, DNA may be mixed with serum-free media and a transfection reagent (such as a lipofection reagent), incubated, and added to a group of cells. After an incubation time, the exogenous DNA will be present in the cells. Alternate methods for delivery include electroporation and infection.

7. Functional Arrays: Nucleic Acid Probe Arrays

In another aspect this invention provides DNA arrays in which the probes attached to a solid substrate comprise sequences from the nucleic acid segment libraries of this invention. Methods of making nucleic acid arrays are well known in the art. See, for example, U.S. Pat. Nos. 5,807,522 and 6,110,426 (Brown and Shalon); 6,054,270 and 6,054,270 (Southern); and 6,040,193; 5,744,305; 5,871,928; 6,610,482; 6,261,776; 6,291,183 (Affymetrix).

Methods and techniques applicable to array synthesis also have been described in U.S. Pat. Nos. 5,143,854, 5,242,974, 5,252,743, 5,324,633, 5,384,261, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, and 6,090,555. All of the above patents incorporated herein by reference in their entireties for all purposes.

The sequence of the probe can comprise the entire sequence of a genomic segment of this invention. Alternatively, a transcription regulatory sequence of this invention can be represented by one or more probes comprising a sequence of at least 21 nucleotides from a transcription regulatory sequence. The sequence can be between 21 and 35 nucleotides long, between 36 and 45 nucleotides long, between 46 and 55 nucleotides longs between 56-65 nucleotides long, or longer. In certain embodiments, a transcriptional regulatory sequence is represented by 2, 3, 4, 5, 6, 7, 8, 9 or 10 probes comprising overlapping and/or non-overlapping nucleotides sequences from the transcriptional regulatory sequence. The probes of this invention can be single stranded or double stranded.

To construct a spotted promoter microarray, small aliquots of plasmid DNA representing each member of the promoter library may be used. Because each plasmid in the library is made up of the same vector backbone with a unique promoter insert, primers to the vector sequence flanking the promoter insert can be designed to allow PCR amplification of the unique insert in each vector using the same set of primers for the entire library. An individual PCR reaction is then conducted for each member of the library generating a large amount of PCR product representing the unique promoter fragment. Being amplified from a plasmid template, the PCR reaction should be very robust and consistent across all promoters, which may not the case if they were amplified from genomic DNA. These purified PCR products are then used to make a spotted microarray on a glass slide either by contact print or ink-jet deposition where each feature represents a unique promoter fragment.

The microarrays of this invention can be used for a number of different experimental purposes. One application is in conjunction with chromatin immunoprecipitation (ChIP). Chromatin immunoprecipitation involves cross-linking proteins to DNA in a living cell, shearing up the chromatin/DNA complex, and immunoprecipitating with an antibody to a protein of interest. The challenge is to identify the DNA sequences that are bound to the protein of interest. One option is to hybridize the ChIP DNA to a microarray to identify the targets that are enriched ChIP. Many researchers already hybridize such experimental outputs to tiled-oligo microarrays to identify binding sites across the genome. However, such experiments are prohibitively expensive for many labs. The spotted promoter microarrays or promoter-specific oligo-based micorarrays provided in the present invention meet the demands of researchers conducting ChIP experiments to study promoters specifically and are looking for a less expensive alternative to tiled oligo arrays.

Another application of this spotted promoter microarray or promoter-specific oligo-based microarray is for conducting genome-wide assays of promoter DNA-methylation status, preferably using the method for determining methylation status of regulatory elements in a high throughput manner as described above, or using a number of different techniques exist for differentially labeling hypo-methylated and hyper-methylated DNA sequences. The results of this differential labeling at promoter sequences can be visualized on the spotted promoter microarray or promoter-specific oligo-based microarray to determine which promoters are under or over-methylated.

In general, any technique that results in differential labeling of one type of sequence over another can be applied to a spotted promoter microarray or promoter-specific oligo-based microarray including DNA-hypersensitivity, histone-modifications, and more. Compared to other oligo-based promoter arrays developed by others in the field, the benefit for using this spotted promoter microarray or promoter-specific oligo-based microarray for such an assay is that the fragments on the array are the exact same fragments that may be tested for functional activity using the plasmid functional macroarray system.

8. Kits

In an embodiment, a kit is provided for a functional macroarray of promoters. The kit includes: transfection-ready set of promoter plasmids arrayed in 96 or 384 wells. The kit may further include: reporter assay substrates; reagents for induction or repression of a particular biological pathway (cytokines or other purified proteins, small molecules, cDNAs, siRNAs, etc.), and/or data analysis software.

In addition, kits are provided which comprise reagents and instructions for performing methods of the present invention, or for performing tests or assays utilizing any of the compositions, libraries, arrays, or assemblies of articles of the present invention. The kits may further comprise buffers, restriction enzymes, adaptors, primers, a ligase, a polymerase, dNTPS and instructions necessary for use of the kits, optionally including troubleshooting information.

In another embodiment, a kit is provided for a CHIP assay. The kit includes: a spotted promoter microarray or promoter-specific oligo-based microarray; and one or more ChIP-grade antibody. The kit may further include: DNA amplification and labeling reagents; and/or data analysis software.

In yet another embodiment, a kit is provided for a DNA-methylation assay, comprising: a spotted promoter microarray or promoter-specific oligo-based microarray; and enzyme sets for methylation assay. The kit may further include: DNA amplification and labeling reagents; and/or data analysis software.

In still another embodiment, an assembly of articles is provided for a comprehensive promoter analysis, comprising: a plasmid functional macroarray kit; a promoter microarray kit for ChIP; and a DNA-methylation assay kit. The assembly may further include: analysis software for data integration.

9. Methods of Use

9.1. Introduction

The functional arrays of this invention are useful for performing high-throughput experiments to screen activity of the transcriptional regulatory sequences of this invention. This increase in throughput of functional promoter assays is important for several reasons: First, removing limits on the numbers of regulatory elements that can be assayed in a single panel allows researchers to interrogate elements corresponding to entire biological networks in a single experiment. For example, there are well over a thousand genes that are implicated in cancer development and progression. By scaling the promoter functional assays to include promoters of over a hundred of genes, for example over a thousand genes, researchers can study all of the promoters of all cancer related genes at once.

Furthermore, many genes have alternative promoters, therefore, increasing the throughput of these assays will allow alternative promoters to be included in a study. Particular alternative promoters have been shown to confer distinct regulation of different isoforms of the same gene, and this is an important aspect of promoter biology that needs to be included in a comprehensive study.

Increasing throughput will also enable the study of promoter sequence variants on a much larger scale. Since each promoter in the genome will likely have several SNPs on average, increasing the throughput will allow a comprehensive analysis of all existing haplotypes of a given set of promoters rather than having to pick the most common haplotypes.

Further, assaying a large number of regulatory elements in a single experiment will allow researchers to conduct statistical analyses with much greater power. The previous promoter activity experiments have shown that promoter activity data often breaks down into clusters of similar activity, just like gene clusters in microarray expression experiments. In an experiment with a small number of promoters, each sub-cluster is often too small to make any statistically significant claims as to important features unique to that cluster, such as the over-representation of certain motifs or higher-order sequence characteristics. The larger the dataset, the more power there is to perform these statistical analyses; and a diversity of promoters beyond 200 or 1,000 in a single panel would be very desirable.

A wide variety of biological samples can be tested according to the present invention, including isolated cells, cell cultures, body fluid (blood, bone marrow, saliva, spinal cord fluid, and semen), biopsy and tissue samples. The tissue samples can be any which are derived from a patient, whether human, other domestic animal, or veterinary animal. Vertebrate animals are preferred, such as humans, mice, horses, cows, dogs, and cats. The samples may be fixed or unfixed, homogenized, lysed, cryopreserved, etc. It is most desirable that matched tissue samples be used as controls. Thus, for example, a suspected colorectal cancer tissue will be compared to a normal colorectal epithelial tissue.

In one aspect of the invention, a method is provided for determining transcriptional regulatory activity of a plurality of different nucleic acid segments. The method comprises: operably linking each of the plurality of different nucleic acid segments with a reporter sequence in an expression vector such that expression of the reporter sequence is under transcriptional control of each of the different nucleic acid segments; expressing the reporter sequence; and determining the expression level of the reporter controlled by each of the different nucleic acid segments.

The present invention also provides compositions, assemblies, and kits, preferably for carrying out the methods of the present invention. For example, an array of different gene expression regulatory elements is provided, preferably an array of different transcriptional promoters. The diversity of the array is preferably at least at least 50, optionally at least 80, 120, 160, 200, 400, 500, 600, 800, 1000, 1500, 2000, 3000, 5000, 8000, 10,000, or 25,000. Also provided are a library of expression vectors each of which comprises a different gene expression regulatory element, preferably operably linked with a reporter sequence such that expression of the reporter sequence is under transcriptional control of each of the gene expression regulatory element.

9.2. Methods of High-Throughput Screening of Promoter Activity

9.2.1. Basic Method

A multiwell plate array of cell harboring the expression constructs of this invention is useful for high-throughput screening of promoter activity. In the basic method, a multiwell plate having a member of an expression library of this invention in each well is filled with a cell type of interest under conditions so that the cells are transfected with the vectors. The cells are then incubated under conditions chosen by the operator. Cells in which the promoters are “turned on” will express the reporter sequences under their transcriptional control. The investigator then checks each well of the device to measure the amount of reporter transcribed. Generally, this involves measuring the signal produced by a reporter protein encoded by the reporter sequence. For example, if the reporter protein is a fluorescent protein, then light is directed to each well and the amount of fluorescence is measured. The amount of signal measured is a function of the expression of the reporter sequence which, in turn, is a function of the activity of the transcriptional regulatory sequences.

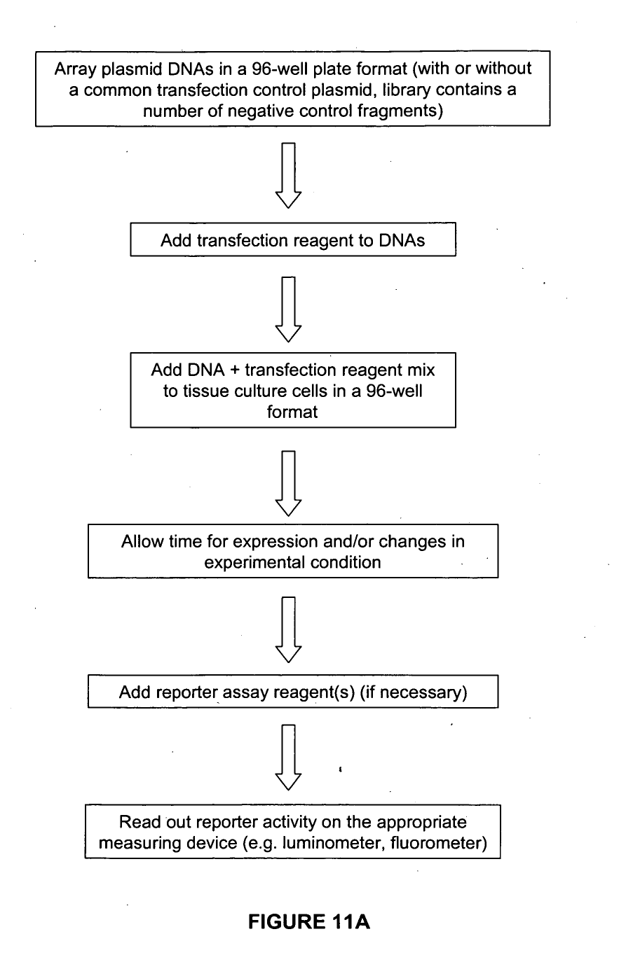

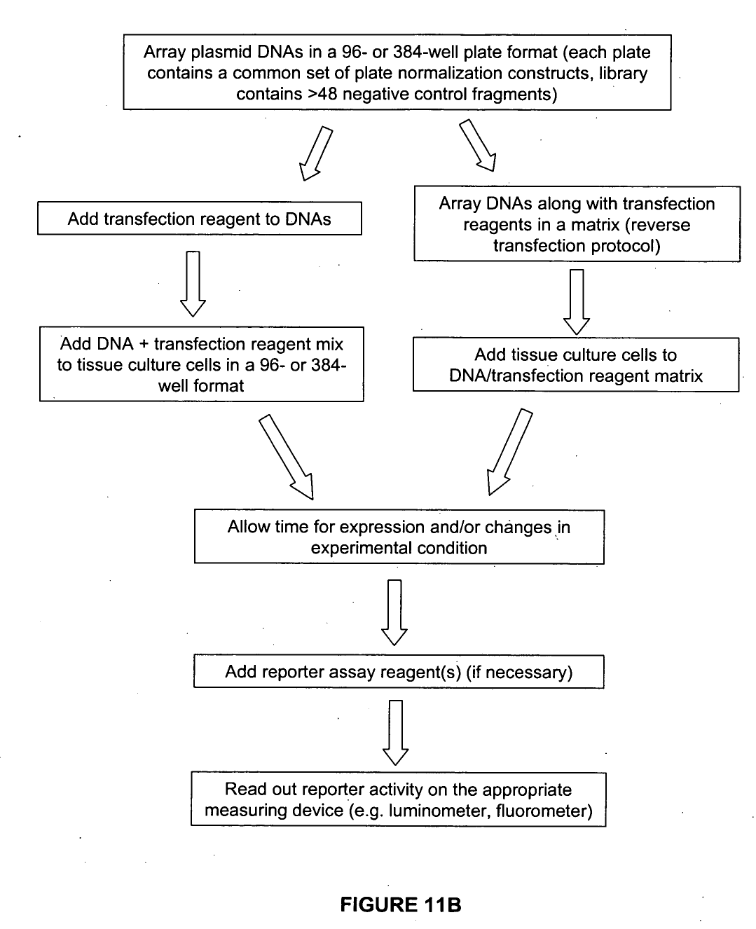

FIG. 11A schematically illustrates an embodiment of the method for detecting transcriptional activity of a plurality of promoters in a high throughput manner. As illustrated in FIG. 11A and further described in Example 1, a large number of promoters contained in a library of reporter constructs are arrayed in a 96-well plate and transfected into tissue culture cells. Expression of the reporter is detected and correlated with the transcriptional activity of the promoters.

FIG. 11B schematically illustrates another embodiment of the method for detecting transcriptional activity of a plurality of promoters in a large scale, high throughput manner. As illustrated in FIG. 11B and further described in Example 2, more than a hundred promoters contained in a library of reporter constructs are arrayed in a multi-well format (e.g. a 96-well or 384-plate format) and transfected into tissue culture cells. The library of reporter constructs and a transfection reagent mix can be transfected or added into tissue culture cells in a 96- or 394-well format. Alternatively and more efficiently, the library of reporter constructs and a transfection reagent mix are arrayed in a 96- or 394-well format and tissue culture cells are added into the wells later (the so-called “reverse transfection”). Expression of the reporter is detected and correlated with the transcriptional activity of the promoters.

By expanding from 96-well plates to 384-well plates and pre-aliquoting the plasmid DNAs, throughput can be expanded from hundreds to >1,000 promoter assays in a single experiment. Scaling this experiment to more than 1,000 independent promoter fragments greatly improves the scope of the research project and gives more power to the downstream statistical analyses of these data. The larger the dataset, the more amenable it is to approaches such as principle component analysis and hierarchical clustering. By studying more than 1,000 promoters at once in multiple experiments, sub-clusters of promoter activity data are large enough to look for over-represented motifs or higher-order sequence characteristics.

As further described in Example 2, the steps of the process are refined to increase the accuracy of promoter prediction and efficiency of every step, thus enabling functionally assaying multiple hundreds or thousands of promoters in a single experiment and allowing thorough interrogations of entire biological pathways in a single experiment. Instead of having to choose only their best candidates for assay because of a limitation on size of the experiment, by using the present invention researchers can include hundreds of genes of interest, therefore receiving much more complete and biologically relevant datasets.

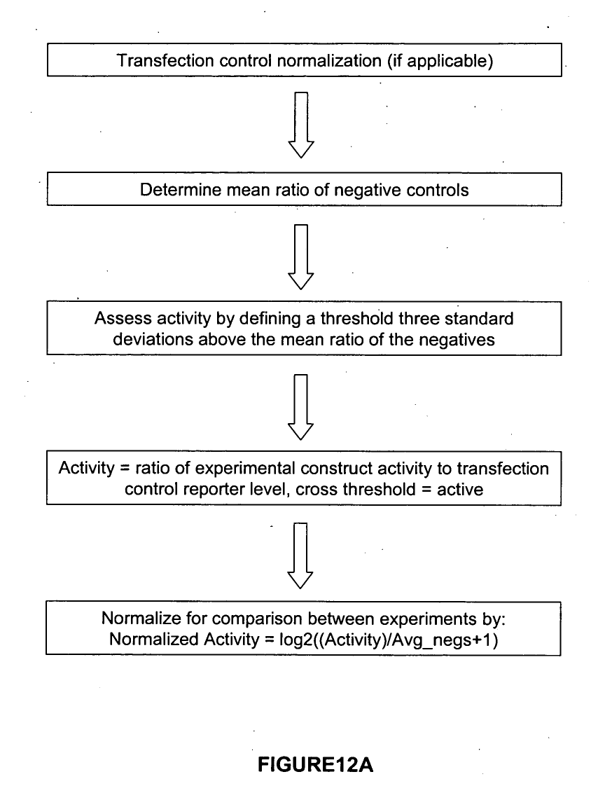

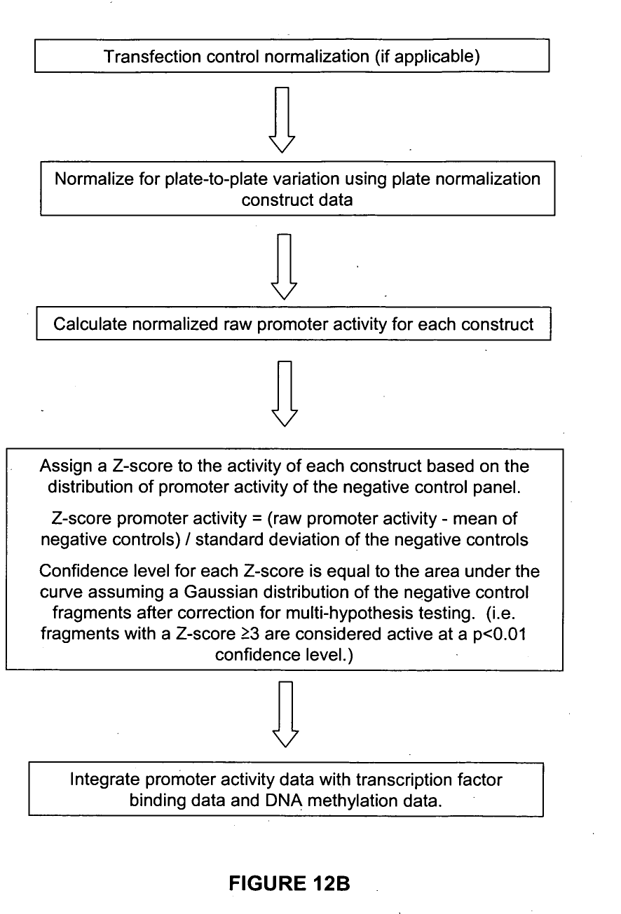

FIG. 12A schematically illustrates an embodiment of the method for analyzing data obtained in a functional assay of a plurality of promoters. As illustrated in FIG. 12A and further described in Example 1, a much larger set of negative control fragments (e.g., about 100) is utilized to get a more confident measure of the background signal from random genomic fragments.

FIG. 12B schematically illustrates another embodiment of the method for analyzing data obtained in a functional assay of a large number of promoters. As illustrated in FIG. 12B and further described in Example 2, a set of plate normalization constructs are utilized in the promoter functional assays described above to allow control for plate-to-plate variation in cell growth, transfection, and assay conditions. The values of each well in a plate are normalized across an experiment based on this set of controls. A Z-score-based analysis allows for even better comparison of data between experiments because it takes into account the variance in the distribution of the negative control values.

9.2.2. Detecting The Effect Of Perturbation

In another embodiment of the methods of this invention, the investigator can test the effect of a system perturbation on the activity of a library of transcription regulatory sequences. The basic method described above is performed under a first set of conditions to determine the amount of activity of the promoters. Then the cells are perturbed, i.e., subject to different conditions, in a manner chosen by the investigator. Perturbations can include, for example, exposing the cells to a test compound, changing environmental conditions such as temperature, pH or nutrition, or genetically modifying the cells to introduce new or modified genetic material or changes in amounts of genetic material. After perturbation, the amount of activity of each promoter in the library is examined and compared to its activity in the first state. Promoters that show altered activity can be isolated and studied further. In this way it can be determined, for example, which transcription regulatory sequences have their activity modulated by a compound of interest.

In a variation of this method, the test is performed in parallel. That is, two identical devices of this invention are examined for promoter activity. However, one device is subjected to a first set of conditions and the other device is subjected to a second set of conditions. In this way, the relative activity of the transcription regulatory sequences under the two conditions can be examined, and sequences that have different activity can be identified and isolated.

9.2.3. Comparison Between Cell Types

It also can be useful to identify differences in transcription regulatory sequence activity in two cell types. For example gene expression differs when cells transform from normal to cancerous. Promoters that are overactive in cancer cells may be targets of pharmacological intervention. The arrays of this invention are useful to identify such transcription regulatory sequences. Accordingly, the investigator provides two sets of arrays comprising expression constructs in the wells. Once cell type is used for transformation in a first device and a second cell type, for transformation in a second device. The expression of reporter sequences between the two devices is compared to identify those expressed differently in the two cell types.

9.2.4. Tests in Mixed Cultures

Using expression constructs in which the transcription regulatory sequences are operably linked to unique reporter sequences opens the possibility of performing tests without the use of multiwell plates. In such situations a single culture of cells contains the entire expression library distributed among the cells. The culture can be incubated under conditions chosen by the investigator. Then the expression products are isolated. As described in the section entitled “Reporter Sequences” because each one has a unique nucleotide sequence tag or barcode associated with its partner nucleic acid segment, the amount of each of the reporter sequences can be measured by measuring the amount of transcript comprising each unique sequence. For example, the molecules can be detected on a DNA array that contains probes complementary to the unique sequences. The amount of hybridization to each probe indicates the amount of the reporter sequence expressed, which, in turn, reflects the activity of the transcription regulatory sequences.

10. Promoter Variants

10.1. Identification of Promoter Variants Having Different Activity

There are many published accounts of sequence changes in promoter regions causing changes in human phenotypes or disease status. One of the classic examples is Beta-thalassemia. Just in the past few years, promoter sequence changes have also been linked to cardiovascular disease, Alzheimer disease, schizophrenia, bi-polar disorder, glaucoma, epilepsy, multiple sclerosis and lupus among others. Very recent work has also shown that a 3 base pair deletion in the promoter of the SRY gene is associated with complete sex reversal. Functional variants in the promoter of the C-reactive Protein gene have also been identified. This is particularly important because serum levels of C-reactive Protein are a key predictor of heart disease risk.

Association studies and efforts such as the Hap-Map project often detect potentially biologically interesting variation in the sequences of promoters between individuals in the human population. The big question then revolves around whether or not those sequence changes actually affect the function of the promoter or if they are essentially silent, non-functional changes. The assays provided herein can be used to compare the activity of promoter variants

This invention provides methods for identifying variants in transcriptional regulatory sequences that are associated with phenotypic differences in a population. The methods involve the following steps. First, one identifies and selects transcriptional regulatory sequences that exhibit sequence polymorphism in a population, such as SNPs, from a database of sequences or other information source. Then, one tests these variants for transcripion regulation activity in an assay of this invention. Polymorphic forms that exhibit differences in activity in these assays are selected for further study. In such a study, two populations are selected that have different phenotypic traits. For example, a first population having a disease and a second population not having the disease are selected. Generally, the investigator will select a promoter that regulates expression of a gene suspected to have some connection with the phenotype in question. The population is large enough to provide statistically significant results. Each individual in the two populations are then tested to determine which form of the variant the individual has. Statistical analysis will indicate whether the polymorphic form is associated with the phenotype. Polymorphic forms found to associate with a specific phenotype then can be used in diagnostic tests to determine how likely it is that the individual has the phenotype.

More generally, the products provided in the present invention can also be used to correlate polymorphisms in a gene expression regulatory element with a phenotypic trait more efficiently. Correlation of individual polymorphisms or groups of polymorphisms with phenotypic characteristics is a valuable tool in the effort to identify DNA variation that contributes to population variation in phenotypic traits. Phenotypic traits include physical characteristics, risk for disease, and response to the environment. Polymorphisms that correlate with disease are particularly interesting because they represent mechanisms to accurately diagnose disease and targets for drug treatment. Hundreds of human diseases have already been correlated with individual polymorphisms but there are many diseases that are known to have an, as yet unidentified, genetic component and many diseases for which a component is or may be genetic.

Many diseases may correlate with multiple genetic changes making identification of the polymorphisms associated with a given disease more difficult. One approach to overcome this difficulty is to systematically explore the limited set of common gene variants for association with disease. The functional studies enabled by a regulatory element macroarray will facilitate the sorting out of sequence variants that affect the function of a regulatory element away from those that do not. Therefore, researchers may look for correlation of functional sequence variants with phenotypic traits, changing the focus from finding variants merely correlated with a phenotype towards identifying variants that may cause a particular phenotype.

To identify correlation between one or more alleles in the gene expression regulatory region and one or more phenotypic traits, individuals are tested for the presence or absence of polymorphic markers or marker sets and for the phenotypic trait or traits of interest. The presence or absence of a set of polymorphisms is compared for individuals who exhibit a particular trait and individuals who exhibit lack of the particular trait to determine if the presence or absence of a particular allele is associated with the trait of interest. For example, it might be found that the presence of allele A1 at polymorphism A in the promoter region of a gene correlates with heart disease. As an example of a correlation between a phenotypic trait and more than one polymorphism, it might be found that allele A1 at polymorphism A and allele B1 at polymorphism B correlate with a phenotypic trait of interest.

Markers or groups of markers in a gene expression regulatory region that correlate with the symptoms or occurrence of disease can be used to diagnose disease or predisposition to disease without regard to phenotypic manifestation. To diagnose disease or predisposition to disease, individuals are tested for the presence or absence of polymorphic markers or marker sets that correlate with one or more diseases. If, for example, the presence of allele A1 at polymorphism A correlates with coronary artery disease then individuals with allele A1 at polymorphism A may be at an increased risk for the condition.

Individuals can be tested before symptoms of the disease develop. Infants, for example, can be tested for genetic diseases such as beta-thalassemia at birth. Individuals of any age could be tested to determine risk profiles for the occurrence of future disease. Often early diagnosis can lead to more effective treatment and prevention of disease through dietary, behavior or pharmaceutical interventions. Individuals can also be tested to determine carrier status for genetic disorders. Potential parents can use this information to make family planning decisions.

Individuals who develop symptoms of disease that are consistent with more than one diagnosis can be tested to make a more accurate diagnosis. If, for example, symptom S is consistent with diseases X, Y or Z but allele A1 at polymorphism A correlates with disease X but not with diseases Y or Z an individual with symptom S is tested for the presence or absence of allele A1 at polymorphism A. Presence of allele A1 at polymorphism A is consistent with a diagnosis of disease X.

10.2. Pharmacogenomics

In addition, the products provided in the present invention can also be used for pharmacogenomics. Pharmacogenomics refers to the study of how your genes affect your response to drugs. There is great heterogeneity in the way individuals respond to medications, in terms of both host toxicity and treatment efficacy. There are many causes of this variability, including: severity of the disease being treated; drug interactions; and the individuals age and nutritional status. Despite the importance of these clinical variables, inherited differences in the form of genetic polymorphisms can have an even greater influence on the efficacy and toxicity of medications. Genetic polymorphisms in drug-metabolizing enzymes, transporters, receptors, and other drug targets have been linked to inter-individual differences in the efficacy and toxicity of many medications. (See, Evans and Relling, Science 286: 487-491 (2001) which is herein incorporated by reference for all purposes). The functional studies enabled by a regulatory element macroarray will facilitate the sorting out of sequence variants that affect the function of a regulatory element away from those that do not. Therefore, researchers may look for correlation of functional sequence variants with phenotypic traits, changing the focus from finding variants merely correlated with a phenotype towards identifying variants that may cause a particular phenotype.

In a manner similar to that above, transcription regulatory sequences encoding genes suspected to be involved in drug metabolism are screened to identify those that exist in polymorphic forms in a population. These sequences are tested for functional differences in the assays of this invention. Those that exhibit functional differences are then examined in populations having different responses to a drug to determine whether a polymorphic form is associated with differences in drug reaction.

An individual patient has an inherited ability to metabolize, eliminate and respond to specific drugs. Correlation of polymorphisms in a gene expression regulatory region with pharmacogenomic traits identifies those polymorphisms that impact drug toxicity and treatment efficacy. This information can be used by doctors to determine what course of medicine is best for a particular patient and by pharmaceutical companies to develop new drugs that target a particular disease or particular individuals within the population, while decreasing the likelihood of adverse affects. Drugs can be targeted to groups of individuals who carry a specific allele or group of alleles. For example, individuals who carry allele A1 at polymorphism A may respond best to medication X while individuals who carry allele A2 respond best to medication Y. A trait may be the result of a single polymorphism but will often be determined by the interplay of several genes.

In addition some drugs that are highly effective for a large percentage of the population, prove dangerous or even lethal for a very small percentage of the population. These drugs typically are not available to anyone. Pharmacogenomics can be used to correlate a specific genotype with an adverse drug response. If pharmaceutical companies and physicians can accurately identify those patients who would suffer adverse responses to a particular drug, the drug can be made available on a limited basis to those who would benefit from the drug.

Similarly, some medications may be highly effective for only a very small percentage of the population while proving only slightly effective or even ineffective to a large percentage of patients. Pharmacogenomics allows pharamaceutical companies to predict which patients would be the ideal candidate for a particular drug, thereby dramatically reducing failure rates and providing greater incentive to companies to continue to conduct research into those drugs.

10.3. Marker-Assisted Breeding

The products provided in the present invention can also be used for marker assisted breeding. Genetic markers can assist breeders in the understanding, selecting and managing of the genetic complexity of animals and plants. Agriculture industry, for example, has a great deal of incentive to try to produce crops with desirable traits (high yield, disease resistance, taste, smell, color, texture, etc.) as consumer demand increases and expectations change. However, many traits, even when the molecular mechanisms are known, are too difficult or costly to monitor during production. Readily detectable polymorphisms in a gene expression regulatory region which are in close physical proximity to the desired genes can be used as a proxy to determine whether the desired trait is present or not in a particular organism. This provides for an efficient screening tool which can accelerate the selective breeding process.

In a manner similar to that above, transcription regulatory sequences encoding genes suspected to be involved in the phenotypic trait of interest are screened to identify those that exist in polymorphic forms in a population. These sequences are tested for functional differences in the assays of this invention. Those that exhibit functional differences are then examined in populations having traits to determine whether a polymorphic form is associated with this trait.

It should be noted that the methods, libraries, arrays, kits and assemblies provided in the present invention are not limited to any particular type of nucleic acid sample: plant, bacterial, animal (including human) total genome DNA, RNA, cDNA and the like may be analyzed using some or all of the methods disclosed in this invention. The word “DNA” may be used below as an example of a nucleic acid. It is understood that this term includes all nucleic acids, such as DNA and RNA, unless a use below requires a specific type of nucleic acid.

11. Software

The present invention provides data analysis software that normalizes promoter strength measurements and calculates the statistical significance of each measurement with a background model. The data analysis algorithm first normalizes the data in each plate using a plurality (e.g., a set of 4, 8 or 16) standard controls. These normalized raw values for each experimental construct are then compared to the promoter activity of a panel of at least 48, 96, or 384 random genomic fragments to assess their significance above background. These random fragments can be chosen truly randomly throughout the genome or from middle exons of protein coding genes that are at least 1000 basepairs in length and at least 5000 bases from a known transcription start site. For each experiment, the average and standard deviation of the random fragment values are calculated. A z-score is then calculated for each experimental promoter activity from the following equation: Z-score promoter activity=(raw promoter activity−mean of random controls)/standard deviation of the random controls. The confidence level for each Z-score is equal to the area under the curve assuming a Gaussian distribution of the negative control fragments after correction for multi-hypothesis testing. (i.e. fragments with a Z-score ≧are considered active at a p<0.01 confidence level.) The Z-score transformed promoter activity data can then be compared to Z-transformed data of other types such as DNA methylation, chromatin IP combined with genomic microarrays, expression array data, etc.

12. Methylation

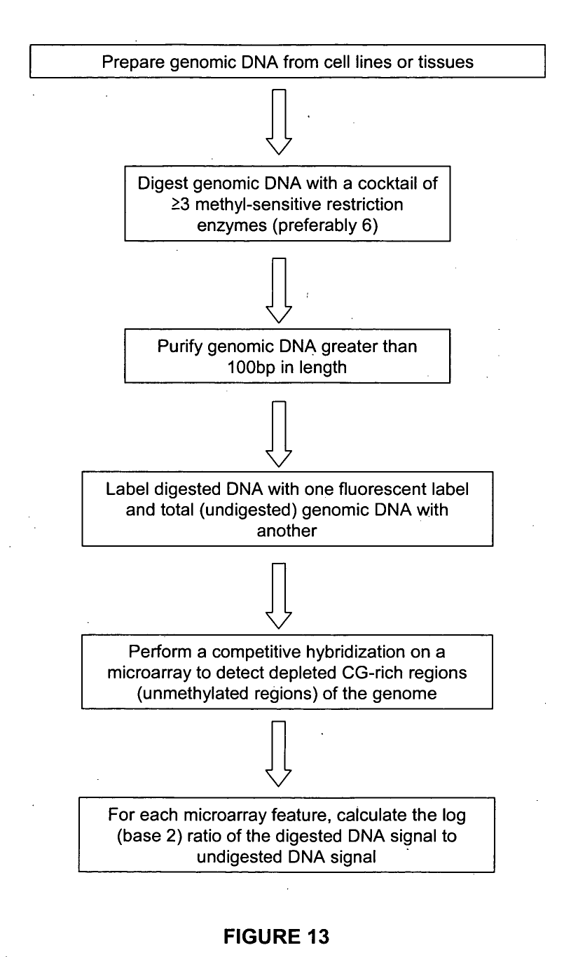

The present invention also provides a method for determining methylation status of CpG dinucleotides within a nucleic acid molecule, in particular, regulatory elements. In certain embodiments, the method is performed in a high throughput manner. Many regulatory elements are CpG-rich, and many CpG-rich regions represent regulatory elements. Therefore, measuring the methylation status of CpG-rich sequences provides insight into the function of many transcriptional regulatory elements. FIG. 13 schematically illustrates an embodiment of the method for large scale, high throughput determination of methylation status of CpG-rich sequence regions genome-wide. As illustrated in FIG. 13 and further described in Example 3, high-molecular weight genomic DNA is prepared from cell lines or tissues and digested with at least three (preferably 6) different methyl-sensitive restriction enzymes. If the CpG-rich sequences in DNA from the source are not methylated, the methyl-sensitive enzymes will cleave these sequences into small fragments. The digested DNA greater than 100 bp in length is purified and labeled with a detectable marker such as a fluorescent label. Undigested genomic DNA is labeled with a different detectable marker. Labeling can either proceed by cleavage and end-labeleing, or by hybridization of random labeled primers followed by extension of the primers. Both samples are applied in a competitive hybridization assay to a genomic microarray, such as a spotted promoter or CpG island array or an oligo array that tiles across genomic regions of interest. In DNA in which the CpG-rich areas are unmethylated, there will be a significant depletion of these CpG-rich regions, as this area will have been cleaved into small fragments less than 100 nucleotides. However, these regions will not be depleted in the un-digested DNA used as a control.

Individual methyl-sensitive restriction enzymes (restriction enzymes that cleave nucleic acid molecules having un-methylated recognition sequences, but not methylated recognition sequences) have been used previously to measure DNA-methylation, but they have usually been used to mark and retrieve the pieces of unmethylated DNA. The novel aspect of the approach is that it measures the depletion of these regions relative to the rest of the genome. Using a cocktail of enzymes, each with a different recognition site, enables a depletion of unmethylated regions that does not occur to the same extent under the treatment with any one enzyme alone. Examples of methylation-sensitive restriction enzymes include: AatII, AciI, AclI, AfeI, AgeI, AscI, AsiSI, AvaI, BceAI, BmgBI, BsaAI, BsaHI, BsiEI, BsiWI, BsmBI, BspDI, BspEI, BsrBI, BsrFI, BssHII, BstBI, BstUI, ClaI, EagI, FauI, FseI, FspI, HaeII, HgaI, HhaI, HinPII, HpaII, Hpy99I, HpyCH4IV, KasI, MluI, Nael, NarI, NgoMIV, NotI, NruI, PaeR7I, PmlII Pvui, RsrII, SacII, SalI, SfoI, SgrAI, SmaI, SnaBI, TilI, XhoI.

By using the method, DNA methylation status at CG-rich regions of the entire genome can be measured efficiently. The major advantage of this method is that it is very efficient, inexpensive, and measures over 97% of the “CpG islands” in the human genome with a very high specificity. DNA methylation is implicated in carcinogenesis and transcriptional regulation. Therefore, profiling the methylation status of the genome could help classify different cancers and explain mechanisms of gene regulation.

CpG Island and promoter arrays could be designed specifically for this assay. One embodiment of an oligonucleotide array design would be to implement an algorithm that specifically designs an array depending on the set of methyl-sensitive restriction enzymes used. This algorithm would first map a defined set of methyl-sensitive restriction enzyme recognition sites throughout a mammalian genome sequence of interest. Preferably more than 2 MSRE and approximately 6 MSRE would be used in this embodiment. A genome-wide map of the MSRE sites describes where the genomic DNA would be cut if it was not methylated at that location. After mapping a set of MSRE sites, the algorithm then calculates the distance between each neighboring MSRE site. The algorithm then clusters those MSRE sites that are less than 100 bp from each other and defines the coordinates of genomic regions bounded by at least 2 MSRE sites where the distance between neighboring MSREs within that region is less than 100 bp. These are regions of the genome that would be depleted if they were unmethylated and digested by the MSREs. Conversely, the algorithm also records those regions that would not be depleted upon digestion with the set of MSRE. These are regions that are greater than 100 bp in length that do not have MSRE recognition sequences closer than 100 bp to each other. These regions would not be depleted in the MSRE treatment and contain few, if any, CpG dinucleotides. The algorithm ultimately produces two lists of genomic regions: one that could be depleted by treatment with one or more MSRE and one that would not be depleted by treatment with one or more MSRE. Examples of depleted regions are shown in SEQ ID NOs. 45,296. Examples of recovered regions are shown in SEQ ID NOs. 45,496. The algorithm would then design oligonucleotide probes approximately 25, 30, 35, 40, 45, 50, 55, or 60 bases in length that cover 10%, 20%, 30%, 40%, 50%, 60%, 70%, 80%, 90%, or 99% of the putative “depleted regions” and another set of oligonucleotide probes approximately 25, 30, 35, 40, 45, 50, 55, or 60 bases in length that cover 10%, 20%, 30%, 40%, or 50% of the putative “recovered regions”. Hybridization and labelling of a genomic DNA sample treated with a plurality of MSRE and an untreated and labeled sample would then identify which regions were depleted, thus unmethylated in the genomic sample hybridized to the custom-designed array. The set of “recovered regions” serve as controls that are used to build an error model to measure the significance of depleted signals at putatively unmethylated regions.

Additionally, enzyme complexes that specifically cleave methylated DNA such as McrBC, could be used to perform the reciprocal experiment (identify depleted methylated regions). This approach could also be applied to whole tissues and other mammalian models.

The present invention relies on many patents, applications and other references for details known to those of the art. Therefore, when a patent, application, or other reference is cited or repeated below, it should be understood that it is incorporated by reference in its entirety for all purposes as well as for the proposition that is recited. As used in the specification and claims, the singular form “a,” “an,” and “the” include plural references unless the context clearly dictates otherwise. For example, the term “an agent” includes a plurality of agents, including mixtures thereof. An individual is not limited to a human being but may also be other organisms including but not limited to mammals, plants, bacteria, or cells derived from any of the above.

Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible subranges as well as common individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. The same holds true for ranges in increments of 10⁵, 10⁴, 10³, 10², 10, 10⁻¹, 10⁻², 10⁻³, 10⁻⁴, or 10⁻⁵, for example. This applies regardless of the breadth of the range.

The practice of the present invention may employ, unless otherwise indicated, conventional techniques of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example hereinbelow. However, other equivalent conventional procedures can, of course, also be used. Such conventional techniques can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), all of which are herein incorporated in their entirety by reference for all purposes.

### EXAMPLES

### Example 1

### Prediction and Transcriptional Assays of Putative Human Core Promoters in 1% of the Human Genome

In this example, several important biological questions regarding promoter function were addressed. The correlation of endogenous transcript levels and promoter activity for a sample of genes were calculated. While other transcriptional regulatory elements such as enhancers, silencers and insulators all modulate the function of promoters and affect steady state RNA levels in vivo, the contribution of promoters was quantified and demonstrate that in many cases promoters play a key role in controlling RNA levels.

The promoter activities of deletion constructs for a set of 45 promoters, allowing the identification of core promoter elements and other elements within the extended promoter that contribute to regulation of transcription initiation were studied. Finally, identification of significant overlaps between functional promoter regions and binding of TBP-associated factor (TAFL, also TAF11250) and RNA Polymerase 2 (RNAP II), and elements conserved among mammalian genomes was made, each of which were identified in independent experiments done by other ENCODE Consortium members. Together these results reveal an unprecedented view of promoter activity in 1% of the human genome and lend insight into promoter function in the genome as a whole.

Results

921 Predicted ENCODE Promoters Using Promoter Prediction Algorithm (PPA v1.1)

By aligning 153,645 human cDNAs to the genome and merging transcripts with overlapping exons on the same strand, 38,412 gene models in the human genome were predicted (See Methods). In agreement with previous observations, approximately 13,450 (35%) of these contained only putative single-exon transcripts (Imanishi et al. 2004). From these gene models, 56,940 were predicted potential transcription start sites in the genome, with roughly half of the genes predicted to have multiple promoters. Within the 30 Mb of the ENCODE region, there were 613 gene models, 27% of which were comprised of single-exon transcripts, many of unknown function. A total of 921 transcription start sites were predicted associated with these gene models. These predictions overlap nearly 80% of the 875 known genes (July 2003 freeze of UCSC Genome Browser) and 74% of ensembl genes (July 2003 freeze of UCSC Genome Browser) (Karolchik et al. 2003). Consistent with the genome-wide estimates, 45% of the ENCODE genes was predicted to have more than one promoter which is substantially higher than previous estimates (Landry et al. 2003). While there are a number of well-characterized single-exon genes (Gentles and Karlin 1999; Hentschel and Bimstiel 1981), the large number of putative single-exon transcripts was identified in the full-length cDNA libraries might result from genomic polyA stretches or other library artifacts. As a result, only a sample of the predicted single-exon promoters was tested. All together, 642 putative promoters were cloned and measured their promoter activities in 16 cell lines. These included 528 putative promoters based on multi-exon transcript and 114 single exon-based predictions and represent 443 of the gene models shown in Table 1.

Identification of 387 Functional Promoters in the ENCODE Region

The level of activity of a cloned promoter in the transient transfection assay as a transformed ratio of luciferase (experimental) to renilla (transfection control) signal, normalizing for transfection efficiency and allowing comparison between experiments was defined. As described in the Methods, the threshold for positive promoter activity as three standard deviations above the mean ratio of the 102 negative control DNA fragments was considered. A fragment as a functional promoter if it had activity exceeding this threshold was considered as Well. One-3 outliers per cell type within the 102 negative controls were identified, estimating a false positive rate for the assay of 1-3%. Using the thresholds defined for each cell type individually, 387 fragments, representing 303 unique gene models, in the ENCODE region showed promoter activity in at least one of the 16 cell types. A much higher validation rate among promoters predicted by multi-exon gene models (66%) than those predicted by single exon transcripts (32% Table 1) was observed. Predicted alternative promoters were less likely to show significant activity compared to predictions based on longest cDNAs in each gene model. And finally, the high confidence predictions were most likely to be active promoters.

In addition to these classes, it was that the ENCODE region, like the remaining 99% of the human genome contains a prominent class of divergently transcribed genes regulated by putative bidirectional promoters. In agreement with previously published work (Trinklein et al. 2004), 44 identified and 32 tested promoters involved in bidirectional gene pairs and found that 31 functioned in at least one of the tested cell types. All of those tested in both orientations functioned bidrectionally.

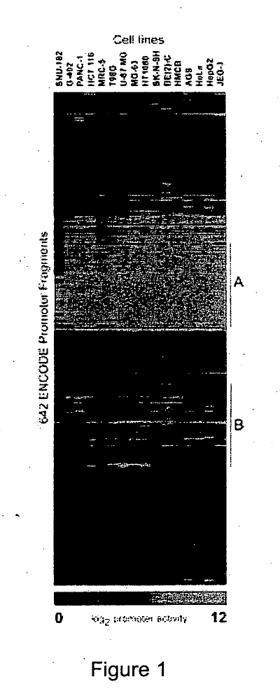

Overall, 60% of the putative promoter fragments tested were functional in at least one cell type (FIG. 1). Many of these exhibited a high degree of variation in promoter activity between cell types (FIG. 1B), suggesting that regulatory elements within the extended promoter guide cell-type specific expression, even taken out of genomic context. It was not expected that the promoter assays will recapitulate perfectly the regulation of the endogenous gene, but there were several instances in which the promoters directed cell-type specific expression similarly in vitro as they do in vivo. For example, the promoter of the hepatocyte growth factor (MET) gene was active in only seven of the 16 cell lines and was most highly active in one of the liver cell lines, HepG2. This is consistent with the expression of MET in a variety of tissues, but predominantly liver and other tissues of mesenchymal origin (Rubin et al. 1993). The osteoclast-associated receptor (OSCAR) promoter was active in only four cell lines, one of which is MG-63, an osteosarcoma cell line. This gene is thought to be expressed exclusively in osteoclasts (Kim et al. 2002). Although the data support the expression of this gene in osteoclasts, promoter activity was observed in additional tissues, suggesting that the assay does not capture all of the regulation controlling the specific expression of this gene. In addition to tissue-specific activity, there were prominent cluster of 118 promoters identified (30% of the total) that had strong, ubiquitous activity in all 16 cell lines (FIG. 1A). Within this cluster, 101 promoter fragments (86%) overlapped CpG Islands, as predicted by the UCSC Genome Browser Database (Karolchik et al. 2003). These data indicate a close association between the presence of CpG dinucleotides and strong, ubiquitous promoter activity. However, 12% (25/202) of the fragments tested that overlap CpG islands had no promoter activity in any of the 16 cell types. Overlap of CpG islands with the predicted TSS was less common in these 25 cases, but a significant difference was not observed in CpG content or length between functional and non-functional promoters overlapping CpG islands. These data suggest that while the CpG island overlap is an important indicator, it is not sufficient to predict promoter activity.

Sequence Characteristics of Promoters

The global sequence content as well as the presence of known DNA motifs within this large data set provide additional insight into promoter function. Because many promoters overlap CpG islands, there is a strong shift in the distribution of GC content in functional promoters. All active promoter fragments have a significantly higher GC content (57%) compared to putative promoter fragments with no observed activity (48%). The overlap with CpG islands and increased GC content within active promoters is the most striking sequence characteristic distinguishing functional promoters from predicted but non-functional promoters in the assay.

The presence of previously characterized promoter-specific motifs was determined in the functionally characterized promoters by doing a simple pattern match for the consensus sequences within the functional promoters. Sixty-one functional promoters (16% of total) were identified containing a TATA-box (TATA(T/A)(T/A)) and 72 functional promoters (19% of total) containing a CAAT (CCAAT) box. However, in agreement with previous work, no significant correlation was found between the presence of these motifs and promoter activity (Trinklein et al. 2003). This suggests that while these motifs may be functionally important, there is no universally required element within promoters necessary for promoter activity.

Using a set of constrained elements identified for all ENCODE targets based on comparisons of human genomic sequence to orthologous sequence from 6-9 mammalian species for each target (Cooper et al. 2005), the extent of constraint was characterized in the 500 bp functional promoters that were identified. Twelve point five percent of bases that were found within functional promoters are constrained, whereas 10% of bases within non-functional promoters were constrained. Both of these are well above the total of 4.3% constrained bases in 30 Mb of the ENCODE regions as defined by these methods. Interestingly, the vast majority of constraint above random is observed within ±50 basepairs from the transcription start site (Supplementary FIG. 1). The steep peak seen at position +1 relative to the transcription start site is very encouraging as it speaks to the accuracy of the TSS predictions. These data also suggest that the basal elements are more likely to be evolutionarily constrained. However, the extended promoter contains more constraint than expected by chance, showing evidence for a reduced but still significant density of functional and constrained elements in this region

More than 20% of Genes have Functional Alternative Promoters

Multiple promoters were predicted, each regulating a unique RNA isoform, for 45% of multi-exon genes in the ENCODE regions and have functional data supporting multiple active promoters for approximately 22% of the gene models that was tested in the transient assay. Most of these (54/66) had two functional promoters, but the UDP glycosyltransferase 1 gene (UGT1), shows evidence for seven functional promoters. Despite requiring full-length clones for alternative promoter prediction, only half of these predictions were validated. This may be explained by highly tissue-specific alternative promoters, or by annotated full-length cDNAs that are not truly full-length. Interestingly, in some cases, use of these alternative promoters results in predicted altered protein products. Of the 66 gene models with more than one functional promoter, 42 alternative isoforms have similarity to each other, and only six have identical amino acid sequences. The remaining 18 result in protein products with no significant similarity to each other. The method of defining gene models can be affected by chimeric transcripts or mis-aligned cDNAs. In these cases, two potentially unrelated transcripts can be included in the same gene model, and these transcripts define alternative promoters of the same gene model with different ORFs. Six of the 18 cases mentioned above involve short single-exon transcripts that overlap one or more exons in a longer multi-exon gene, and it is not surprising that these transcripts have different predicted ORFs. Upon manual inspection, it was observed that in ten of the remaining 12 cases, transcripts derived from alternative promoters have a similar exon structure with the exception of the 5′ exons. These transcripts use an alternative start codon that results in a completely different ORF. These proteins may have important biological functions of their own, or the existence of an alternate promoter and downstream transcript may act as a regulatory mechanism for the functional protein. Work from other groups has provided examples in which a secondary, unrelated protein, sharing coding exons with a primary transcript plays a role in the regulation of the primary transcript (Yang et al. 1998). In some cases, these transcripts may act as regulatory RNAs, creating no protein at all, or they may be completely unrelated genes, sharing exonic sequences.

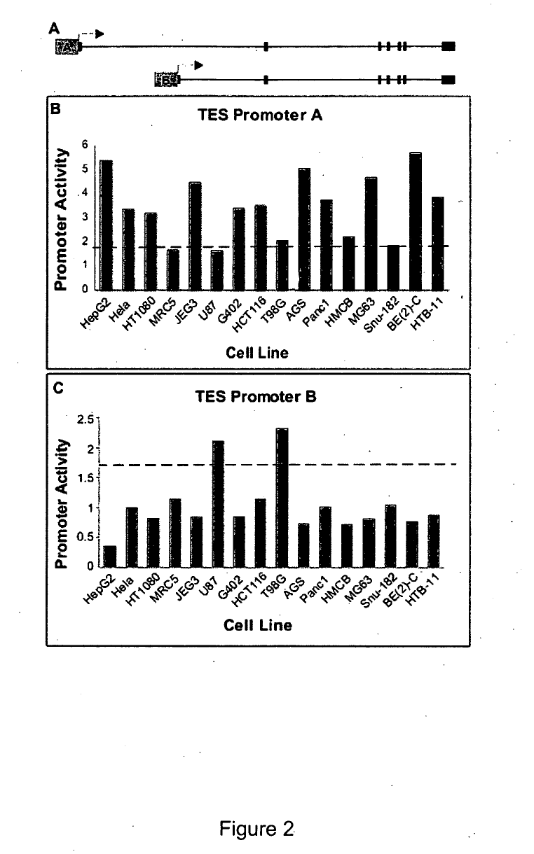

In addition to changing the amino acid sequence of the protein, alternative promoters provide distinct regulation for alternate isoforms of the same gene. Results indicate that 60% of alternative promoter pairs have significantly different expression patterns among the 16 cell lines were tested. For example, the testin (TES) gene has evidence for two promoters. The TES gene is ubiquitously expressed and has three isoforms and two putative promoters (Tatarelli et al. 2000). It was found that one promoter was active in two of the brain cell lines (FIG. 2A), and a second promoter was active in twelve remaining cell lines (FIG. 2B). In this case, the protein product is unaffected by the alternative promoter, but these promoters may be used to provide differential regulation of this gene in various tissues. Looking closely at the data from Tatarelli et al., it was seen that expression in the brain is much lower than other tissues, and this may be explained by the use of an alternative promoter. This is just one example of alternative promoters functioning to differentially regulate transcription of alternate RNA isoforms.

Functional Regions within Extended Promoter Fragments

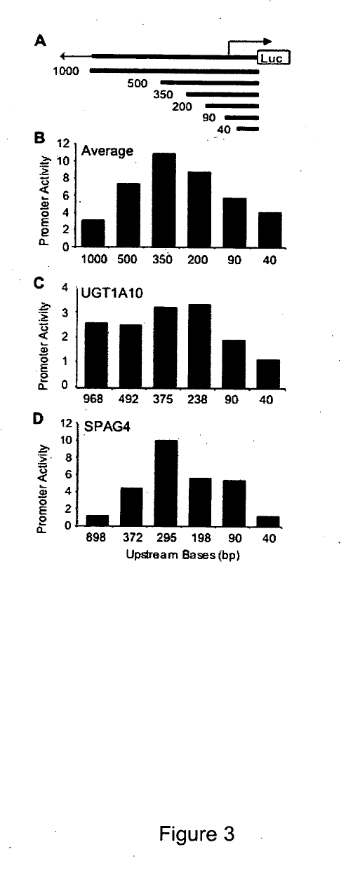

To understand further the functional elements within the extended promoter region, reporter constructs were generated with a series of nested deletions for 45 of the promoters that were active in the transient assay. The deletion fragments (described in Methods) range in size from 40 bp to 1,000 bp and were cloned upstream of the luciferase gene as diagrammed in FIG. 3A. These fragments were assayed for promoter activity as before and the average activity for each deletion construct illustrated a number of interesting points (FIG. 3B). First, promoter activity decreases with deletion of sequences between 350 bp to 40 bp upstream of the TSS, indicating the presence of positive elements between −350 and −40 bp relative to the TSS in many of these promoters. It was found that in 17 of 25 cases, the presence of 40 bp upstream of the predicted transcription start site was sufficient for basal activity that was significantly above background, but only five of these core promoter fragments had activity that was at least 90% of the 500 bp extended promoter fragment.

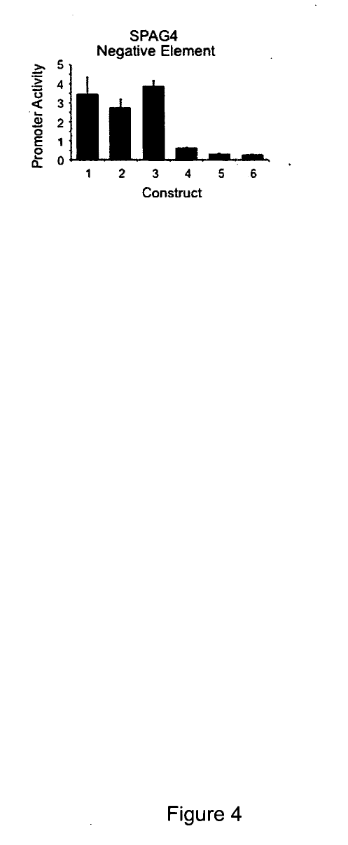

It was also observed that, on average, the 500 bp and 1,000 bp promoter fragments showed decreased activity compared to the corresponding 350 bp fragment. Overall there was a reduction in activity of the larger fragments, but a range of behaviors for individual promoters was observed (FIGS. 3C and D). Like the sperm-associated antigen 4 (SPAG4) promoter (FIG. 3D), many (12/22) of the 1,000 bp and 500 bp fragments showed significantly less activity than the 350 bp fragment of the same promoter in all seven tested cell types. These results suggest the presence of negative regulatory elements in the region −350 to −1,000 bp upstream of the TSS for many of these genes. The sequences of these fragments was examined and no simple sequence elements such as stop codons or long repetitive stretches beyond what is expected by chance were observed, nor was any significant secondary structure identified to explain these results (data not shown). Experiments were conducted to demonstrate that the change in activity observed was not a result of increased plasmid size by cloning the 500 bp promoter in duplicate or cloning 500 bp of random sequence upstream of the 500 bp promoter (FIG. 4, compare construct 1 to 2 and 3).

To test further the hypothesis that these fragments contain a negative regulatory element, the −1,000 to −500 bp fragments of five promoters upstream of two 40 bp heterologous promoters that are otherwise highly active in these cell types were cloned (See FIG. 4, constructs 5 and 6). These results strongly support the presence of a negative element in this region of the SPAG4 promoter. Of the five fragments examined, evidence was found that three of these contain negative regulatory elements. (See Supplementary Data). The others may act as position-specific or gene-specific negative elements.

Endogenous Transcript Levels Correlate with Promoter Activity

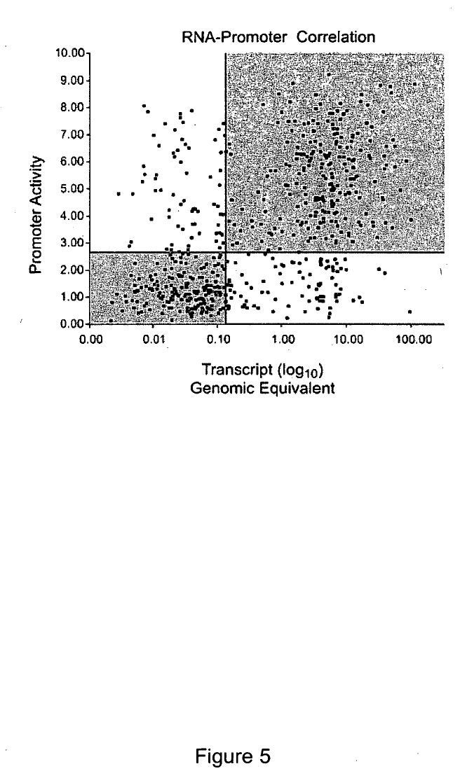

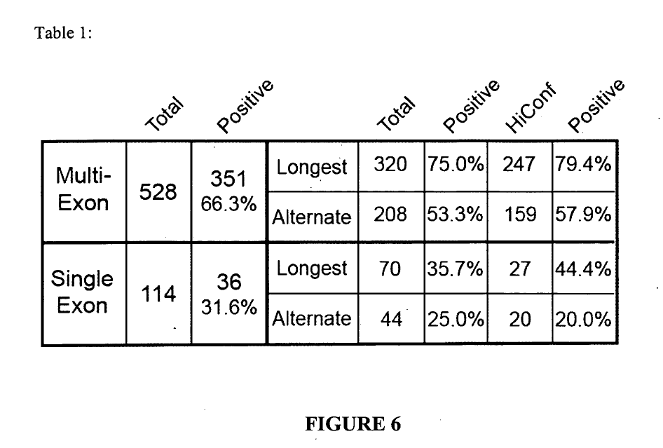

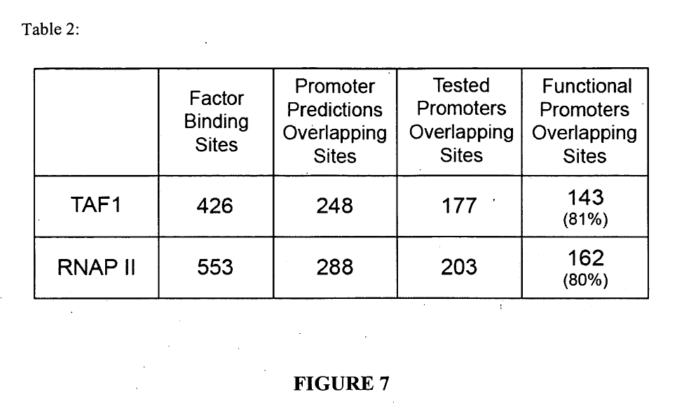

Given the variety of transcriptional regulatory elements known to exist outside of the promoter regions of genes as well as post-transcriptional regulatory mechanisms, the extent to which the activity of promoter fragments correlates to the steady state endogenous transcript levels in the same cell types was quantified. Quantitative RT-PCR was used to assay the absolute endogenous transcript levels for 35 genes whose promoter activity was measured in reporter assays in 14 cell types. In addition more comprehensive data was collected for 96 additional genes in one cell type. It was observed that there was a correlation of r=0.53 between endogenous RNA levels and the promoter activity predicted by its transcription start site (FIG. 5). To assess the significance of this correlation, the correlation coefficient of randomized data 1,000 times was calculated. The average correlation coefficient of these randomized data sets was 0.026 with a standard deviation of 0.04, indicating that the observed correlation is highly significant compared to random (p<10-12). This correlation indicates that the extended promoter fragments contain many of the elements important for regulating the transcription of these genes in vivo.

The RNA data also allows us to assess false positive and false negative rates which indicate how well promoter activity predicts in vivo RNA transcript levels. Across 14 cell types and 35 genes, 58/273 (21%) active promoter fragments were found to have no detectable RNA transcript and 72/217 (33%) inactive promoters have detectable RNA transcript. There are a variety of biological explanations for these apparent discrepancies. Promoters which function in the assay but do not seem to function in vivo can be explained by a promoter taken out of context, removed from epigenetic signals or relevant regulatory sequences or by an RNA with low abundance and high turnover. These data also confirm the expectation that for a fraction of expressed genes, the promoter was incorrectly predicted. Nonetheless, the degree of correlation observed, indicates much of the regulatory sequence was captured relevant to gene expression.

In addition to these genes, the correlation was measured between transcript levels and promoter activity for 11 genes with alternative promoters. In many cases, genes with two promoters and unique RNA isoforms showed activity consistent with one another. (See Supplemental FIG. 2.) Of the 11 genes with alternative promoters that were tested, seven had promoter activity patterns that matched the trends seen in the corresponding transcript levels. These data provide further evidence that promoters and alternative promoters contribute significantly to the control of RNA levels within a cell and that are able to recapitulate aspects of this regulation with the transient transfection assay.

Functional Promoters Co-Occur with TAF1, RNAP II Binding

Other researchers in the ENCODE Consortium have generated data useful to understanding the activity of the promoters that have been identified. Specifically, chromatin IP-microarray experiments examining the occupancy of two promoter-binding proteins, TBP-associated factor (TAF1) and RNA polymerase 2 (RNAP II) have been produced by collaborators Ren and colleagues (Kim et al. 2005) and are confirmed in a reporter assay in their lab. These experiments measure ChIP-enriched targets by genomic tiling microarray hybridization. Using a stringent cutoff for identification of binding (p-value<10-4 for TAF experiments and p-value<10-6 for RNAP II experiments), functional promoter fragments were compared with regions bound by these two transcription factors and made the following observations (Table 2). Of the 258 functional promoters identified in the two cell types common to the experiments (HCT 116 and HeLa), approximately half overlapped either TAF1 or RNAP II sites identified by chromatin IP. Conversely, of the 177 TAF1 binding sites and 203 RNAP II binding sites tested in the reporter assay, over 80% showed significant activity. Finally, of promoters bound to both RNAP II and TAF1-bound, 85% had significant promoter activity.

Discussion

Comparison to Previous Functional Promoter Studies

The experiments presented here represent the comprehensive functional testing of DNA fragments likely to be transcriptional promoters in a selected 1% of the human genome. Overall, 60% of the predicted promoters showed significant activity in at least one cell type in the transient transfection reporter assay. The fraction of active promoters is substantially lower than the 90% positives established in a previous, smaller study described in 2003 (Trinklein et al. 2003). One likely explanation for the discrepancy is that the promoters predicted in previous work relied exclusively on full-length cDNA sequences from an early version of the Mammalian Gene Collection. This early collection was likely biased towards highly expressed genes, and consequently, the promoters initially predicted were upstream of ubiquitously and highly expressed genes. In addition, the ENCODE targets contain many genes known to be highly tissue specific, including the genes of the HoxA cluster and the beta and alpha globin gene clusters. The promoters of these genes are less likely to be active in a limited panel of cell lines, where factors necessary for transcription initiation may be absent.

Due to the distinct goal of identifying all functional promoters in this region, the method used to predict promoters in the ENCODE region was also considerably different than the previous study which aimed to verify predictions based exclusively on the MGC full-length cDNA collection. By using alignments of all the cDNAs in GenBank, promoter predictions were included based on weak evidence (either there was no full-length clone to validate the prediction or only a single cDNA supported the existence of a transcription start site). This strategy introduced false predictions, but allowed a more complete identification of promoters within the ENCODE region. In support of this, data for bidirectional promoters is directly comparable to previous work and shows a similar high validation.

As with the earlier experiment (Trinlrein et al. 2003), false negative results arise due to the artificial nature of the transient reporter assay. By cloning the promoter fragment in a plasmid, the cloned fragment is required to function independently, and may not detect the activity of promoters that require elements outside the 500 bp that were tested. Although care must taken in analyzing negative results, using a large number of random fragments as a baseline for no activity ensures that positive results are more definitive. With a false positive rate of 2%, it is felt that the vast majority of positive promoter activity identified by the assay represents biologically relevant promoter activity. The data presented here represents one of the largest functional promoter datasets and provides a valuable resource for a large number of researchers studying these regions.

A Significant Fraction of Transcripts of Unknown Function have Functional Promoters

Several recent studies have shown that a significantly larger fraction of the genome is transcribed than previously thought (Bertone et al. 2004; Kapranov et al. 2002). It remains to be seen whether these “transcripts of unknown function” (TUFs) have an important biological activity and if so, how their expression is regulated. About half of the single-exon gene models and a much smaller fraction of multi-exon gene models that was predicted for this study fit the category of transcripts of unknown function, lacking a known function or an ORF of longer than 100 amino acids. Negative results must be cautiously interpreted, but the considerable difference in validation between the single-exon based prediction and multi-exon based predictions suggests a biological difference between the two classes. This difference suggests that either a larger fraction of TUFs are cDNA library or alignment artifacts or that their promoters are less likely to function in the experiments that were designed. Nevertheless, the data indicate that one-third of the sequences upstream of these single exon transcripts are functional promoters, and the presence of an ORF of at least 100 amino acids is not predictive of promoter function in this class of transcripts. In accordance with the low abundance of some of the TUFs, two-thirds of active TUF promoters function in at least one but no more than 10 of the 16 cell types tested, while less than half of the multi-exon predicted promoters meet these criteria, suggesting that TUFs may be more likely to be expressed in a specific time or place. While these data support the hypothesis that some TUFs are regulated and biologically important, the possibility exists that these transcripts are in regions of the genome that have leaky transcriptional activity and the reason for their existence is the presence of a spurious upstream promoter-like sequence. Ongoing experiments within the ENCODE Consortium to characterize the regulatory elements of novel transcribed regions will prove helpful in determining which of the TUFs are functionally relevant and specifically regulated.

Core Promoters and Upstream Regulatory Elements

Our observations that 68% of 40 bp core promoter fragments maintain basal promoter activity and that these fragments contain much of the constraint observed in promoters emphasize the importance of the core promoter. However, the deletion analyses reported also demonstrate that additional regulatory sequences are present throughout the extended promoter. Successive removal of sequences in the −350 to −40 bp region of the promoters significantly reduces promoter activity in the transient transfection assay, indicating that these regions contain positive regulatory elements. In contrast, the region upstream of −350 tends to contain elements that negatively affect transcription initiation. This trend was particularly striking within a few of the −1,000 to −500 bp regions.

These experiments can lead to interesting hypotheses about gene regulation. For example, the experiments demonstrate a negative element within the SPAG4 promoter meeting the criteria for classically defined silencers (Ogboume and Antalis 1998). The SPAG4 gene is expressed exclusively in spermatid cells during tail elongation (Tamasky et al. 1998) and an element located between −372 and −898 from the TSS could act to control tissue-specific expression of this gene by inhibiting expression in other cell types. While tissue-specific expression being initiated by a tissue-specific positive element is commonly accepted, precedence for tissue-specific regulation by a negative element has also been previously established in neurons, where gene expression is controlled by the neuron-restrictive silencer element and the factor that binds it (Schoenherr and Anderson 1995; Schoenherr et al. 1996). The fragments containing negative elements that were identified provide a detailed resource for researches interested in the regulation of these genes.

Regulatory Contribution of Promoters to Endogenous Transcript Levels

One of the fundamental questions in the field of gene expression is the relative contribution of the extended promoter region to the regulation of transcription. Long-range regulatory elements such as enhancers, silencers, and insulators have been identified and shown to play an important role in spatial and temporal regulation of gene expression, particularly during development (Howard and Davidson 2004). However, the extent of this type of regulation remains to be seen. Furthermore, epigenetic alterations, such as DNA methylation and covalent histone modification also contribute to gene expression by altering chromatin conformation (Lunyak et al. 2004). Post-transcriptional mechanisms affecting mRNA processing and stability also play a role in regulating steady-state mRNA levels (Meyer et al. 2004; Wilusz and Wilusz 2004). With all of these contributing factors, there is little experimental evidence to allow a quantitative estimate of the contribution of promoters to human gene expression on a large scale. The studies of promoter activity in the ENCODE region gave us the unique opportunity to measure the correlation of promoter function with mRNA transcript levels.

The steady-state mRNA levels measured are affected by a variety of transcriptional and post-transcriptional factors, all of which would be expected to reduce the correlation between promoter function and mRNA levels. Nevertheless, it was observed there was a remarkably high correlation between promoter activity and the levels of endogenous mRNA in each cell type, indicating that extended promoters play a significant role in regulating transcript levels. Based on the calculated correlation coefficient of 0.53 (R), 28% (R2) of the variation observed in transcript levels can be attributed to differences in promoter activity. This is likely an underestimate of overall promoter contribution due to the inherent experimental noise in the promoter activity measurements and mRNA quantification. Most genes likely require a combination of regulatory inputs. The continuous distribution of correlations between promoter function and mRNA levels among genes supports this hypothesis. Experimental noise certainly contributes to this continuous distribution; however the wide distribution supports the notion that some genes are regulated entirely by their promoter, while other genes rely on other elements to control expression. Genes that show strong correlation between promoter and RNA levels could be studied further by mutational analysis to locate the specific regions of the promoter that confer the observed regulation.

Integrating Data to Reveal Promoter Function

The integration of multiple data sets generated by the ENCODE Consortium serves to validate the different experimental approaches. The locations of active promoters and TAF1 and RNAP II binding sites throughout the ENCODE regions overlapped significantly. Of the sites bound by both TAF1 and RNAP II, and that were tested in the reporter assays, 85% were active promoters. The strong overlap between the positive results of the two experiments serves to validate both approaches as they independently identify many of the same functional promoters. The minority of fragments that were bound by both factors but were not functionally active in the reporter assays could represent sites where the preinitiation complex was assembled but paused and not transcriptionally active (Krumm et al. 1995; Krumm et al. 1992). Additional work measuring the levels of the endogenous transcripts of these genes could confirm which sites represent paused complexes rather than false positive chromatin IP results or false negative reporter data.

Most surprisingly, many examples were found of active promoters measured in the assay that did not bind either TAF1 or RNAP II binding. While, this is partly due to the stringent threshold set for TAF1 and RNAP II binding, one biological explanation is that long-range negative elements acting on these promoters in vivo prevent TAF1 and RNAP II from binding and when taken out of their genomic context and separated from negative elements, these fragments act as promoters in the transient-reporter system. This may reflect true biological activity relevant in certain cell types or under certain conditions.

Furthermore, seven genes were identified with active promoters that do not bind either TAF1 or RNAP II, but have detectable transcripts in the cell lines tested. The possibility exists that factor binding at these promoters is more difficult to detect because the DNA-protein interactions are harder to capture by chromatin immunoprecipitation for a variety of reasons. Alternatively, some of these promoters may not be bound by TAF1 and do not require TAF1 to initiate transcription. In support of this hypothesis, previous work shows that a temperature-sensitive TAF1 allele in mammalian cells does not have a global defect in RNAP II transcription demonstrating that not all transcription requires TAF1 (Suzuki-Yagawa et al. 1997; Wang and Tjian 1994). As more promoters are identified and characterized, it is becoming clear that only a small fraction of promoters contain a TATA-box and other elements previously thought to be features of the general promoter. Indeed, as more promoters are functionally characterized, the concepts of the “general transcription machinery” and “basal promoter elements” will be continuously refined.

The data presented represents a functional study of 1% of all human promoters. The data, in combination with other data generated for the ENCODE region, provides new opportunities to identify regulatory elements and better understand the transcriptional regulatory code of human cells. In addition to providing biological insight, the combination of these experimental data sets with complete sequence conservation and motif data may eventually facilitate more accurate promoter prediction throughout the genome.

Methods

Predicting Human Promoters Based on Full-Length cDNA Sequences

The locations of promoters were predicted for genes in the ENCODE region as previously described with some modifications (Trinklein et al. 2004; Trinklein et al. 2003). All human cDNA alignments were downloaded from the July 2003 freeze with at least 95% identity, available from UCSC Genome Browser (Karolchik et al.

2003), which totaled 153,642 alignments. These cDNAs represented all available cDNAs in GenBank at that time. Using the alignments of these cDNAs to the genome, gene models were defined by merging all alignments with at least 1 bp of exon overlap on the same strand. For each gene model, one TSS was defined as the 5′-most base of the gene model; however single-exon transcripts were not permitted to extend 5′ ends of multi-exon genes. Alternative transcription start sites were based only on annotated full-length clones whose 5′ ends were at least 500 bp downstream from the previously defined transcription start site. Throughout the manuscript alternative promoters were defined as distinct sequences resulting in transcription of alternate RNA isoforms.

Cloning and Plasmid Preparation

Primer3 software was used to design primers by inputting 600 bp of upstream sequence and 100 bp downstream of the predicted TSS (Rozen and Skaletsky 2000). Each primer pair was required to flank the transcription start site. To the 5′ end of each primer, 16 basepair tails were added to facilitate cloning by the Infusion Cloning System (BD Biosciences, Clontech cat no. 639605). (Left primer tail: 5′-CCGAGCTCTTACGCGT-3′, Right primer tail: 5′-CTTAGATCGCAGATCT-3′) The fragments were amplified using the touchdown PCR protocol previously described (Trinklein et al. 2004) and Titanium Taq Enzyme (BD Biosciences, Clontech, cat no 639210). To clone the PCR amplified fragments using the Infusion Cloning System, 2 μl purified PCR product and 100 ng linearized pGL3-Basic vector (Promega) were combined. This mixture was added to the Infusion reagent and incubated at 42° C. for 30 minutes. After incubation, the mixture was diluted and transformed into competent cells (Clontech cat. No. 636758). Clones for insert by PCR were screened and positive clones were prepared as previously described. DNA was quantified with a 96-well spectrophotometer (Molecular Devices, Spectramax 190) and standardized concentrations to 50 ng/μl for transfections.

Negative Control Fragment Selection

A total of 102 fragments was chosen similar in length to the experimental fragments to assay as negative controls. Twenty-four fragments were picked from coding exons that were at least 5 kb from a predicted transcription start site. The remaining 78 size-matched fragments were chosen randomly from the ENCODE regions. Because they were randomly chosen fragments, the GC content was similar to the ENCODE-wide average of approximately 43%. Primers were designed and followed all downstream protocols identically to those performed for putative promoter fragments.

Cell Culture Transient Transfections and Reporter Gene Activity Assays

Each of the 16 cell lines were obtained (AGS, Be(2)-C, G-402, HCT116, HepG2, HeLa, HMCB, HT1080, JEG-3, MG-63, MRC-5, Panc-1, SK-N-SH, SNU-182, T98G, and U-87 MG) from ATCC and grown in the media suggested by ATCC. (See Supplemental Methods for more information.)

Transfections of cultured human cell lines were performed as previously described (Trinklein et al. 2004) and 5,000 cells per well were seeded in 96-well plates (see Supplemental Methods). Twenty-four hours after seeding, 50 ng of experimental luciferase plasmid was co-transfected with 10 ng of renilla control plasmid (pRL-TK, Promega Cat. No. E2241) in duplicate using 0.3 μl of FuGene (Roche) transfection reagent per well. Cells were lysed 24-48 hours post-transfection, depending on cell type. Luciferase and renilla activity was measured using the PE Wallac Luminometer and the Dual Luciferase Kit (Promega, Cat. No. E1960). The protocol suggested by the manufacturer was following with the exceptions of injecting 60 μl each of the luciferase and renilla substrate reagents and reading for 5 seconds.

Data Analysis & Verification

All data was reported as a transformed ratio of luciferase to renilla. The mean ratio of the 102 negative controls was determined, and eliminated outliers by Dixon's test (Dixon 1950). By this test, 0-3 outliers were identified in each cell line. Only two outliers appeared in multiple cell types. The activity of putative promoters was assessed by defining a threshold three standard deviations above the mean ratio of the negatives. It was normalized for comparison between cell types by dividing each ratio by the mean ratio of the negative controls for that cell type adding one and taking the log2 of each ratio. (Activity=log2((Luciferase/Renilla)/AvgNeg+1). Forty-eight promoters were prepared independently to verify the data to assess reproducibility. Each sample began with a new transformation, bacterial culture, DNA extraction, quantification, and transfection. Promoter activity in four cell lines was assayed and found a correlation of 0.93 between transformed luciferase/renilla ratios of the two independent samples.

Sequence Analysis and Comparative Studies

For motif discovery, promoters into clusters were divided based on the clustering displayed in FIG. 1 and used MEME (Bailey and Elkan 1994) to search for motifs over represented within each cluster. High GC content confounded the search and no significant motifs were identified. Bioprospector (Liu et al. 2001) were used to identify motifs which differentiated between functional and non-functional promoters, but did not recover any significant motifs.

Constrained elements were identified for all ENCODE target regions based on analyses performed by other members of the ENCODE consortium (Cooper and Sidow, unpublished). Constrained element annotations were generated for the October 2004 ENCODE sequence data freeze (The ENCODE Project Consortium 2004), using Genomic Evolutionary Rate Profiling (GERP, described in detail in (Cooper et al. 2005)) analyses of multiple sequence alignments built using MLAGAN alignment software (Brudno et al. 2003). These constrained elements collectively cover 4.3% of all human ENCODE bases, and all elements are statistically significant at 95% confidence (Cooper et al. 2005). (See Supplemental Materials) More information, along with updated constrained element annotations and scores will be available through the ENCODE portal of the UC-Santa Cruz genome browser http://genome.ucsc.edu/ENCODE).

Promoter Deletions Series

For each of 45 promoters, additional amplicons were designed and constructed plasmids with promoter inserts averaging 1,000, 330, 210, 90, and 40 upstream bases, in addition to the 500 bp fragments already cloned. (Primer sequences available as supplemental materials.) Each of the smaller fragments were subcloned from the original promoter, and amplified the 1,000 basepair fragments from genomic DNA. These fragments were cloned using restriction enzymes and ligation, as described previously (Trinklein et al. 2004; Trinklein et al.

2003). After cloning, the constructs were transfected and assayed as described above in seven cell lines: HT1080, HCT116, AGS, T98G, U87 MG, HeLa, and JEG-3.

RNA Preparation and cDNA Synthesis

RNA was isolated using QIAGEN RNA/DNA Mini Kit (Cat. No. 14123) from duplicate samples of 14 cell types (AGS, G-402, HCT116, HeLa, HepG2, HMCB, HT1080, JEG-3, MG-63, MRC-5, Panc-1, SNU-182, T98G, and U-87 MG). Each cell line was grown in monolayer and lysed 4×10⁶ cells in 0.5 ml lysis buffer. RNA pellets were resuspended in 100 μl RNase-free water. The RNA samples were then reverse transcribed by using a mix of random hexamers, poly-T first strand synthesis primers, and Superscript reverse transcriptase (Invitrogen).

Quantitative RT-PCR

Amplicons were designed to the cDNA sequence of each gene and performed real-time PCR to quantitate the absolute amount of cDNA for each gene (amplicon size range between 60-100 base pairs). Each reaction contained 3.5 mM MgCl2, 0.125 mM dNTPs, 0.5 μM forward primer, 0.5 μM reverse primer, 0.5× Sybr Green (Molecular Probes), 1U Stoffel fragment (Applied Biosystems), and template DNA in a final volume of 20 μl. For each amplicon there was a standard curve of 50 ng, 5 ng, 500 pg, and 50 pg total genomic DNA in addition to the replicate cDNA samples. Product accumulation was measured for 40 cycles on the Bio-Rad Icycler, and calculated the threshold cycle for each dilution of the standard curve and then performed a linear regression to fit the threshold cycle from the cDNA sample to this standard curve to measure the absolute number of genomic equivalents of that gene in the pool of cDNA from each of the 14 cell lines. The levels of beta-actin were measured and GAPDH in each cDNA preparation to normalize for any variation in absolute quantities of cDNA in each prep. Three genomic controls were also measured to estimate the background levels of contaminating genomic DNA or other background signal. For false positive and false negative calculations, RNA transcript was considered detectable at 10-fold over the genomic background controls.

### Example 2

### Large-Scale Structural and Functional Characterization of Human Expanded Promoters

1) Promoter Prediction Algorithm (PPA v1.2)

This example provides a preferred embodiment of the method illustrated in FIG. 9B.

A. Post-Processing of cDNA Alignments

As of Jul. 6, 2005, there were more than 200,000 human cDNA sequences aligned to the human genome (hg17) by the BLAT algorithm at UCSC. These alignments are all publicly available at the website of genome.ucsc.edu.

The PPA downloads these alignments and filters out those that have less than 95% sequence identity, those that have more than 200 bases at the 5′ end of the cDNA sequence that do not align to the genome, and those that align to random sequence not assembled into the reference chromosome sequences. These filters are implemented to remove cDNAs that have low quality sequence at the 5′ end and, therefore, predict dubious transcription start sites. As of Jul. 6, 2005, there were 223,100 cDNAs that met these criteria.

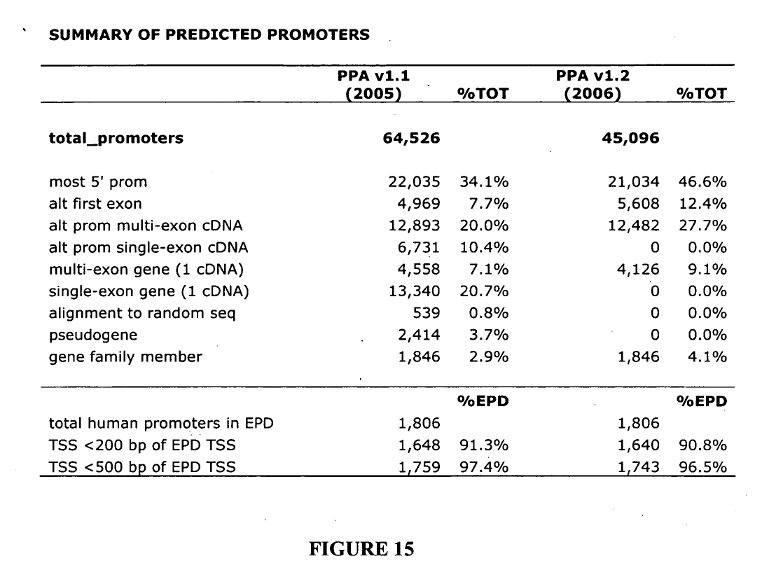

cDNAs that align to multiple places in the genome that meet the above criteria are further analyzed to distinguished putative processed pseudogenes from highly similar or duplicated genes. Processed pseudogenes are formed when endogenous mRNAs are reverse transcribed into DNA and inserted in the genome, therefore, one feature that distinguishes processed pseudogenes is that they often appear as single exon genes. Since processed pseudogenes are an artifact of viral replication, they are not good indicators of transcriptional promoters, therefore, the PPA attempts to filter out these sequences. Single exon genes can be identified by intron length, and the PPA measures intron length by calculating the ratio of the length of each cDNA to the length of the genomic alignment of that cDNA. A ratio of 1 represents a single exon gene, whereas a ratio of 0.1 represents a gene where 90% of the genomic alignment is intronic sequence. The distribution of all alignment ratios shows that 0.95 is an appropriate threshold for calling an alignment “intronless.” The threshold is slightly less than 1 to take into account random sequencing errors and alignment artifacts that create small single base deletions and insertions. The PPA cannot simply filter out all single exon genes because there are a significant number of real single exon genes. Instead, the PPA makes note when a cDNA aligns to multiple places in the genome and what the smallest alignment ratio is for all the alignments of that cDNA. If the smallest ratio is less than 0.95, additional alignment ratios greater than 0.95 are categorized as pseudogenes, ratios with a difference greater than 0.2 above the smallest alignment ratio are also called pseudogenes, and ratios with a difference of less than 0.2 above the smallest ratio are called likely gene family members. FIG. 15 is a table showing that nearly 2,500 pseudogenes are identified and filtered out by PPA v1.2.

Compared with PPA v1.1, PPA v1.2 has the following distinct features:

PPA 1.2 uses a less stringent quality control for cDNAs. It allows 200 bp of unaligned sequence at the 5′ end of cDNAs. It has been shown that the 100 bp cutoff used in PPA 1.1 may be overly stringent.

PPA 1.2 deals with cDNAs that align to multiple places in the genome and filters out likely processed pseudogenes in a way that was not implemented in PPA 1.1.

PPA 1.2 filters out alignments to random, unassembled sequence.

B. Assembling Gene Models

After the PPA finishes post-processing the cDNA alignments, it begins assembling the aligned cDNAs into gene models. The concept of a “gene” has become exceptionally complicated when viewed from a genomic perspective. Overlapping genes, anti-sense transcripts, trans-splicing, and alternative promoters all make a gene a difficult entity to define. A project at the NCBI called Unigene takes an approach of aligning cDNA sequences to each other and merging those with a certain amount of similar sequence into “unigene” clusters. This approach is problematic because, among other things, genes with similar protein domains may align to each other because of this underlying similarity but not because they were part of the same gene. In contrast, the PPA compares all cDNA genomic alignments to each other and assembles gene models based on cDNAs whose exons align to the same region and same strand of the genome. This distinct approach is superior because it uses the entire cDNA sequence to assign it to a genomic locus and then measures which cDNAs have exons that overlap based on their alignments to a common reference genomic sequence. The PPA defines a gene model as all the collection of cDNAs with at least one base of exon overlap with at least one other cDNA in the same genomic region on the same strand. FIG. 1 shows an example of a group of cDNAs that comprise a gene model.

Gene models defined by a single cDNA are less reliable than gene models defined by many cDNA sequences because they are based on a single observation, and are even more dubious when the only cDNA is a single-exon cDNA. Many functional and biologically relevant RNA molecules are processed in some way, such as splicing, which creates gaps in the alignment of the RNA sequence to the genome. While true single-exon genes exist, as described above, a large fraction of single-exon cDNA alignments represent pseudogenes. In addition, random pieces of contaminating genomic DNA present in cDNA libraries would appear to be single-exon genes since those pieces of genomic DNA would not be spliced or processed in any sort of way. The previous studies have also shown that the majority of “single-exon genes” represented by a single cDNA do not have functional transcriptional promoters. For all of these reasons, the PPA filters out gene models that are defined by one single-exon cDNA alignment due to the low probability that they actually represent a biologically relevant gene.

C. Predicting and Categorizing TSSs and Transcriptional Promoters

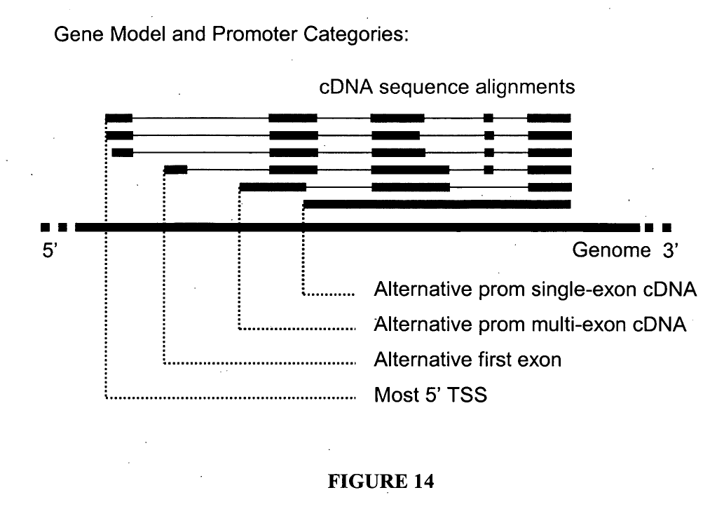

After the PPA assembles all the cDNAs into gene models, it predicts the transcription start sites (TSS) within the gene models. TSSs are classified based on their location in the gene model and from the type of cDNA that establishes that TSS (see FIG. 14). For each gene model, there is a 5′ boundary and a cDNA that defines that most 5′ TSS. Some gene models have cDNAs that predict alternative TSSs downstream of the most 5′ TSS. These shorter cDNAs may be incomplete products and therefore would not predict true biological TSSs. Some cDNAs, however, come from libraries that have been enriched for full-length cDNAs such as the Mammalian Gene Collection or the DBTSS. Other cDNAs have been hand-curated to assess quality and are part of the Refseq database built at the NCBI. The PPA predicts alternative TSSs based on these full-length cDNAs from the MGC, DBTSS, or RefSeq that are at least 500 bases downstream of the next closest cDNA. In addition, an alternative TSS is predicted if a cDNA has a first exon that does not overlap any exons from longer cDNAs in the same gene model. A unique first exon increases the confidence in that particular TSS, because it is less likely to be an artificially truncated form of the gene. Therefore, the PPA also predicts alternative TSSs from cDNAs containing unique first exons. Because of the issues raised above concerning single-exon cDNAs, the PPA filters out any alternative TSSs predicted by a single-exon cDNA in that gene model. FIG. 1 shows an example of a hypothetical gene model that has each type of TSS and the cDNAs that define them. Furthermore, the PPA also compares the open reading frames encoded by different cDNAs in a gene model and records how the usage of alternative TSSs may affect the protein product produced by those transcripts.

Once the PPA establishes the final list of TSSs for each gene model in the genome, the PPA then gathers promoter sequence associated with each TSS. A transcriptional promoter contains two general parts: a core promoter which extends approximately 75 bp upstream and 20 bp downstream of the transcription start site and an extended promoter region that extends up to 2,000 bp upstream of the TSS. The core promoter is the region where RNA polymerase and other basal factors assemble to initiate transcription and the extended promoter region often contains gene-specific regulatory elements that control the spacial and temporal regulation of the gene. Based on these promoter boundaries defined in large part by the previous work, the PPA gathers promoter sequence that extends 2,100 bp upstream and 200 bp downstream of each TSS.

In order to PCR amplify and clone these promoter fragments, the PPA then calls the primer3 primer design program developed at MIT to design PCR primers that amplify each of these promoter fragments ranging from 700-2,000 bp products depending on the local sequence content of each promoter. For each promoter fragment the PPA requires that PCR primers include the TSS in each amplified fragment and that primers avoid repetitive DNA.

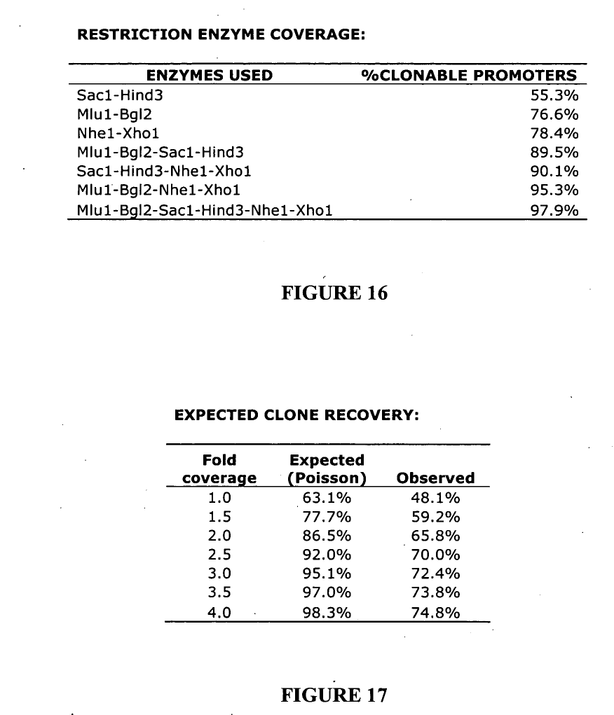

In order to clone each promoter fragment by ligation, each promoter sequence must be screened for the restriction enzyme pair that is used for the directional ligation reaction. Towards this end, the PPA screens each promoter sequence, and one of three restriction site pairs will be used depending on which sites are absent in the promoter sequence. Based on the genome-wide promoter analysis, employing three restriction enzyme pairs cover 97% of all of the promoters of the genome whereas using a single pair will cover between 55-78% depending on the pair of enzymes used (see the Table in FIG. 16 for details). Once the promoter sequences have been stratified based on restriction site content, the PPA adds the appropriate restriction enzyme recognition sequences at the 5′ end of the forward and reverse primers to allow efficient directional cloning into the plasmid.

The PPA algorithm also selects a set of 384 negative control fragments from the genome matched to the same size distribution of the promoter fragments. Approximately 25% of these fragments are random middle exon sequences that are at least 10 kb from both ends of the gene. The remaining negative control fragments are chosen randomly from the genome excluding the regions predicted to be promoters by the PPA.

Compared with PPA v 1.1, PPA v1.2 has the following distinct features:

PPA v1.2 predicts alternative promoters in a gene model based on cDNAs with unique first exons in addition to using the criteria established in PPA v1.1.

PPA v1.2 removes alternative TSSs defined by single-exon cDNAs whereas PPA v1.1 does not.

PPA v1.2 also records if the alternative TSSs result in a different open reading frame compared to the longest cDNA in the gene model.

PPA v1.2 gathers 2,000 bases of putative promoter sequence from which primers are designed to amplify a promoter fragment between 700 and 2,000 bp. The inventors believe that there is a significant amount of transcriptional regulation controlled in the distal promoter region, and subsequent functional assays performed with these fragments will be more informative than experiments done with promoter fragments <700 basepairs.

FIG. 15 shows a table that summarizes the categories of promoters predicted by both algorithms. PPA v1.1 predicts 64,526 promoters and PPA v1.2 predicts 45,096 promoters (the sequences of which are designated SEQ ID NOs: 1-45096 listed in the attached DVD) in the human genome. This 30% reduction in overall promoter number largely represents a reduction of noise that was present in PPA v 1.1. Table 1 summarizes the number of promoters in each category using both PPA v1.1 and PPA v1.2.

Furthermore, FIG. 15 shows the results of a comparison with promoters in the Eukaryotic Promoter Database (EPD). The EPD is database that currently contains 1,806 human promoters that have experimentally validated TSSs. This is a reasonable set of human promoters to test the sensitivity of the algorithms. PPA v1.1 predicts 91.3% and 97.4% of the TSSs that are within 200 bp and 500 bp of the TSSs in EPD, respectively. Likewise, PPA v1.2 predicts 90.8% and 96.5% of the TSSs that are within 200 bp and 500 bp of the TSSs in EPD, respectively. Therefore, both algorithms capture nearly all the promoters present in the EPD. The small number of EPD promoters that were picked up by PPA v1.1 that were missed by PPA v1.2 were looked at and interestingly, all of these appear to be mis-annotations in the EPD to regions upstream of pseudogenes. Therefore, PPA v1.2 is a significant improvement over PPA v1.1 and is significantly (30%) more specific without sacrificing sensitivity.

2) Large-Scale Promoter Cloning

This example provides a preferred embodiment of the method illustrated in FIG. 10B.

Several different approaches for high-throughput cloning of human promoter fragments exist including ligation-based methods and recombination-based methods. The new recombination-based cloning products, such as the Gateway system from Invitrogen and the InFusion system from Clontech, are effective and have become very popular in recent years. In Example 1, the Infusion system was used to clone over 1,000 promoter fragments. While effective, the reagents for both Gateway and InFusion are quite expensive. Another disadvantage is that as many as 20 extra bases need to be added to the 5′ end of each PCR primer, significantly raising the cost of oligos. The experience using both ligation-based and recombination-based cloning methods has reliably shown success rates of >90% each at both the PCR and cloning steps.

To clone more than 5,000 fragments, it was estimated that it becomes more time efficient to use a pooling approach to minimize the effort involved with handling and tracking thousands of individual reactions. By pooling hundreds of samples into single reactions, the burden is shifted to the sequencing effort needed to identify all the anonymously cloned fragments. Major academic and commercial sequencing centers have become incredibly high-throughput and are able to sequence hundreds of thousands of clones quickly and efficiently. It is believed that taking advantage of this expertise greatly benefits a large-scale cloning effort.

A pilot study was conducted where 384 PCR products were pooled and random fragments were cloned from this pool. Plasmids (fragment to be tested for promoter activity cloned 5′ to a luciferase reporter cassette) were constructed representing 24 putative novel promoters and 12 negative control fragments. This panel of 36 plasmids was then transfected into tissue culture cells (HT1080 fibrosarcoma cells) in 96- and 384-well formats in duplicate. Fifty ng of plasmid was then transfected into each 96-well format well and 20 ng of plasmid into each 384-well format well. After transfection, the cells were moved back to 37° C. for 24 hours. After those 24 hours, luciferase assay reagent was added to each well (Steady-Glo from Promega), 100 uL for 96-well format and 30 uL for 384-well format. Five minutes were waited and then the visible light output was read from each well for 10 seconds using a plate luminometer.

As less DNA was transfected into fewer cells in the 384-well format, it was expected that the absolute amount of visible light from each well would be less than that seen for the 96-well format. Indeed, this is what was seen with light about ˜50% decreased in the 384-well format. However, this reduced level still fell well within the linear detection range for the luminometer. It was an attempt to find out whether the scaling-down process (to smaller wells) leads to an increase in the variability between replicate wells transfected with the same plasmid construct (i.e. an increase in experimental noise).

To address this question, the standard deviation was first calculated between replicates for each construct in each well format. However, the standard deviation numbers could not be compared between the two well formats because of the difference in absolute levels of reporter activity. To correct for different activity levels, it was calculated that the Coefficient of Variance (CV, standard deviation divided by the mean) for each construct in each well format. The smaller the CV, the more agreement there is between replicate wells. For the 96-well format, the average CV was 0.15. For the 384-well format, the average CV was 0.12. So the variability between replicates is almost identical for the two formats, and if anything, the 384-well format performed slightly better. In addition, the promoter activity of each fragment tested was compared between the two formats and saw an overall correlation of 0.99. This indicates that the data gathered from a 384-well format is as of least as good of quality as that taken from a 96-well format.

By sequencing 384 clones (1× coverage), 188 unique fragments (49%) were successfully recovered. While not the 63% expected by random Poisson sampling, this was close to what was expected, knowing that each fragment would not be equally represented due to PCR and cloning biases. The table in FIG. 17 shows the expected percentage of unique clones recovered at different levels of coverage based on our pilot experiment. The following modified protocol applies to any multi-well plate, preferably to a 384-well plate.

Step 1: First Round Pooling

Each of the 25,000 promoters is individually PCR amplified in 384-well format. The forward and reverse PCR primers already mixed are used to save plasticware, handling, and space. High-fidelity PCR polymerase is used to amplify promoters and expect a ˜90-92% PCR success rate with less than one error per 10 kb. The success rate is measured by running 384 PCR reactions on a gel. These PCR products are then combined into 65 pools of 384 fragments. To work with pools of 384 it is decided to limit the bias of rare over-represented fragments. This way, an over-represented fragment is contained within one pool and does not out-compete fragments in other pools that are more evenly represented.

The fragments in each of the 65 pools are purified and digested with the appropriate restriction enzyme pair to yield sticky ends. The digested fragments are again be purified, quantitated, and then ligated into our reporter vector. Our reporter vector is also engineered to contain a flexible multiple cloning site and to be compatible with recombination-based shuttling systems. For this purpose, the sequences flanking of the promoter are engineered to allow efficient shuttling into different vector constructs. The vector is plasmid-based and is designed to be used primarily in transient gene delivery systems.

Each ligation reaction is treated as a mini-library. Each ligation is transformed into high-efficiency chemically competent E. coli and plate the transformed bacteria on 0.150 mm agar plates with the appropriate selectable marker. Part of the negotiated service for sequencing includes colony picking, plasmid preparation, glycerol stock production, and sequencing. Before sending the plates to the sequencing service, 192 colonies are picked, purified plasmids are prepared from each, and a test digest is prepared to ensure that there are 1 kb inserts in at least 99% of the clones. Then, from each library, 768 colonies (2× coverage) are picked from each plate and grown in 2 ml cultures overnight. From each culture, a 50 uL aliquot are archived as a glycerol stock, and the rest of the culture will be used to sequence the promoter insert in each plasmid.

Based on a study-summarized in FIG. 17, it is expected that ˜15,200 unique sequences are retrieved (˜66% of successful PCR reactions) from the original ˜25,000 promoters in all the pools. Using automated sequence analysis tools, each sequence is aligned to read to our database of promoter sequences from the reference human genome sequence. Successfully cloned promoters are identified, and notes are made of the promoters that are not cloned. A liquid handling robot is then employed to rearray the PCR primers of those promoter fragments that are not cloned in the first round.

Steps 2: Second Round Pooling

The following step is the same as Step 1, the only difference being that in the beginning they had roughly 33% of the number of promoters used in the previous step. First all PCR amplifications are repeated from the rearrayed primers. It may seem wasteful to regenerate the PCR products since what left could be rearrayed from the original PCR reactions. Based on this experience, there is a significant decline in the cloning efficiency of fragments left in frozen PCR reactions for more than a week, so fresh PCT products are used.

As before, PCR products are pooled, digested, ligated, transformed, and picked twice as many colonies (2× coverage) as original PCR reactions. It is then sequenced to identify newly cloned fragments and make note of the promoters that are not successfully cloned. It is expected that a smaller percentage of unique fragments will be retrieved in the second round because the second round will be enriched for PCR failures and hard to clone fragments. After these 2 rounds it is expected that ˜75% of the 25,000 total promoters will have been cloned.

An alternative strategy to conducting 2 rounds of pooling, deconvoluting, and rearraying, would be to do a single round and sequence more clones to gain a greater coverage. Based on random sampling, fewer unique clones are recovered with each increase in fold-coverage, therefore the cost per unique clone increases as a library is sequenced to greater depth.

Step 3: Individual Cloning

The PCR primers are rearrayed and individually clone the remaining promoters that are unable to be cloned in the previous 2 rounds, in addition to the promoters for which alternative restriction enzyme pairs or blunt clone due to their incompatibility with our 3 primary restriction sites are used. Many of the promoters that are not cloned in the pooling strategy represent PCR failures, therefore each PCR reaction is run on a high-throughput slab gel to identify the failed PCRs that are not worth pursuing. The successful PCR reactions are then rearrayed and purified individually in 96-well format in less than a week to avoid decreases in cloning efficiency. Finally, the same steps of digestion, ligation, and transformation are preformed, only on each fragment individually in 96-well format.

3) Large-Scale Functional Promoter Assay

This example provides a preferred embodiment of the method illustrated in FIG. 11B.

After all of the promoters in the human genome are cloned, a non-redundant set of promoter-containing plasmids (along with the negative controls) are mass-produced in E. coli, purified, diluted to the same concentration (50 ng/ul), and stored in 96-well blocks (2 ml/well). Using a liquid handling robot, 50 ng of each plasmid is re-arrayed into multiple sets of 60 384-well plates. An optional step is to also add 10 ng of the same transfection control plasmid to each well. The transfection control plasmid has a ubiquitous promoter that drives a different reporter than the one used on the experimental promoter plasmid. Each plate contains a column (16 wells) of plate normalization constructs (PNC). The set of PNC comprises 8 positive control fragments spanning a range of promoter strengths and 8 negative control fragments. The plasmid DNAs are dried in each well and stored for subsequent applications.

The large-scale plasmid delivery to living cells can be performed using one of the following approaches:

Approach 1—High-throughput conventional transient transfection: Resuspend plasmids in a transfection reagent mix including a lipofection reagent such as Fugene (Roche) and serum-free media. The transfection reagent forms liposomal complexes with the plasmid DNA and is then ready to be added to tissue culture cells growing in 384-well plates.

Approach 2—High-throughput reverse transfection: Alternatively, resuspend plasmids in a transfection reagent mix similar to that described above but also including a liquefied matrix of either glycerin or agar. Next, deposit this transfection mixture to the bottom of an empty 384-well tissue culture plate and allow it to solidify in the matrix. Then, living cells can be plated on top of this transfection matrix and the cells will take up the promoter plasmids that are contained in the matrix. Details of reverse transfection of cDNAs are described in U.S. Pat. Nos. 6,544,790; 6,670,129; 6,951,757; and U.S. application Ser. Nos. 09/817,003; and 10/379,130, all of which are incorporated herein by reference in their entireties for all purposes.

Once the plasmids from the library have been delivered to cells in one of the ways described above, they must be given 24-48 hours to allow time for expression of the reporter gene. The experiment may also include a change in experimental condition such as addition of a compound or change in the environment. After there has been sufficient amount of time for the expression of the reporter gene, the level of the reporter product is measured either by the addition of the appropriate substrate (for luminescent reporters) or by excitation by the appropriate wavelength of light (for fluorescent reporters). The substrate for the luminescent reporters (for both the experimental plasmid and transfection control plasmid if it is used) is delivered either to living cells or by lysing the cells in each well with a lysis buffer and mixing the substrate with the cell extract. The last step is to read the signal produced in each well (by each reporter) by the appropriate device (luminometer or fluorometer).

4) Data Analysis for Large-scale Functional Promoter Assay

This example provides a preferred embodiment of the method illustrated in FIG. 12B.

Once the raw data has been collected, the first step is to normalize based on the transfection control if a transfection control plasmid has been used by calculating the ratio of experimental signal divided by the transfection control signal. Then average any replicate transfections that have been performed.

The next step is to normalize for any plate-to-plate variation using the plate normalization constructs (PNC). The mean signal and standard deviation is calculated for each of the 16 individual constructs across all of the plates in the PNC and then calculate the signal difference of each construct from the mean for each plate. The difference for each construct is normalized by dividing by the standard deviation of that construct. This normalization is necessary to correct for the larger variances of the positive control fragments in the PNC that are due to larger absolute values. Then the 16 normalized differences in each plate are averaged together to derive a plate normalization factor, and it factor is used to normalize the data for each plate. This ultimately produces a normalized raw promoter activity value for each promoter.

The normalized raw promoter values are most relevant in the context of the negative control fragments. Therefore, the next step is to measure the distribution of the values of the negative control fragments and express each promoter value in terms of the mean and standard deviation of the distribution of the negative controls. This results in a Z-score value for each promoter that is calculated as [(raw promoter activity−mean of negative controls)/standard deviation of the negative controls]. This Z-score-based analysis allows for better comparison of data between experiments because it takes into account the variance in the distribution of the negative control values. Z-score measure of promoter activity takes into account the variance of cell lines and corrects for it.

### Example 3

### Assay for Determining DNA Methylation Status Genome-Wide

This example provides a preferred embodiment of the method for determining DNA methylation illustrated in FIG. 13. The process is as follows.

From either tissue culture cells or tissue samples, prepare high-molecular weight DNA using either a DNA affinity column (such as those provided in the DNeasy Kit from Qiagen) or by repeated phenol-chloroform extractions. Make sure the 260/280 ratio is >1.8 and that there are no residual traces of phenol in the sample.

Next digest 10 ug of the genomic DNA with 2 ul each of the following 3 methyl-sensitive restriction enzymes: HpaII, HgaI, HpyCH4 IV. Perform digestion in a total volume of 100 ul for 2-4 hours. These enzymes are optimized to work in the same buffer conditions (NEB Buffer #1) that is provided by the enzyme supplier (NEB).

Purify the DNA from the digest using the DNeasy columns from Qiagen. Elute in a final volume of 85 ul of water. Use this elution in a second digestion reaction using 2 ul each of the following 3 methyl-sensitive restrictrion enzymes: AciI, HhaI, BstU I. Perform digestion in a total volume of 100 ul for 2-4 hours. These enzymes are optimized to work in the same buffer conditions (NEB Buffer #4+bovine serum albumin) that is provided by the enzyme supplier (NEB).

Purify the DNA from the digest using the DNeasy columns from Qiagen. Elute in a final volume of 100 ul of water. This series of digestions with methyl-sensitive enzymes should deplete all unmethylated regions of the genome. The DNeasy columns only bind to DNA >100 bp so smaller pieces produced by the digestion are purified away.

Next label the digested DNA with a fluorescent nucleotide or primer (cy3 or cy5 dUTP or dCTP). Also label an undigested control sample of the same genomic DNA with a different fluorescent label than that used on the digested sample. Apply both samples in a competitive hybridization to a genomic microarray following standard procedures. The microarray can either be a spotted promoter or CpG island array or an oligo array that tiles across genomic regions of interest.

After washing and scanning the microarray, for each microarray feature, calculate the log (base 2) ratio of the digested DNA signal to the undigested DNA signal. Use negative control regions that should not be depleted by the enzyme treatment to measure the variation of log ratios around 0. A log ratio of 0 corresponds to equal signals from both colors representing equal amounts of a particular target in both the treated and untreated samples.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### SEQUENCE LISTING

SEQ ID NOs: 1-45,496 are provided on a compact disc as file name 33102-701.201.SeqList.ST25.txt, enclosed with this filing.

### REFERENCES

Ahituv, N., E. M. Rubin, and M. A. Nobrega. 2004. Exploiting human—fish genome comparisons for deciphering gene regulation. Hum Mol Genet 13 Spec No 2: R261-266.
Bailey, T. L. and C. Elkan. 1994. Fitting a mixture model by expectation maximization to discover motifs in biopolymers. Proc Int Conf Intell Syst Mol Biol 2: 28-36.
Bertone, P., y. Stolc, T. E. Royce, J. S. Rozowsky, A. E. Urban, X. Zhu, J. L. Rinn, W. Tongprasit, M. Samanta, S. Weissman, M. Gerstein, and M. Snyder. 2004. Global identification of human transcribed sequences with genome tiling arrays. Science 306: 2242-2246.
Blais, A. and B. D. Dynlacht. 2004. Hitting their targets: an emerging picture of E2F and cell cycle control. Curr Opin Genet Dev 14: 527-532.
Brudno, M., C. B. Do, G. M. Cooper, M. F. Kim, E. Davydov, E. D. Green, A. Sidow, and S. Batzoglou. 2003. LAGAN and Multi-LAGAN: efficient tools for large-scale multiple alignment of genomic DNA. Genome Res 13: 721-731.
Butler, J. E. and J. T. Kadonaga. 2002. The RNA polymerase II core promoter: a key component in the regulation of gene expression. Genes Dev 16: 2583-2592.
Cavin Perier, R., T. Junier, and P. Bucher. 1998. The Eukaryotic Promoter Database EPD. Nucleic Acids Res 26: 353-357.
Cooper, G. M., E. A. Stone, G. Asimenos, E. D. Green, S. Batzoglou, and A. Sidow. 2005. Distribution and intensity of constraint in mammalian genomic sequence. Genome Res 15: 901-913.
Dixon, W. 1950. Analysis of extreme Values. Annals of Mathematics and Statistics 21: 488-506.
The ENCODE Project Consortium. 2004. The ENCODE (ENCyclopedia Of DNA Elements) Project. Science 306: 636-640.
Gentles, A. J. and S. Karlin. 1999. Why are human G-protein-coupled receptors predominantly intronless? Trends Genet 15: 4749.
Gerhard, D. S. L. et al. 2004. The status, quality, and expansion of the NIH full-length cDNA project: the Mammalian Gene Collection (MGC). Genome Res 14: 2121-2127.
Hentschel, C. C. and M. L. Birnstiel. 1981. The organization and expression of histone gene families. Cell 25: 301-313.
Howard, M. L. and E. H. Davidson. 2004. cis-Regulatory control circuits in development. Dev Biol 271: 109-118.
Imanishi, T. T. et al. 2004. Integrative annotation of 21,037 human genes validated by full-length cDNA clones. PLoS Biol 2: 856-875.
Kapranov, P., S. E. Cawley, J. Drenkow, S. Bekiranov, R. L. Strausberg, S. P. Fodor, and T. R. Gingeras. 2002. Large-scale transcriptional activity in chromosomes 21 and 22. Science 296: 916-919.
Karolchik, D., R. Baertsch, M. Diekhans, T. S. Furey, A. Hinrichs, Y. T. Lu, K. M. Roskin, M. Schwartz, C. W. Sugnet, D. J. Thomas, R. J. Weber, D. Haussler, and W. J. Kent. 2003. The UCSC Genome Browser Database. Nucleic Acids Res 31: 51-54.
Kim, N., M. Takami, J. Rho, R. Josien, and Y. Choi. 2002. A novel member of the leukocyte receptor complex regulates osteoclast differentiation. J Exp Med 195: 201-209.
Kim, T. H., L. O. Barrera, C. Qu, S. Van Calcar, N. D. Trinklein, S. J. Cooper, R. M. Luna, C. K. Glass, M. G. Rosenfeld, R. M. Myers, and B. Ren. 2005. Direct isolation and identification of promoters in the human genome. Genome Res 15: 830-839.
Kimmel, A. R. and S. L. Berger. 1987. Preparation of cDNA and the generation of cDNA libraries: overview. Methods Enzymol 152: 307-316.
Krumm, A., L. B. Hickey, and M. Groudine. 1995. Promoter-proximal pausing of RNA polymerase II defines a general rate-limiting step after transcription initiation. Genes Dev 9: 559-572.
Krumm, A., T. Meulia, M. Brunvand, and M. Groudine. 1992. The block to transcriptional elongation within the human c-myc gene is determined in the promoter-proximal region. Genes Dev 6: 2201-2213.
Landry, J. R., D. L. Mager, and B. T. Wilhelm. 2003. Complex controls: the role of alternative promoters in mammalian genomes. Trends Genet 19: 640-648.
Liu, X., D. L. Brutlag, and J. S. Liu. 2001. BioProspector: discovering conserved DNA motifs in upstream regulatory regions of co-expressed genes. Pac Symp Biocomput: 127-138.
Lunyak, V. V., G. G. Prefontaine, and M. G. Rosenfeld. 2004. REST and peace for the neuronal-specific transcriptional program. Ann N Y Acad Sci 1014: 110-120.
Meyer, S., C. Temme, and E. Wahle. 2004. Messenger RNA turnover in eukaryotes: pathways and enzymes. Crit Rev Biochem Mol Biol 39: 197-216.
Ogbourne, S. and T. M. Antalis. 1998. Transcriptional control and the role of silencers in transcriptional regulation in eukaryotes. Biochem J 331 (Pt 1): 1-14.
Pirkkala, L., P. Nykanen, and L. Sistonen. 2001. Roles of the heat shock transcription factors in regulation of the heat shock response and beyond. Faseb J 15: 1118-1131.
Praz, V., R. Perier, C. Bonnard, and P. Bucher. 2002. The Eukaryotic Promoter Database, EPD: new entry types and links to gene expression data. Nucleic Acids Res 30: 322-324.
Rozen, S. and H. Skaletsky. 2000. Primer3 on the WWW for general users and for biologist programmers. Methods Mol Biol 132: 365-386.
Rubin, J. S., D. P. Bottaro, and S. A. Aaronson. 1993. Hepatocyte growth factor/scatter factor and its receptor, the c-met proto-oncogene product. Biochim Biophys Acta 1155: 357-371.
Schoenherr, C. J. and D. J. Anderson. 1995. The neuron-restrictive silencer factor (NRSF): a coordinate repressor of multiple neuron-specific genes. Science 267: 1360-1363.
Schoenherr, C. J., A. J. Paquette, and D. J. Anderson. 1996. Identification of potential target genes for the neuron-restrictive silencer factor. Proc Natl Acad Sci USA 93: 9881-9886.
Suzuki, Y., R. Yamashita, K. Nakai, and S. Sugano. 2002. DBTSS: DataBase of human Transcriptional Start Sites and full-length cDNAs. Nucleic Acids Res 30: 328-331.
Suzuki, Y., R. Yamashita, S. Sugano, and K. Nakai. 2004. DBTSS, DataBase of Transcriptional Start Sites: progress report 2004. Nucleic Acids Res 32 Database issue: D78-81.
Suzuki-Yagawa, Y., M. Guermah, and R. G. Roeder. 1997. The ts13 mutation in the TAF(II)250 subunit (CCGI) of TFIID directly affects transcription of D-type cyclin genes in cells arrested in GI at the nonpermissive temperature. Mol Cell Biol 17: 3284-3294.
Tamasky, H., D. Gill, S. Murthy, X. Shao, D. J. Demetrick, and F. A. van der Hoom. 1998. A novel testis-specific gene, SPAG4, whose product interacts specifically with outer dense fiber protein ODF27, maps to human chromosome 20q11.2. Cytogenet Cell Genet 81: 65-67.
Tatarelli, C., A. Linnenbach, K. Mimori, and C. M. Croce. 2000. Characterization of the human TESTIN gene localized in the FRA7G region at 7q31.2. Genomics 68: 1-12.
Trinklein, N. D., S. F. Aldred, S. J. Hartman, D. I. Schroeder, R. P. Otillar, and R. M. Myers. 2004. An abundance of bidirectional promoters in the human genome. Genome Res 14: 62-66.
Trinklein, N. D., S. J. Aldred, A. J. Saldanha, and R. M. Myers. 2003. Identification and functional analysis of human transcriptional promoters. Genome Res 13: 308-312.
Wang, E. H. and R. Tjian. 1994. Promoter-selective transcriptional defect in cell cycle mutant ts13 rescued by hTAFII250. Science 263: 811-814.
Wilusz, C. J. and J. Wilusz. 2004. Bringing the role of mRNA decay in the control of gene expression into focus. Trends Genet 20: 491-497.
Yang, A., M. Kaghad, Y. Wang, E. Gillett, M. D. Fleming, V. Dotsch, N. C. Andrews, D. Caput, and F. McKeon. 1998. p63, a p53 homolog at 3q27-29, encodes multiple products with transactivating, death-inducing, and dominant-negative activities. Mol Cell 2: 305-316.

What is claimed is:

1. A library of expression constructs, each member of the library comprising a different nucleic acid segment from a genome, wherein the segment comprises transcription regulatory sequences, operably linked with a heterologous reporter sequence in an expression vector such that expression of the reporter sequence is under transcriptional control of the transcription regulatory sequences, wherein:
(a) the library has a diversity of at least 50 different nucleic acid segments;
(b) each nucleic acid segment and is naturally linked in the genome with a sequence expressed as a cDNA; and
(c) the average length of the nucleic acid segments in the library is at least 600 nucleotides.

2. The library of claim 1, wherein the average length of the nucleic acid segments in the library is between 700 nucleotides and 1200 nucleotides.

3. The library of claim 1, wherein the average length of the nucleic acid segments in the library is between 800 nucleotides and 1100 nucleotides.

4. The library of claim 1, wherein at least 90% of the nucleic acid segments in the library have a length between 700 nucleotides and 1300 nucleotides.

5. The library of claim 1, wherein each nucleic acid segment comprises at least 500 nucleotides upstream of a transcriptional start site.

6. The library of claim 1, wherein no more than 5% of the nucleic acid segments are naturally linked to cDNA alignment artifacts.

7. The library of claim 1, wherein the library is indexed to indicate the gene naturally under the transcriptional control of each transcription regulatory sequence in the genome.

8. The library of claim 1, wherein the reporter sequences encode the same reporter molecule.

9. The library of claim 1, wherein the reporter sequence encodes a light-emitting reporter molecule, a fluorescent reporter molecule or a calorimetric molecule.

10. The library of claim 1, wherein each reporter sequence comprises a pre-determined, unique nucleotide barcode and/or a reporter that reports a visible signal.

11. The library of claim 1, wherein the genome is a mammalian genome.

12. The library of claim 1, wherein the genome is a human genome.

13. The library of claim 1, wherein the genome is a mouse genome.

14. The library of claim 1, wherein the diversity of the nucleic acid segment is at least 100.

15. The library of claim 1, wherein the diversity of the nucleic acid segment is at least 500.

16. The library of claim 1, wherein the expression construct is a plasmid or viral construct.

17. The library of claim 1, wherein the nucleic acid segments include at least two of the DNA segments selected from the group consisting of SEQ ID NOs: 1-45096 or fragments thereof or nucleic acids having sequences with at least 70%, 75%, 80%, 85%, 90%, 95%, or 98% homology thereto.

18. A library of isolated nucleic acid molecules, each member of the library comprising a different, pre-determined nucleic acid segment from a genome, wherein the segment comprises transcription regulatory sequences, wherein:
(a) the library has a diversity of at least 50 different nucleic acid segments;
(b) each nucleic acid segment is naturally linked in the genome with a sequence expressed as a cDNA; and
(c) the average length of the nucleic acid segments in the library is at least 600 nucleotides.

19. A library of recombinant nucleic acid molecules, each member of the library comprising a different, determined nucleic acid segment from a genome linked with a heterologous nucleic acid molecule, wherein the segment comprises transcription regulatory sequences, wherein:
(a) the library has a diversity of at least 50 different nucleic acid segments;
(b) each nucleic acid segment is naturally linked in the genome with a sequence expressed as a cDNA; and
(c) the average length of the nucleic acid segments in the library is at least 600 nucleotides.

20. The library of claim 19 wherein the nucleic acid molecule comprises a pair of restriction sites flanking a 5′ and a 3′ side of the segment.

21. The library of claim 19 wherein the nucleic acid molecule comprises sites flanking on the 5′ and 3′ ends the segment that are complementary to PCR primers that may be used for amplification.

22. A library of cells, wherein each cell in the library of cells comprises a different member of a library of expression constructs, wherein each member of the library of expression constructs comprises a different nucleic acid segment from a genome, wherein the segment comprises transcription regulatory sequences, operably linked with a heterologous reporter sequence in an expression vector such that expression of the reporter sequence is under transcriptional control of the transcription regulatory sequences, wherein:
(a) the library has a diversity of at least 50 different nucleic acid segments;
(b) each nucleic acid segment is naturally linked in the genome with a sequence expressed as a cDNA; and
(c) the average length of the nucleic acid segments in the library is at least 600 nucleotides.

23. The library of claim 22 wherein the cells are human cells.

24. The library of claim 22 wherein the cells are non-human cells.

25. A collection of cells comprising within the cells a library of expression constructs, each member of the library of expression constructs comprising: a different nucleic acid segment from a genome, wherein the segment comprises transcription regulatory sequences, operably linked with a different heterologous reporter sequence in an expression vector such that expression of the reporter sequence is under transcriptional control of the transcription regulatory sequences.

26. The collection of cells of claim 25, wherein the cell containing a different expression construct is in an identifiable vial or well.

27. The collection of cells of claim 25 wherein:
(a) the library has a diversity of at least 50 different nucleic acid segments;
(b) each nucleic acid segment is naturally linked in the genome with a sequence expressed as a cDNA; and
(c) the average length of the nucleic acid segments in the library is at least 600 nucleotides.

28. A device comprising at least one plate comprising a plurality of wells, each well containing a different member of a library of expression constructs, each expression construct comprising a different, nucleic acid segment from a genome, wherein the segment comprises transcription regulatory sequences, operably linked with a heterologous reporter sequence in an expression vector such that expression of the reporter sequence is under transcriptional control of the transcription regulatory sequences, and wherein each member has a known location among the wells.

29. The device of claim 28, wherein:
(a) the library has a diversity of at least 50 different nucleic acid segments,
(b) each nucleic acid segment is naturally linked in the genome with a sequence expressed as a cDNA; and
(c) the average length of the nucleic acid segments in the library is at least 600 nucleotides.

30. The device of claim 28, wherein the constructs are in the form of a dried nucleic acid or are in solution.

31. The device of claim 30 wherein the constructs are in a transfection matrix combination.

32. The device of claim 28 comprising a 96-well plate, a 384-well plate or a 1536 well plate.

33. The device of claim 28, wherein the gene expression regulatory elements include at least two of the DNA segments selected from the group consisting of SEQ ID NOs: 145096 or fragments thereof or nucleic acids having sequences with at least 70%, 75%, 80%, 85%, 90%, 95%, or 98% homology thereto.

34.

35. A device comprising at least one plate comprising a plurality of wells, each well containing a different member of the library of cells, wherein each cell in the library of cells comprises a different member of the library of expression constructs, each expression construct comprising a different nucleic acid segment from a genome, wherein the segment comprises transcription regulatory sequences, operably linked with a heterologous reporter sequence in an expression vector such that expression of the reporter sequence is under transcriptional control of the transcription regulatory sequences and wherein each member of the library of cells has a known location among the wells.

36. The device of claim 35 wherein:
(a) the library of expression constructs has a diversity of at least 50 different nucleic acid segments;
(b) each nucleic acid segment is naturally linked in the genome with a sequence expressed as a cDNA; and
(c) the average length of the nucleic acid segments in the library is at least 600 nucleotides.

37. A kit for characterizing a biological function of a target gene expression regulatory element, comprising:
(a) a device comprising at least one plate comprising a plurality of wells, each well containing a different member of the library of expression constructs, each expression construct comprising a different nucleic acid segment from a genome, wherein the segment comprises transcription regulatory sequences operably linked with a heterologous reporter sequence in an expression vector such that expression of the reporter sequence is under transcriptional control of the transcription regulatory sequences, and wherein each member has a known location among the wells; and
(b) reporter assay substrates.

38. The kit of claim 37, further comprising: instructions for characterizing the biological function of the target gene expression regulatory element.

39. A device comprising a solid substrate comprising a surface and nucleic acid molecules immobilized to the surface, each at a different known location, wherein each molecule comprises a nucleotide sequence of at least 10 nucleotides from a genomic segment comprising transcription regulatory sequences and the device comprises transcription regulatory sequences from at least 50 different genomic segments.

40. The device of claim 39 wherein each nucleic acid segment is naturally linked in the genome with a sequence expressed as a cDNA.

41. The device of claim 39 wherein the gene expression regulatory elements include at least two of the DNA segments selected from the group consisting of SEQ ID NOs: 1-45096 or fragments thereof.

42. The device of claim 39 wherein the molecules are no more than 60 nucleotides long.

43. The device of claim 39 wherein each genomic segment is represented by a set comprising a plurality of molecules, each molecule in the set comprising a different a different nucleotide sequence from the genomic segment.

44. A system comprising:
(a) a device of claim 35;
(b) a reader adapted to detect a signal from an expressed reporter sequenced in each well of the device.

45. The system of claim 44 wherein the device comprises a plurality of control constructs that provide a predetermined signal level, and wherein the system further comprises (c) software comprising:
(i) code that executes an algorithm that normalizes signal from all wells of plates based on the signal from the control constructs.

46. Software comprising code that executes the algorithm of claim 45.

47. A method comprising:
(a) providing a device comprising at least one plate comprising a plurality of wells, each well containing a different member of a library of cells, wherein each cell in the library of cells comprises a different member of the library of expression constructs, each expression construct comprising a different nucleic acid segment from a genome, wherein the segment comprises transcription regulatory sequences, operably linked with a heterologous reporter sequence in an expression vector such that expression of the reporter sequence is under transcriptional control of the transcription regulatory sequences and wherein each member of the library of cells has a known location among the wells;
(b) culturing the cells; and
(c) measuring the level of expression of the reporter sequence in each well.

48. The method of claim 45 wherein:
(i) the library has a diversity of at least 50 different nucleic acid segments;
(ii) each nucleic acid segment is naturally linked in the genome with a sequence expressed as a cDNA; and
(iii) the average length of the nucleic acid segments in the library is at least 600 nucleotides.

49. The method of claim 45 wherein the step of providing the device comprises:
(i) providing a device comprising at least one plate comprising a plurality of wells, each well containing a different member of the library of expression constructs, wherein each member of the library of expression constructs has a known location among the wells;
(ii) delivering cells to each of the wells; and
(iii) transfecting the cells with the expression constructs.

50. The method of claim 45 further comprising:
(d) perturbing the cells in each well;
(e) measuring the level of expression of the reporter sequence in each well; and
(f) determining whether the level of expression in any well changed after contacting the cells with the test compound.

51. The method of claim 50 wherein perturbing comprises contacting the cells in each well with a test compound, exposing the cells to different environmental conditions, or genetically modifying the cells either permanently or transiently such as by inducing mutation, overexpressing a transcript for example by transfecting with a cDNA or decreasing expression of a transcript by siRNA.

52. The method of claim 45 wherein the reporter sequence encodes a reporter molecule and measuring expression of the reporter sequence comprises measuring the expression of the reporter molecule.

53. A method comprising:
(a) providing a first device and second device, each device comprising at least one plate comprising a plurality of wells, each well containing a different member of a library of cells, wherein each cell in the library of cells comprises a different member of the library of expression constructs, each expression construct comprising a different nucleic acid segment from a genome, wherein the segment comprises transcription regulatory sequences, operably linked with a heterologous reporter sequence in an expression vector such that expression of the reporter sequence is under transcriptional control of the transcription regulatory sequences, wherein each member of the library of cells has a known location among the wells and wherein the first and second devices comprise cells of the same type and the library of expression constructs is the same in the first and second devices;
(b) culturing the cells of the first and second devices under different culture conditions;
(c) measuring the level of expression of the reporter sequence in each well; and
(d) comparing the level of expression of the reporter sequence to each transcription regulatory sequence between the first cell type and the second cell type.

54. The method of claim 53 wherein the different culture conditions comprise culturing the cells of the second device in the presence of compound not present in the culture of the cells of the first device.

55. A method comprising:
(a) providing a first device and second device, each device comprising at least one plate comprising a plurality of wells, each well containing a different member of a library of cells, wherein each cell in the library of cells comprises a different member of the library of expression constructs, each expression construct comprising a different nucleic acid segment from a genome, wherein the segment comprises transcription regulatory sequences, operably linked with a heterologous reporter sequence in an expression vector such that expression of the reporter sequence is under transcriptional control of the transcription regulatory sequences, wherein each member of the library of cells has a known location among the wells and wherein the first device comprises cells of a first type and second device comprises cells of a second type and the library of expression constructs is the same in the first and second devices;
(b) culturing the cells of the first and second devices;
(c) measuring the level of expression of the reporter sequence in each well; and
(d) comparing the level of expression of the reporter sequence to each transcription regulatory sequence between the first cell type and the second cell type.

56. The method of claim 55 wherein:
(i) the library has a diversity of at least 50 different nucleic acid segments;
(ii) each nucleic acid segment is naturally linked in the genome with a sequence expressed as a cDNA; and
(iii) the average length of the nucleic acid segments in the library is at least 600 nucleotides.

57. The method of claim 55 wherein the step of providing the devices comprises:
(i) providing devices, each device comprising at least one plate comprising a plurality of wells, each well containing a different member of the library of expression constructs, wherein each member of the library of expression constructs has a known location among the wells;
(ii) delivering cells to each of the wells; and
(iii) transfecting or infecting the cells with the expression constructs.

58. A method for evaluating the level of expression from constructs measured by the method of claim 47 comprising:
(a) providing a set of cells comprising a set of control reporter constructs, each control reporter construct comprising a random genomic fragment operatively linked with the heterologous reporter sequence;
(b) measuring the level of expression of the reporter sequence in each of cells;
(c) determining a mean or average of the expression level among the control constructs;
(d) determining, for the level of expression of each of the test constructs, a statistical distance from the mean or average; and
(e) determining whether the deviation is statistically significant.

59. The method of claim 58 wherein the deviation is a standard deviation.

60. The method of claim 58 wherein the random genomic fragments are random fragments selected from the genome of the same size distribution as the experimental fragments.

61. The method of claim 58 wherein the random genomic fragments are random fragments from middle exons of protein coding genes where the middle exon codes for protein and is a length of at least the size of the experimental fragments and at least 5,000 or 10,000 bases from a known transcription start site in the genome.

62. The method of claim 58 wherein activity and significance are calculated as a Z-score by the following equation: Z-score promoter activity=(raw promoter activity−mean of random controls)/standard deviation of the random controls.

63. Software comprising code that executes an algorithm that determines the mean and deviations of claim 58.

64. Analysis software that integrates Z-score transformed promoter activity data with Z-score transformed functional data from DNA methylation experiments, transcription factor binding data, histone modification data, DNase hypersensitivity data, nucleosome displacement data or gene expression data.

65. A method for determining a methylation pattern in a sequence of nucleic acid comprising:
(a) creating a first set of labeled nucleic acid segments by:
(i) obtaining a nucleic acid molecule comprising the sequence from a source; and
(ii) labeling the isolated nucleic acid molecule with a first label, whereby labeling creates a first set of labeled nucleic acid segments;
(b) creating a second set of labeled nucleic acid segments by:
(i) obtaining the nucleic acid molecule having the nucleotide sequence from the source;
(ii) contacting the nucleic acid molecule with at least three methyl-sensitive restriction enzymes having different recognition sequences, wherein the enzymes cleave the nucleic acid molecule at un-methylated recognition sequences but not at methylated recognition sequences, thereby nucleic acid fragments;
(iii) isolating nucleic acid fragments of at least 100 nucleotides from the mixture; and
(iv) labeling the fragments with a second, different label, whereby labeling creates a second set of nucleic acid segments;
(c) hybridizing the first and second labeled segments to one or more nucleic acid probes comprising the nucleotide sequence; and
(d) determining areas of the nucleotide sequence that are differentially labeled by the first and second labeled segments, wherein differentially labeled areas are un-methylated areas of the nucleotide sequence.

66. The method of claim 65 wherein the nucleic acid molecule comprises transcription regulatory sequences.

67. The method of claim 65 comprising contacting the nucleic acid molecules with at least six different methyl-sensitive enzymes.

68. The method of claim 65 wherein the first label generates a first color and the second label generates a second, different color.

69. The method of claim 65 comprising hybridizing the segments to a plurality of probes that tile the nucleotide sequence of the nucleic acid molecule.

70. The method of claim 65 further comprising performing the method a second time with nucleic acid from a second source, wherein the first and second sources are healthy and diseased tissues or two different types of diseased tissues.

71. A business method comprising:
(a) commercializing the compositions, devices or methods of any of claims 1, 18, 19, 22, 25, 28, 34, 38, 43, 45, 46, 52, 54, 57, 62, 63 and 64.
